(19) United States
(12) Patent Application Publication
(10) Pub. No.: US 2004/0170949 A1
(43) Pub. Date: Sep. 2, 2004

(54) Method for organizing and depicting biological elements

(76) Inventors: Sean O'Donoghue, Heidelberg (DE); Karsten Fries, Heidelberg (DE); Joachim Meyer, Heidelberg (DE); Andrea Schafferhans, Seeheim (DE)

Correspondence Address: MCDERMOTT WILL & EMERY LLP, 600 13TH STREET, N.W., WASHINGTON, DC, 20005-3096, US

(21) Appl. No.: 10/250,571

(22) PCT Filed: Jan. 7, 2002
(86) PCT No.: PCT/EP02/00064

(30) Foreign Application Priority Data
Jan. 5, 2001 (EP) 011003621
Feb. 20, 2001 (EP) 011040706

(51) Int. Cl. G09B 23/26

(52) U.S. Cl. 434/278

(57) ABSTRACT

The invention relates to a method and apparatus for depicting one or more biological elements in a basic environment by means of a data processing system comprising the steps of obtaining one or more data sets relating to a biological element, determining at least one first feature element from said data sets, said feature element providing information on a relation between said biological element and said basic environment, obtaining data determining a graphical representation for depicting at least one of the biological elements corresponding to said one or more data sets determining a relation between the graphical representation of said basic environment and said graphical representation on the basis of said first feature element, providing means for effecting that in a graphical representation of said environment generated from said data said graphical representation of said biological element is depicted as located on said display of said basic environment element according to said relation determined on the basis of said first feature element. The invention also provides for a method and apparatus for handling three-dimensional representions of biological molecules, such as proteins and protein complexes.

The invention described here applies to the field of visualization of and navigation in biological entities, especially, but not limited to biomolecular 3D structures and related information, such as sequences (amino acid or nucleic) and features or annotations related to molecules or sequences.

A major challenge in the life sciences today is dealing with the rapid growth in biological, chemical and/or medical data; the best known examples are the DNA and/or protein sequence databases, which are increasing in number and content size exponentially; more rapidly, in fact, than the increase in computer speed. In addition, other methods such as protein structure determination and mass spectroscopy are being scaled up for high-throughput; this is creating a corresponding increase not just in the size, but the number of biological databases available each year. To deal with this rapid increase in data, informatics tools are required that can automatically organize new and existing data, and allow the user to maintain an overview.

The most successful and best known method for integrating biological chemical and/or medical data databases is to construct a ‘meta’-database that keeps track of the main databases as they grow, adding cross-links between the databases. With such systems, a user can submit queries and get back a formatted text summary with links to matching entries in any of the original biological databases. Two well known systems of this type are SRS (‘Sequence Retrieval System’, a product distributed by LION Bioscience AG) and the Entrez server (www.ncbi.nlm.gov/entrez). As with text-based computer operating systems (e.g., MS-DOS or Unix), such systems are ideal for expert users, but for non-experts they have a number of draw-backs. To make these systems amenable to non-experts, graphical user interfaces (GUIs) help the user navigate through the data.

To date, most tools for visualizing biological databases are designed to show essentially only one type of database. Methods that can combine different types of data into a single view are desired. One important example of combining different data is mapping of functional properties (single nucleotide polymorphisms or SNPs, sequence conservation, residues involved in protein-protein interaction, and active sites) onto the protein 3D structure. Such combined views could then be visualized using, e.g. standard molecular graphics methods such as RasMol (www.umass.edu/microbio/rasmol).

It would be very desirable however to have a method for organizing and depicting one or more biological elements; preferentially molecules or sequence features, such as SNPs/SAPs, exon/intron borders, postranslational modification sites (phosphorylation, glycosylation, acetylation, methylation, ubiquitination, etc.), and features predicted from bioinformatics analysis, stemming from one or more databases and one or more data sets whereby at least a first feature element is determined from each of said data sets, a graphical representation is made for displaying the biological elements corresponding to said data sets and a display of a basic environment element is enhanced by locating at least one of said graphical representations of said biological elements on the display depending on the information contained in the feature element.

A specific case of the above is the three-dimensional visualization of biological molecules, especially proteins. The number of known protein sequences deposited in sequence databases such as SwissProt (Bairoch, A. and R. Apweiler (2000). “The SWISS-PROT protein sequence database and its supplement TrEMBL in 2000.” Nucleic Acids Res 28(1): 45-8) or TrEMBL is growing almost exponentially; similarly, the number of protein structures collected in PDB (Protein DataBase, cf. Bernstein, F. C., T. F. Koetzle, et al. (1977). “The Protein Data Bank: a computer based archival file for macromolecular structures.” Journal of Molecular Biology 112: 535-542) is also growing at an almost exponential rate. However, the number of known structures is lagging far behind that of sequences. As of December 2001, a total of around 700,000 protein sequences are known. In contrast, only 16,000 protein structures are known. Naively, that suggests that only around 2% of all known sequences have a known structure; in fact the number is less than 1%, since many sequences have more than one associated structure in the database.

However, since the structure is highly conserved in a family of related proteins, the overall fold of structurally unknown proteins can often be inferred from related sequences for which the structure has been solved experimentally. A related structure is known for about 130,000, or around 20%, of all known sequences. This number is somewhat arbitrary, as it depends on the threshold set for determining relatedness of a sequence and structure. With more generous criteria, the percentage may be as high as 40%.

One of the aims of structural genomics initiatives is to extend the number of experimentally determined structures such that for every sequence a related sequence with known structure can be found. While one is still far from reaching this aim, it can be expected that the percentage of sequences for which a related 3D structure is known is set to increase, and in the next decade, a related structure will be available for most sequences. This perspective gives researchers in the field the challenge to stay up to date with this wealth of sequence/structure information.

In general, in addition to the growth of the sequence and structure databases, there is an ever-growing pool of features and annotations related to structures available in various databases throughout the biologist community. Some examples of such data are SNPs/SAPs, exon/intron borders, postranslational modification sites (phosphorylation, glycosylation, acetylation, methylation, ubiquitination, etc.), and features predicted from bioinformatics analysis. Mapping these data onto related 3D structures can be very useful in further interpreting and understanding structures, and in suggesting many insights to researchers in the field.

A related system of the prior art is PMD, the protein mutation database and server (Kawabata, T., M. Ota, et al. (1999). “The protein mutant database.” Nucleic Acids Research 27: 355-357) (pmd.ddbj.nig.ac.jp/˜pmd). PMD maps coding SNPs onto 3D structures. PMD has two major limitations; firstly, only one database with one kind of feature data is mapped onto the structure. I.e. PMD is not designed to handle many different heterogeneous databases of sequence features. Secondly, only one feature at a time is mapped onto the structure, rather than several or many. It is a specifically tailored system, not a general system for varying tasks.

Another non-commercial system is ModBase (pipe.rockefeller.edu/modbase-cgi/index.cgi) (Sánchez, R., U. Pieper, et al. (2000). “MODBASE, a database of annotated comparative protein structure models.” Nucleic Acids Research 28: 250-253), which has a database of homology models for all sequences (where possible). ModBase has domain annotations of the sequence that can be displayed together with the structure. This is again limited to mapping only one kind of data. ModBase has the additional disadvantage that, since it requires a complete homology modeling (which is quite CPU intensive) it is slow to update as new sequences and structure become available. Further the feature mapping is not done dynamically, but off-line.

None of the systems of the prior art have a general mechanism for dynamically mapping sequence features from a database onto structure. Rather, the feature analyses are pre-calculated from structures directly and pre-stored. This means that the integration of new feature databases is not straightforward, and all features to be mapped onto structures must be explicidly stored in a separate feature-to-structure database. Furthermore, these systems do not display more than one or a small number of ‘feature elements’ at a time, and then only one kind of feature at a time.

The ability to create dynamic views that combine data from heterogeneous databases is a strength of the SRS system (Etzold, T., A. Ulyanov, et al. (1996). “SRS: information retrieval system for molecular biology data banks.” Methods Enzymol 266: 114-28, Etzold, T. and G. Verde (1997). “Using views for retrieving data from extremely heterogeneous databanks.” Pac Symp Biocomput: 134-41). According to the prior art, structures were not integrated into SRS very well; in particular, there was no 3D visualization method that could display these diverse data mapped onto structures. There was also no database that was tailored for this task.

Accordingly, a specific object of the invention is an improved system for mapping data onto related 3D structures which allows annotations to be easily transferred onto structures for visualization.

Another problem encountered in the field is inherent in the complexity of the entities dealt with. Especially considering the three-dimensional structure of macromolecules, such as proteins, it is frequently hard for a user with ordinary skill to associate local sequence features to regions of the three-dimensional structure.

Prior art 3D viewers are generally stand-alone components. Recently, several viewers on the market have added a ‘sequence details’ window that shows all residues in one or all sequences (e.g. the Cn3D viewer). These windows are usually coupled to the 3D view, so that a residue selected in one view is seen in the other. This is useful as it allows the user to better understand the relationship between sequence and structure.

State-of-the-art 3D viewers are sufficient for most macromolecular structures. However, increasingly larger and more complex structures are found, for example the large ribosome subunit that was recently determined at atomic-resolution (Ban, N., P. Nissen, et al. (2000). “The complete atomic structure of the large ribosomal subunit at 2.4 A resolution” Science 289 (5481): 905-20). This latter complex is a complex of over 26 separate protein molecules. In such a large complex it is usually difficult to see which parts of the complex belong to which protein with a prior art viewer.

Another basic limitation in state-of-the-art 3D viewers is that they usually do not show the user features or annotations associated with the structure or its related sequence. Currently, very few viewing systems offer annotations of the sequence or structure. Of these, only the Protein Mutation Database (pmd.ddbj.nig.ac.jp/˜pmd) displays annotations in a separate sequence view. This viewer shows mutant residues in the sequence view and structure view. However, only one mutation is shown at a time, and the there is no visual way to turn this annotation on or off (one has to use a menu command).

In general, there is an ever-growing pool of features and annotations related to sequence or structure available in various databases throughout the biological community. These data could be very useful in interpreting and understanding structures and in suggesting many insights to researches in the field.

In order to provide a representation that is more intellegible, various styles of representation have been proposed for representing chemical or biological entities. Depending on the level of detail desired, helix portions of a protein have been represented as ribbons, chains of residues by a C_{α}-trace, molecules in a wireframe representation or a ball and stick representation and so forth. The Ball & Stick representation displays atoms with a reduced van der Waals radius (e.g. scaled by ¼) and displays the covalent bonds in between the atoms as lines or as cylinders. The Wireframe representation displays covalent bonds with lines. Atoms that are not covalently bound can be displayed as 2D/3D cross. Atoms can also be displayed with a point of different size (i.e. bigger than the line width used for representing the bonds).

In the field of macromolecular graphic programs, only simple changes in the representation of molecules can usually be made. An exception therefrom is the program Cn3D. Cn3D uses the concept of “styles”, i.e. a predetermined combination of graphical features a user can select, which are, however, strictly limited to changing coloring and representation only. Many 3D viewers have a script-based language; the user can specify his own macros to transform the appearance of the molecule, sometime in a complicated way, with conditional statements. In summary, one does not find flexibility and ease of handling to the degree desirable to an end user who is not a computer expert.

It is a further object of the invention to provide a better ability to navigate from structure to multiple sequences and to provide a mechanism that allows the user to visually choose one or several from a larger number of annotations and modify the 3D view accordingly to indicate regions matching the selected annotations.

Another problem encountered in the field relates to viewing large complexes. In a three-dimensional graphical representation of large complexes, the picture can become confusing, if the entire complex is represented with the same level of detail. Thus an important feature of molecular graphics viewers is the ability to make selections of parts of the molecule and then apply operations to the selected elements, e.g. select all ligands in a molecule and e.g. change their representation to SpaceFill, and color their atoms by element type. Consequently, the ability to specify selections in a flexible way is very important in the field.

Most viewers were designed for experts, and hence emphasize rich and powerful feature sets, rather than usability for non-experts. Consequently, most viewers implement complex selections only via a scripting language, and provide only rudimentary mechanisms for graphical selections made with the mouse. For the non-expert, there is a step learning curve before he can harness the full power of most viewers. He must learn how to program the scripting language, and usually each viewers has its own idiosyncratic language.

Furthermore the increasing availability of large complexes require graphical selection methods that can handle higher-level data structures than in classical molecular graphics programs. In prior art molecule viewers, graphical selections (using the mouse to select objects of interest) usually work on a single, fixed level of the hierarchy. For example, in some viewers the user can only select atoms; in other viewers, only residues. Within one level, the user can only add or toggle individual elements in and out of the selection. A few viewers allow the user to change the level of click selection via a menu item. Selecting a menu item to modify the selection behavior is, in practice, very tedious for the user; after the click action is modified (e.g. so that click selects a whole chain), the user must usually-set it back to the default action (e.g. so that click now toggles off individual residues). Thus, complex selections can in principle be made via the GUI, but in practice very few people use them, since the process is too tedious.

In the Cn3D program the user can select ranges of residues from a sequence window. The corresponding range is highlighted in the structure. The user can also select multiple ranges, and reset ranges. It is, however, not possible to select ranges directly from the 3D view.

A related aspect is the zooming function. Whenever a complex structure is viewed, it is desirable to have a function enabling the user to inspect part of the structure in more detail. In order to zoom into part of an object in prior art 3D-viewers, one has to first move the whole object such that the required part lies in the center of the screen, then manually zoom until the desired magnification is reached. This already involves several iterative mouse drag operations. From that point, one usually has to then set the center of rotation to the desired part by separate operations; usually this is done in two steps, first selecting the desired part, then setting that to the center of rotation via a menu. In total, in prior art 3D viewers zooming to a desired part of an object and setting it to the rotation center involves at least four operations (translate, manual zoom, select, set center of rotation). It would be desirable to have a more easy zoom function.

### DETAILED DESCRIPTION OF THE INVENTION

The present invention provides for a method for organizing and depicting one or more biological elements comprising the steps of, receiving an input to select one or more databases, receiving further input to select one or more desired data sets from the one or more databases based on one or more selection criteria, determining at least one first feature element from each of said one or more data sets, determining a graphical representation for displaying at least one of the biological elements corresponding to said one or more data sets and, enhancing a display of a basic environment element by locating at least one of said graphical representations of said biological elements on said display of said basic environment element, depending on the information contained in said first feature element.

A biological element may be a compound, a molecule, regardless of whether they are of organic or inorganic nature. A biological element may also be a feature of a biological molecule, especially a sequence feature, such as SNPs/SAPs, exon/intron borders, postranslational modification sites (phosphorylation, glycosylation, acetylation, methylation, ubiquitination, etc.), and features predicted from bioinformatics analysis. In one embodiment the biological element is an element that may be found in living organisms, such as a protein, a nucleic acid, large macromolecular complexes, such as ribosomes or the like, but the invention is not limited to these. Also encompassed by this description are, e.g. pharmaceutical compounds or lead molecules which may be found in various databases. The invention also encompasses compounds which interact with molecules of a living organism to be biological elements. Such biological elements may be herbicides, pesticides or the like. One skilled in the art will recognize many different kinds of biological elements all of which should primarily either be present in a living organism or interact with a living organism or a part thereof.

The invention makes use of one or more databases herein a database may be for example, a flat-file database, or a relational database or an XML database. Commonly used databases for the foregoing invention are those which contain information on biological elements. Examples are SWISS-PROT, BIND, PDB, INTERPRO, GENBANK, and EMBL. The databases may present within the system that runs the method according to the invention or located externally.

The data sets are chosen based on one or more selection criteria. Such criteria may be the origin from which the biological element stems to which the data set pertains. For example, one may “choose all proteins known in humans”. Or one may “select all proteins that are present in the nucleus of a rat cell”. Or one may “select all human proteins that are related to cancer”. Or one may “select all mutations of the androgen receptor associated with prostate cancer”. Any given criteria may be applied for selecting the data sets and thus the biological elements.

When the method according to the invention is applied, a first feature element is determined for each of the data sets. The feature element represents a piece of information that characterizes the element in further detail and is needed to place the graphical representation within the display of a basic environment element. So in one embodiment for example data sets pertaining to human proteins are extracted from a database. The first feature element that is determined pertains to the information within the data set, which defines the localization of the proteins in a cell. This could be in the nucleus for example (see also figures). In a preferred embodiment this is done by extracting the sub-cellular location from, e.g. a SWISS-PROT entry, or from an entry in, e.g. the BIND database. For some biological elements, the subcellular location is not available in a database. In this case, the sub-cellular location can be inferred by applying a method for calculating properties such SignalP (Nielsen, H., J. Engelbrecht, et al. (1997). Protein Engineering 10: 1-6.) and/or PreLoc (Andrade, M. A., S. I. O'Donoghue, et al. (1998) Journal of Molecular Biology 276: 517-525). These predictions can also be precalculated and provided as a database.

The same or a further embodiment may provide that the biological elements comprise sequence features, such as SNPs/SAPs, exon/intron borders, postranslational modification sites (phosphorylation, glycosylation, acetylation, methylation, ubiquitination, etc.), and features predicted from bioinformatics analysis. In this case the first feature element may relate to the location of such sequence features on protein structures and may be extracted from a related database, such as HSSP (Schneider, R. and C. Sander (1996). “The HSSP database of protein structure-sequence alignments.” Nucleic Acids Research 24: 201-205).

Based on the first feature element, that biological element is placed into the space of basic environment. The basic environment may consist of a graphic chosen from the group comprising an organism, one or more tissue types, a cell, an organelle, a sub-cellular compartment, a molecule, or a molecule complex, especially a protein or protein complex, an atom and/or a sub atomic particle. It may also comprise more than one of the above. In one preferred embodiment of the invention it is a cell image or the three-dimensional image of a molecule. In embodiments where the basic environment is or comprises a cell, the different cell types which are possible are created separately; here in the figures, the inventors have chosen a generalized eukaryotic cell. The cell membranes may be e.g. defined using standard vector graphics methods, such as postscript curves; the curves are initially defined based on images of the cell topology from microscope images of cells. This is done either by hand or by fitting mathematical parametric curves to images of the membranes from cell micrographs. A background bitmap image is then constructed with different shadings to give more richness to the image, and help the user differentiate between different parts of the cell.

In one embodiment of the invention the method according to the invention makes use of molecules as biological elements. In this embodiment, e.g. proteins, nucleic acids, fatty acids, carbohydrates, peptides or the like are displayed. In one embodiment molecules which are found within living organisms are displayed together with those that are not known to be found within living organisms such as, e.g. pharmaceutical compounds. Hence, it is possible to analyze and/or depict their possible interaction. In a particularly preferred embodiment of the invention proteins are displayed.

In an embodiment, where the basic environment consists of one or more molecules, especially proteins, which may e.g. form a complex, the representation of the molecules can be of a standard type, wherein the position of basic elements, such as atoms or residues, are taken from a file or a database and the atoms or residues with bonds therebetween are shown at the respective coordinates in a three-dimensional representation using conventional graphics techniques. In such an embodiment, the method according to the invention may make use of parts or sub-entities of molecules as biological elements. For example, SNPs/SAPs, exon/intron borders, postranslational modification sites (phosphorylation, glycosylation, acetylation, methylation, ubiquitination, etc.), and features predicted from bioinformatics analysis may be displayed as such biological elements. In one embodiment, proteins or protein complexes of a living organism are displayed together with a ligand. If sequence elements are shown at the appropriate position on relation to the ligand, conclusions as to the possible interaction between the ligand and the molecule can be drawn, especially if the sequence features relate to mutations. If certain mutations are known to relate to certain diseases or biological processes, conclusions as to the role of the ligand for such diseases or processes can be drawn from such a three-dimensional representation of mutations in relation to a ligand.

In one embodiment of the method for organizing and depicting one or more biological elements according to the invention the display of said basic environment element is enhanced by locating at least 50 of said graphical representations of said biological elements on said display of said basic environment element. It is equally possible locate at least 500 of said graphical representations of said biological elements on said display of said basic environment element and it is particularly preferred to locate at least 5000 of said graphical representations of said biological elements on said display of said basic environment element.

In one embodiment all proteins known to be in a given cell type of one organism are depicted as biological elements according to the invention and the display of said basic environment element in this case a cell is enhanced by locating all of said graphical representations of said biological elements on said display of said basic environment element.

The method according to the invention makes it possible to add or subtract any of the biological elements, such as proteins for the environment of a cell or sequence features for the environment of a protein, to and from the display of said basic environment element at any given time. It is also possible to display different subsets of biological elements simultaneously by, for example by coloring the elements with different colors. Thus, it is possible to choose subsets by any criteria (such as an SRS query) and display the results of these queries.

Ordinarily one or more further feature elements are determined for said one or more data sets and the one or more further feature elements are extracted from the same database as the database from which the first feature element was determined. It is however just as likely that one or more further feature elements are determined for said one or more data sets and the one or more further feature elements are extracted from one or more different databases as the database from which the first feature element was determined.

So in a given example, human proteins are located within the virtual cell based on the information from the first feature element. The relationship, i.e. the binding of two or more proteins to each other, or the spatial closeness and/or distance amongst the proteins is depicted based on information stemming from a different database, that may for example contain experimental data from Yeast-Two-Hybrid experiments (methods such as described by Fields and Song Nature 340, pp245 (1989), Bartel et al., Biotechniques 14, pp920 (1993) and Lee et al. Nature 374 pp91-4 (1995)). It may also contain experimental data concerning macromolecular complexes determined either from mass spectroscopy or from X-ray crystallography. It may also contain data about protein interaction that is inferred or predicted by methods such as homology inference or protein-protein docking algorithms. Thus, in this preferred embodiment the second feature element helps organize the proteins in a biologically meaningful way. Whereas the first feature element also accomplished that, the intent there is to organize the biological elements with respect to their localization within the virtual cell. It is the intent of the second feature element to organize the proteins with respect to one another.

In one embodiment of the method according to the invention an additional step of, determining at least one second feature element for said at least one data set and, further enhancing the display of said basic environment element by using the information from said second feature element to place the at least one biological element into said basic graphical representation of said basic environment element is performed.

In a further embodiment a further feature element for said at least one data set is determined however it is used to further enhance the display of said at least one graphical representation of said biological element.

The inventors have made use of this embodiment of the invention, e.g. enhancing the image of proteins when shown within a cell. Here, information is extracted from the PDB database of three dimensional structures of biomolecules. Based on the area of the display of the basic environment element that is chosen, i.e. a close view or a distant view, it is possible to represent proteins as either ‘zero’-dimensional single points, as one-dimensional strings or graphical objects, as two-dimensional images, or as three dimensional objects.

In one embodiment of the invention a transition from one biological environment to a different biological environment may be provided. For example, if a user starts out with a representation where the basic environment is a cell and selects a protein represented in the cell, the representation may switch to a representation of this protein alone, i.e. without the environment of the cell. The protein may then form a new biological environment in the sense of the invention and the representation of biological elements, e.g. sequence features, such as SNPs/SAPs, exon/intron borders, postranslational modification sites (phosphorylation, glycosylation, acetylation, methylation, ubiquitination, etc.), and features predicted from bioinformatics analysis, may be superseded to the three-dimensional representation of this protein.

The exact 3D structure is presently only known for around 1% of known proteins. For about 20% of the proteins with unknown 3D structure, the 3D structure can be inferred by homology to one or more known structures. The inferred structure can be used as the best current model of the 3D structure. For around 80% of proteins, no precise details of the structure are available. For these proteins, some aspects of structure can still be inferred by prediction methods, such as secondary structure. The various information about the structure, predicted or experimental, can be combined into a 3D model. In the preferred embodiment, these model are represented in such a way as to make it clear that the 3D information is only inferred. This representation is chosen to be clearly different from that used to represent biological elements where the exact 3D is known.

Similarly, exact 3D structures of whole chromosomes will probably never be known at atomic detail. However, in the preferred embodiment, models of chromosome structures are built and used.

A further feature element for said at least one data set pertaining to said at least one biological element may contain information pertaining to one of the activities of said biological elements, thus the feature element may be used to enhance the display of said at least one graphical representation of said biological element by displaying the activity thereof. The inventors have used this feature of the invention to display, e.g. enzymatic activities. In this embodiment, e.g. a kinase enzyme may be displayed during the action of phosphorylating another protein. The feature element in this particular case is the entry within the data-set pertaining to the description of the enzymatic activity. Feature elements may also be used to, e.g. display the “life-time”, i.e. time of presence of a biological elements or other aspects pertaining to the fate of such an entity. Feature elements may also be used to enhance the display by depicting other physical or chemical properties of a biological element.

In some embodiments of the invention one or more databases, are chosen from the group comprising databases that comprise data sets with information regarding biomolecules, organic molecules and/or inorganic molecules found in living organisms. In preferred embodiments the databases comprise data sets with information regarding genes and/or proteins and/or chemical compounds.

The basic environment element is often a representation chosen from the group comprising an organism, one or more tissue types, a cell, an organelle, a sub-cellular compartment, a large complex of macromolecules, a molecule, an atom and/or a sub atomic particle.

In a preferred embodiment it is a eukaryotic, or prokaryotic, or archean cell or a virus particle.

It is of course possible to depict any of the elements either in a zero-dimensions (single points), one dimension, two dimensions, or three dimensions.

Time can also be added to the representation so that changes in the visual representation with time correspond to biological processes, such as differentiation, drug response etc.

In one embodiment the area that is depicted in said display of said basic environment element is selected by choosing an area in a second display of said basic environment element.

The inventors have done this for the eukaryotic cell. Here, one display shows the entire cell as well as a smaller window therein, which when moved, changes the area of the cell displayed in a second display (see also figures).

The invention also pertains to a display of a basic environment element, obtainable by a method according to the invention especially a computer display. The invention also pertains to a data structure representing a graphic display, said graphic display being obtainable by applying the method according to the invention. In one embodiment at least 50 of said graphical representations of said biological elements are presented, in another embodiment at least 500 of said graphical representations of said biological elements are present, in the most preferred embodiment at least 5000 of said graphical representations of said biological elements are presented.

The invention also concerns a computer readable medium for embodying or storing therein data readable by a computer, said medium comprising one or more of the following, a data structure generated by executing a method according to any of the embodiments of the invention, computer program code means which is adapted to cause a computer to execute a method according to any of the embodiments of the invention.

The invention also concerns a system for enabling different users to access and share common data structures associated with the method. The access may be either locally, within an organization, or may be distributed remotely, for example, via the internet.

The invention also concerns an apparatus for organizing and depicting one or more biological elements by applying the method according to the invention.

According to a further aspect of the invention, an improved system for mapping data onto related 3D structures is provided which allows annotations to be easily transferred onto structures for visualization. In a preferred embodiment, construction of the system involved comprises three steps:

(a) Construct Sequence-to-Structure Alignments (PSSH Database)

In a first step each sequence is aligned onto all matching 3D structures. For this purpose, it is essential that the alignment between the sequence and the structure is as accurate as possible. In addition to alignment accuracy, there is also the question of the threshold used to decide whether a sequence matches a structure or not. Prior art databases, such as the HSSP database (Schneider, R. and C. Sander (1996). “The HSSP database of protein structure-sequence alignments.” Nucleic Acids Research 24: 201-205), contain accurate alignments between sequence and structures, and the similarity thresholds are good. The main problem is the organization of the database: prior art databases are organized by structure, not by sequence. This means that each entry contains a list of all sequences that match a single structure; the entry also contains the full details of the alignment. Furthermore, since one structure can contain more than one protein chain, a single entry can contain matching sequences for several different proteins. With the current organization of prior art database entries, it is not possible to create a view showing matching structures to a given sequence.

According to the present invention several databases are constructed, e.g. from HSSP, that organize the information in a better way. The first database, referred to as PSSH subsequently, lists all structures that match a single sequence, and comprises information about the range of the match (i.e. which residues in the structure match which in the sequence). According to a preferred embodiment, structures are sorted by their similarity to the sequence, with the most relevant structures occurring first. This sorting is typically more useful than the sorting according to the prior art.

A second database, referred to as HSSPalign, stores the details of an individual sequence-to-structure alignment. A final database, HSSPchain, lists all sequences that match a single chain in one structure, as well as information about the range of the match (i.e. which residues in the sequence match which in the structure chain).

This organization of data makes it much easier to navigate from sequence to structure for a user, and also facilitate the mapping of sequence features onto structures. Full implementation details of how these databases were derived are given below.

It would be ideal to actually calculate a homology model for each sequence-to-structure alignment. However, in order to see where sequence annotations map onto homologous structures, it is quite sufficient to inspect only the template structure (since homology modeling, if it is done correctly, should not change the backbone coordinates more than a very small amount).

(b) Construct Dynamic Views from Multiple Databases

In a preferred embodiment the SRS system (Etzold, Ulyanov et al. 1996) is used. Firstly, it is a standard in the field for integrating heterogeneous databases. Virtually all relevant databases (sequence, structure, and annotation) are already integrated into SRS. Secondly, SRS has the possibility to create ‘hybrid’ views that combine data extracted on-the-fly from different databases (Etzold and Verde 1997). The only requirement is that the database entry can be crosslinked. According to a preferred embodiment, each sequence-to-structure alignment is a separate entry in the second database (HSSPalign) that can be crosslinked to, for example, SwissProt (Bairoch and Apweiler 2000). Crosslinking enabled under SRS also has the advantage that the views are dynamic, i.e. when a database, such as SwissProt is updated, this will be seen immediately the next time the user loads t a view according to the present invention.

(c) Display of Multiple Annotations

In a preferred embodiment, the present invention can display an alignment, read annotations that are given to it upon invocation, and display these data in addition to the normal 3D structure data. The annotation data passed from SRS to the 3D viewer component can include a URL for each individual feature element; from the 3D viewer it is then possible to link to the URL. Thus, it is for the first time possible to construct such combined representations on the fly from source databases and link e.g. SwissProt features and annotations from InterPro (Apweiler, R., T. K. Attwood, et al. (2001). “InterPro—an integrated documentation resource for protein families, domains and functional sites.” Bioinformatics 16: 1145-1150) from the 3D view.

The invention can be easily extended to DNA sequence databases by using the splice-form variant database in the same architecture.This would allow DNA sequence features, such as exon/intron boundaries to be shown mapped onto corresponding three-dimensional protein structures.

The invention also provides a new user interface for exploring and navigating structure and associated sequence information. The interface is comprised of different views that are tightly coupled to each other, so that changes in selections, coloring, or representation in one view can be automatically propagated to all other views.

According to an embodiment of the invention the interface comprises a plurality of the following view components:

(a) 3D View.

The basis of the interface is a 3D view showing the 3-dimensional structure of e.g. a macromolecule or macromolecule complex, ensembles of proteins or whole cells, and providing functionality, such as zoom, rotation etc..

(b) Sequence Overview.

This view initially shows all sequences of the structure and all provided aligned sequences. When a selection is made (either in this view or in one of the other views) of part of a sequence, the corresponding sequence region(s) on this view is (are) highlighted. This view automatically zooms so that only the selected sequence is visible, thus providing a slightly more detailed view of this sequence. Usually, this view shows the entire selected sequence, allowing the user to easily see where his selection corresponds in the sequence. However, the view can be fine-tuned to zoom to a maximum number of residues (say 400), enabling an even more detailed look at the sequence in the proximity of the selection. When the selection is canceled, the view returns to showing all sequences in the structure. This view and behavior are helpful to the user to maintain an overview of which part of a sequence he has selected, and is particularly helpful when viewing molecular complex structures with many sequences.

According to a specific embodiment another feature of this view a ‘focus’ box indicates the region of residues that are displayed in the Sequence Detail View, which will be explained below. The focus is automatically adapted to the selection.

(c) Sequence Detail View.

This view shows a range of alphabetic characters corresponding to the one-letter aminoacid or nucleic-acid code for a protein or a DNA. The view has only a single line of characters (usually less than 50, depending on the screen width, resolution, and font-size chosen). This corresponds to a small residue window of one sequence; the position of the residue range shown in this view is indicated by the focus box in the sequence overview, thus showing the user exactly where this range of residues fits into the whole sequence. The range of residues in this view is updated automatically when the selection is changed. Most selections are small (one or a few residues); in such cases, the view adjusts so that all selected residues are included. When all residues cannot be included (for example, either a very large range of residues is selected, or two residues on different sequences are selected), the view will focus on the first chosen, or N-terminal range.

The range of residues can also be reset by dragging the focus box in the Sequence Overview. This view, combined with the above view, avoids the problem associated with sequence views where the user needs to ‘zoom’ into the sequence to see the residue details; such zooming can be awkward when one wants to navigate quickly to see, for example, the details from two different parts of a sequence (e.g. the N- and C-terminal residues).

(d) Annotation View.

This view is closely synchronized to the Sequence Overview, and shows the annotations or features associated with each sequence. The annotation can be grouped by type (for example, all domain annotations, or all SNPs) into lanes. Many different annotation lanes can be shown. From this view, the user can ‘activate’ a whole annotation lane; this in turn has the effect to change the molecule coloring or representation of the 3D structure (in other views) to highlight the residues that match that annotation. One or more annotations can be activated at a time; the user can also select an individual feature, rather than an entire annotation lane, changing the representation of just those residues. Annotations are usually derived from other databases, and each feature has one or more hyperlinks to related database entries. From this view, the user can either directly link to these entries, or, by activating the annotation on the structure, can enable direct linking from part of the 3D structure to related database entries concerning specific features.

The invention also allows the user to select the source of the annotations. Usually, a set of annotations are available from a given database entry. For example SwissProt contains usually several different kinds of annotations for each protein. The user can choose another view that shows annotation sets from another database, e.g. InterPro.

(e) Hierarchy View.

Macromolecules are organized according to an intrinsic hierarchy (atoms, residues, secondary structure elements, chains, complexes); it is useful to include a hierarchy viewer (similar to a file system browser) that enables selection by hierarchy, especially for navigating larger complexes.

A further aspect of the invention provides a mechanism enabling a user to select representation styles that involve at least one non-trivial step involving a calculation on or analysis of the sequence or structure, the outcome of which determines a change in the appearance (representation, coloring, etc.) or behavior of regions of molecules of special interest. Each style could have several parameters controlling this calculation step; these parameters, along with the coloring, representation, and behaviors, can be modified by the user using a style sheet window, as known in the art. Styles can be applied either globally to the whole molecule, or to a specific part of the molecule specified in the current selection, the aspect of selection being explained in more detail below.

The following are styles that have been found to be useful to end-users of these programs, as they greatly facilitate important use-cases.

(a) First Impression Style.

This style highlights the overall structure of the molecule to give an informative ‘first glance’ overview of the whole structure. For example, polypeptide chains are displayed as ribbons, single chains are coloured by secondary structure, oligomers of identical molecules are coloured by chain, complexes with different molecules are coloured by molecule. Ligands and disulfide bonds are displayed prominently.

(b) Binding Site Style.

While the first impression style is generally useful to get an overall impression of the whole molecule; the binding site style enables an easy way to switch to an alternative representation that highlights details of protein-ligand interaction. The ligand may be displayed in Ball & Stick representation with carbons colored green. Otherwise element coloring is used, wherein atoms (and bonds associated with the atoms) are coloured accordingly to the element type of the atom. Proximal atoms within a predefined range (e.g. 4 Å) on other molecules may be expanded and displayed in a wireframe representation using element coloring (e.g. carbons gray), i.e., visibly different to that of the ligand. In a wireframe representation covalent bonds are displayed by lines. Atoms without a covalent bond can be displayed as 2D/3D cross. Atoms can also be displayed as point with a size bigger than the thickness of the lines indicating the bonds.

The ligand and proximal atoms are preferably brightly colored. Parts of the protein that are not proximal to the ligand may be in Cα-Trace representation and reduced in brightness (colored dull). Further, the solvent accessible surface of the proximal residues can be displayed (i.e. transparent). Proximal water molecules can be displayed (e.g. using Ball & Stick or Wireframe representation). All other sidechains may be hidden, allowing the user to more easily distinguish the active site residues.

(c) Binding Surface Style.

The binding surface style is like the binding site style, except that the surface of the protein active site in direct contact (say 4 Å) with the ligand molecule is calculated and displayed.

(d) Homology Style.

The homology style is like the first impression style except that coloring is by sequence similarity; this similarity is calculated from the alignment of sequence to structure (see above). Usually this style will only be used when an alignment is present, although it is, of course, be possible to use related data without the actual display of an alignment.

(e) Displacement Style.

The Displacement Styles can be applied to superimposed structures A and B. In the computational step the viewer determines matching residues in A and B by computing a structure-structure alignment. In this style matching residues of A and B are colored according to their spatial distance (by applying a specific metric). One possible implementation. is to apply a gradual coloring that colors close (in terms of the metric) matching residues green and fades to blue for more distant residues. Unmatched residues are colored separately in an additional differentiable color (e.g. gray). In one embodiment, structure A is considered as basis structure and is in a default Ribbon representation. According to a certain embodiments ligands have element coloring (darkened). The visibility of the superimposed structure B can be reduced, by representing it in a half transparent Coil representation.

The changes due to applying these styles can also be propagated to different views, such as mentioned above, and influence the appearance of the corresponding object in those views.

According to the invention a general selection scheme is provided that allows flexible selections and deselections. According to an important aspect, the user is enabled by the invention to select in a way that is natural or intuitive given the intrinsic hierarchical organization of such data, i.e. atom, residue, secondary structure element, chain fragment, chain, complex, and higher levels of organization, such as bound to the same chromosome or occurring in the same subcellular location. A hierarchy—dependent selection scheme is a powerful tool for making the view more intelligible. In case of a macromolecule or even a single molecule a hierarchical data structure is inherent. Thus, it should be noted that the selection scheme is most powerful in conjunction with a hierarchical object organization.

Certain preferred special selection behaviors of the model will be described below.

According to a further aspect of the invention, an improved and simplified zoom function is provided for a 3D molecular viewer. Whereas it was necessary to perform several subsequent actions (e.g. translate, manual zoom, select, set center of rotation) according to the prior art, the invention, in one embodiment thereof, unifies all the above mentioned operations into a single operation (e.g. a key stroke or mouse action, such as double-click). According to one embodiment this operation selects a desired object (objects), zooms continuously to this selection (until all selected objects nearly fill the available screen), and sets the center of rotation to the geometric center of the current selection (i.e. the average of the spatial coordinates of all selected objects). Clicking to a point outside the structure may, in one embodiment, shrink the representation to a full view of the object or to the scale of representation prior to zooming. The auto-zoom tool according to the invention is very useful to navigate in macromolecules and it is of particular interest when examining binding pockets. It is also useful to navigate from high level views, such as whole cell views, to low level views, such as the view of a single molecule.

It should be noted that this zoom function is not restricted to applications where a three-dimensional structure of a molecule is represented. It can also be applied instances where the basic environment in the representation is a cell or another biological entity above the molecular level. It may especially be provided that one can zoom in and out to the molecular level and/or submolecular level and that in doing so, the basic environment of the representation may change. Thus, one may zoom to a protein in a cell which will eventually result in the protein being displayed without the environment of the cell, however, given the case, with some sub-molecular details, such as the sequence features mentioned previously. Vice versa, zooming out from a protein may result in the protein being eventually represented in a cellular environment or, zooming out even further, in the protein even disappearing from the representation or being reduced to a dot or point.

According to a preferred embodiment, the zoom is continuous until the desired zoom factor is reached so that a user visually experiences the increase/decrease in scale as by a telescope.

A zoom feature may also be employed in a one dimensional representation of long sequences or a subsequent representation of sequences of different molecules of an ensemble in a line, e.g. in a sequence overview explained subsequently. Selecting a molecule in an ensemble focuses the one dimensional representation on the sequence of the selected molecule, i.e. the one-dimensional representation is shown or shown centered on the screen. Likewise, selected parts of the sequence may be focussed. Additionally or alternatively, a corresponding focus of a three-dimensional representation may be provided simultaneously.

The zoom function according to the invention can be combined with the selection scheme described in more detail below. An arbitrary selection can be made, and an auto-zoom operation can be applied to the current selection. At the end of the operation, the selected parts of the molecule will nearly fill the screen, and will be the center of rotation. This combination is very useful for navigating within visualizations of groups of 3D objects, and especially for macromolecules.

Various aspects of the present invention will be summarized below.

According to one aspect, the present invention provides a method for organizing and depicting one or more biological elements comprising the steps of

receiving an input to select one or more databases,

receiving further input to select one or more desired data sets from the one or more databases based on one or more selection criteria,

determining at least one first feature element from each of said one or more data sets,

determining a graphical representation for displaying at least one of the biological elements corresponding to said one or more data sets and,

enhancing a display of a basic environment element by locating at least one of said graphical representations of said biological elements on said display of said basic environment element,

depending on the information contained in said first feature element.

The invention may provide that the biological elements are selected from the group comprising molecules, complexes of molecules, atoms, sub-atomic particles, SNPs/SAPs, exon/intron borders, postranslational modification sites (phosphorylation, glycosylation, acetylation, methylation, ubiquitination, etc.), and/or features predicted from bioinformatics analysis.

The invention may provide that the display of said basic environment element is enhanced by locating at least 50 of said graphical representations of said biological elements on said display of said basic environment element.

The invention may provide that the display of said basic environment element is enhanced by locating at least 500 of said graphical representations of said biological elements on said display of said basic environment element.

The invention may provide that the display of said basic environment element is enhanced by locating at least 5000 of said graphical representations of said biological elements on said display of said basic environment element.

The invention may provide that one or more further feature elements are determined for said one or more data sets and the one or more further feature elements are extracted from the same database as the database from which the first feature element was determined.

The invention may provide that one or more further feature elements are determined for said one or more data sets and the one or more further feature elements are extracted from one or more different databases as the database from which the first feature element was determined.

The invention may provide the step of determining at least one second feature element for said at least one data set and further enhancing the display of said basic environment element by using the information from said second feature element to place the at least one biological element into said basic graphical representation of said basic environment element.

The invention may provide the step of determining at least one further feature element for said at least one data set and further enhancing the display of said at least one graphical representations of said biological element by using the information from said further feature element.

The invention may provide that a further feature element for said at least one data set pertaining to said at least one biological element contains information pertaining to one of the activities of said biological elements and the feature element is used to enhance the display of said at least one graphical representation of said biological element by displaying the activity thereof.

The invention may provide that said one or more databases, are chosen from the group comprising databases that comprise data sets with information regarding biomolecules, organic molecules and/or inorganic molecules found in living organisms.

The invention may provide that the databases comprise data sets with information regarding genes and/or proteins and/or chemical compounds.

The invention may provide that the basic environment element is a representation chosen from the group comprising an organism, one or more tissue types, an organ, a cell, an organelle, a sub-cellular compartment, a complex of molecules, a molecule, an atom and/or a sub atomic particle.

The invention also provides a data structure representing a graphic display, said data structure being obtained by a method as previously described and a computer readable medium for embodying or storing therein data readable by a computer, said medium comprising one or more of the following:

a data structure generated by executing a process as previously described,

a computer program comprising code means which is adapted to cause a computer to execute a method as previously described.

The invention also provides an apparatus for organizing and depicting one or more biological elements, said apparatus comprising a receiving module for receiving an input to select one or more databases, a receiving module for receiving further input to select one or more desired data sets from the one or more databases based on one or more selection criteria, a determination module for determining at least one first feature element from each of said one or more data sets, a determination module for determining a graphical representation for displaying at least one of the biological elements corresponding to said one or more data sets and, an enhancing module for enhancing a display of a basic environment element by locating at least one of said graphical representations of said biological elements on said display of said basic environment element, depending on the information contained in said first feature element.

The invention may provide one or more views separate from the representation of said basic environment, wherein biological elements are represented and selection of said biological element leads to an enhancement of the representation of said basic environment by a representation of said element.

The invention may provide that said representation of said biological elements in said separate view forms a means for access to data not involved in the representation of said basic environment, i.e. data that are not directly accessed by the system for representing said basic environment or enhancements thereof. Especially, said representation may comprise a pointer to a further programming object, e.g. a link to one or more entries in an internal or external database. Said data may comprise information on biological elements relevant to a portion of said basic environment the representation of which could be potentially enhanced. In one embodiment said representation of biological elements may be non-specific to a particular biological element in that it is just a symbol indicating a site, e.g. a site of a molecule, such as a protein, and said data may provide information on biological elements relevant to said site and/or their spatial and/or functional relation to said site. Of course said representation of biological elements may as well represent a specific biological element and provide access to information thereon.

The invention may further provide that interacting with a portion of said representation of said basic environment on a graphical user interface invokes an access to data not involved in the representation of said basic environment and containing information on biological elements related to said portion of said basic environment. The invention may further provide that on the basis of such information and, given the case, further information previously stored or otherwise accessible, a graphical representation of a biological element indicated by such data is created and the representation of said basic environment is enhanced by said representation of said biological element.

The invention may provide that the representation is a two- or three-dimensional representation.

The invention may provide that said basic environment element is a ligand molecule and said biological element comprises one or more linear molecules, e.g. macromolecules, especially one or more linear macromolecules having binding sites related to ligands, especially ligands known or supposed to bind to said binding sites. The feature element may comprise information about the binding site of a molecule and ligands binding to said site or features of ligands that are relevant for binding to said site. Thus, the invention provides both the possibility to view the spatial relation between a macromolecule and a ligand binding thereto and the possibility to arrange a macromolecule and a ligand in a spatial relation corresponding to a possible bond and to analyse the spatial relation in more detail. Information about the macromolecule (or another biological entity related to a ligand) can be obtained via a dynamic link to a database. Especially, it is possible to update information about matching ligands/molecules via such a dynamic link.

Of course, the invention may also work the other way round in that the basic environment represents a macromolecule, e.g. a protein in three dimensions, and the biological element to be inserted corresponds to a ligand.

The invention may also provide that said basic environment element is a molecule, e.g. a linear molecule, especially a linear polymer molecule, e.g. a protein or a DNA, or an ensemble of molecules, especially an ensemble of such linear molecules.

The invention may further provide that said biological element corresponds to a part of said molecule.

The invention may especially provide that the basic environment element is a three-dimensional protein structure and the biological elements are protein features, such as SNP, domain boundaries, exon/intron borders, annotations of active site residues and/or post-translational modifications, or other similar objects.

The invention may provide that said basic environment element is a three dimensional representation of a linear molecule, that one or more one dimensional representations of the sites of said linear molecule are provided on a graphical user interface, preferably the same graphical user interface as the one containing said three-dimensional representation of said linear molecule, that one or more biological elements, e.g. elements, sub-structures or domains of said molecule, are represented in one or more of said one dimensional representations and that interacting with the representation of a biological element in one of these one-dimensional representations results in said three-dimensional representation of said linear molecule to be enhanced by the selected biological element.

The invention may provide that one or more biological elements are shown as being assigned to one or more sites of said molecule in one or more of said one-dimensional representations of said sites of said molecule and that selecting a biological element results in enhancing the three dimensional representation of said molecule by a representation of said element at the site to which it is shown to be assigned in said one-dimensional representation.

The invention may provide a method wherein a three dimensional representation of a macromolecule is displayed together with a one-dimensional representation of said macromolecule.

The invention may be characterized in that said one dimensional representation is a character representation.

The invention may provide a method wherein the graphical representation of said biological element is different from the graphical representation of said environment element.

The invention may provide a method wherein a molecule, especially a biological macromolecule, comprises a sequence of elements and differs from the sequence of a second molecule, e.g. another biological macromolecule, aligned thereto such that there is an optimum match of the elements at the aligned sites of said first and second molecules, wherein said biological element consists of one or more elements of said first molecule differing from the aligned sequence of said second molecule and said first feature element comprises information on the site or sites of said differing elements, wherein said biological element is represented at the sites indicated by said first feature in a manner different from the representation of said macromolecule.

The invention may be characterized in that means are provided for selecting a part of said basic environment element on which whole or part of said biological element is to be located in said graphical representation.

The invention may provide a method wherein a one-dimensional representation of a linear molecule, especially a macromolecule, such as a protein, is displayed, a range of elements of said molecule is selected in said one-dimensional display, wherein said biological element is a part of said molecule and is depicted at the location of the three-dimensional representation of said molecule corresponding to the selected range in that one dimensional representation.

The invention may comprise the step of determining the area that is depicted in said display of said basic environment element by selecting an area in a second display of said basic environment element.

The invention may provide a method characterized in that a range of a molecule, especially a macromolecule, displayed and/or selected and/or the element on which the cursor is currently positioned are displayed in said one-dimensional representation.

According to a further aspect, the invention provides a method of visualising biological entities, especially linear macromolecules, by means of a data processing system, comprising the steps of

providing a multidimensional graphical representation of one or more biological entities on a graphical user interface,

interacting with said graphical user interface to select a point or feature of a portion of said graphical user interface containing said representation,

determining a part of a biological entity to be selected that was not represented by a feature selected in said previous interaction step and selecting said part of said biological entity,

performing an operation on the representation of the selected part of said entity.

The invention may provide that the representation of at least one biological entity comprises a plurality of individual graphical elements, said feature selected in said step of interacting with the graphical user interface is a graphical element of the representation of said biological entity and wherein a further part of said biological entity is determined to be selected that was not represented by a said selected graphical element.

The invention may provide that said step of selecting a graphical element of said representation implies the selection of the portion of said entity represented by said graphical element.

The invention may provide that said step of selecting a graphical element of said representation implies the selection of only part of the portion of said entity represented by said graphical element. For example, if the graphical element represents a structural unit in a macromolecule, such as a helix, a domain, or the like, the invention may provide that by selecting said graphical element the first or last residue of said structural unit is selected or, to go to more elaborate examples, that the atom or residue of said structural unit closest to a ligand is selected.

It may also be provided that that portion of said entity is selected that correponds to a predetermined type of element located at or close to a point where the interaction with a graphical user interface took place. For example, the graphical element may be a ribbon and clicking the ribbon will select the residue located at the position of the ribbon where the cursor was when the mouse was clicked. The selected portion does not necessarily have to be a residue or another elementary part of the entity. Especially, with a biological entity with a hierarchical structure, as explained in more detail below, the selection could be to a unit at the selected level of hierarchy. For example, if the lowest level is a residue and the selection at lowest level is selected, a click will select a residue. If a higher level is selected, a click may select a helix, or a domain.

The invention may further provide that said biological entity is a linear molecule and said method comprises the steps of:

interacting with said multidimensional graphic representation to select a further graphical element of the multidimensional graphical representation of said molecule, thereby selecting the entire range of said molecule represented by the portion of said graphical representation from said first graphical element to said second, further graphical element,

performing an operation on the representation of the selected range of said molecule.

The invention may provide that said biological entity is a linear molecule and said step of determining a further part of said biological entity comprises the steps of interacting with said multidimensional graphical representation to select a further graphical element of the graphical representation of said biological entity, thereby adding the portion of said biological entity represented by said graphical element to the selected part of said biological entity.

The invention may provide the step of providing data representing one or more biological entities, at least one of these entities being represented as consisting of basic biological units, especially residues of a sequence.

The invention may provide that said data related to said biological entity comprise data assigning one or more basic biological units to one or more structural units of said biological entity, said structural units and said basic biological units forming a hierarchy in that each of said structural units comprises at least one basic biological unit and/or another structural unit. The entity itself may form a structural unit in the sense of this hierarchy. Usually, it is the unit at the highest level of hierarchy.

For example, one or more of the hierarchy levels of atoms, residues, secondary structure elements, chains, complexes and ensembles of molecules may be provided for macromolecules. The invention may provide for such a hierarchical structure of said entity that said step of determining a part of a biological entity to be selected comprises the steps of:

determining a level of hierarchy and

selecting a basic biological unit and/or structural unit at the determined level of hierarchy which comprises a basic biological unit or group of basic biological units of said biological entity previously selected.

The invention may provide that in a first step one or more graphical elements of said representation are selected and in a further step all basic biological units and/or structural units at the chosen level of hierarchy are selected that comprise basic biological units corresponding to any of said graphical elements of said representation selected in said first step.

The invention may provide that one graphical element of said representation is selected by interacting with said graphical representation of said biological entity and that the structural unit at said level of hierarchy is selected which comprises all basic biological units of said biological entity corresponding to the selected element of said representation.

The invention may provide that said level of hierarchy is the next higher level to that of the greatest structural unit comprised in the group of selected basic biological units.

The invention may provide that said level of hierarchy is greater or equal to that of the greatest structural unit represented by a previously selected graphical element.

The invention may provide that said level of hierarchy is in a predetermined relation to the level of hierarchy represented by a selected graphical element. For example, it may be the next higher level or a certain number of levels apart. The level with regard to said graphical element may also be determined by a keystroke and/or mouse click.

The invention may further provide that in a first step one or more basic biological units are selected, a graphical element is further selected as an anchor object and that said level of hierarchy is in a predetermined relation to the level of hierarchy represented by said anchor object.

The invention may provide that said selection of the level of hierarchy is effected by a keystroke and/or mouse click.

The invention may provide that a further part of the biological entity to be selected is determined by a calculation having as input parameters parameters related to one or more selected points or features of the graphical user interface or one or more basic biological units and/or structural units previously selected.

The invention may provide that those basic biological units and/or structural units within a certain distance around a point or feature selected in said graphical user interface are determined and the basic biological units and/or structural units determined are selected.

The invention may provide that the part of said biological entity comprising the basic biological units and/or structural units determined by said calculation are displayed differently from the previous representation of said biological entity.

The invention may provide that the part of said biological entity comprising the basic biological units and/or structural units determined by said calculation are displayed differently from other parts of the representation of said biological entity.

The invention may provide that a representation of said basic biological units and/or structural units determined by said calculation is displayed and/or marked subsequent to said calculation.

The invention may provide that those basic biological units and/or structural units closest to a point or feature selected in a portion of a said graphical user interface containing said representation of said one or more biological entities are determined by said calculation.

The invention may provide that said interaction with said graphical user interface comprises a mouse click and/or keystroke.

The invention may provide that said selected part of the biological entity is represented differently from the rest of the biological entity, especially by a different colour or a brighter shade of the same colour.

The invention may provide that said selected part is represented in a different style.

The invention may provide that said representation is zoomed to the selected part of said biological entity upon activating the zoom operation e.g. by a mouse click and/or a keystroke.

The invention may provide that said zoom is such that the selected part of said biological entity is fully displayed on the screen. It may be provided that it fills a predetermined portion, e.g. 80 %, of said screen.

The invention may provide that said operation comprises executing a link assigned to a selected part of said biological entity or a selected part of the representation thereof and displaying information provided by said link

The invention may provide that at least one of said biological entities comprises a molecule and a binding surface of said molecule is calculated with regard to the selected point or feature.

The invention may provide that said selected feature is the representation of a further molecule or part thereof, especially of a ligand to a protein or protein complex.

According to a further aspect, the invention provides a method of visualising biological entities, especially linear macromolecules or ensembles thereof, by means of a computer, comprising the steps of

providing data representing at least one biological entity as consisting of basic biological units wherein said data related to said biological entity comprise data assigning one or more biological units to one or more structural units of said biological entity, said structural units and said biological units forming a hierarchy in that each of said structural units comprises at least one basic biological unit and/or another structural unit,

providing a multidimensional graphical representation of one or more biological entities on a graphical user interface,

selecting a level of hierarchy and

operating on the graphical user interface on the basis of the selected hierarchy.

The invention may provide that said biological entity is a linear molecule and a cursor movement is provided along said molecule in steps of one or more structural units at the chosen hierarchy level.

The invention may provide that a certain representation style is assigned to each hierarchy level and a biological entity is depicted according to the style determined for said hierarchy.

The invention may provide that the representation of said biological entity is shown as consisting of graphical elements, at least part of which correspond to structural units at the chosen level of hierarchy.

The invention may provide that a part of the representation of said biological entity is selected and an operation on said selected part is performed on the basis of the selected hierarchy.

The invention may provide that different levels of hierarchy are chosen for different parts of said representation of said biological entity.

The invention may provide that one or more, preferably all of said different parts are determined by selecting a portion of said biological entity and an individual level of hierarchy for operations on the graphical representation of the respective selected portion is chosen.

The invention may provide that said level of hierarchy is chosen by a keystroke and/or a mouse click.

The invention may provide that by means of a keystroke and/or mouse click the next higher or lower level of hierarchy is selected.

The invention may provide that in response to a cursor operation in the vicinity of or on a graphical element of said graphical representation a continuous auto-zoom is effected to the structural unit at the chosen hierarchy level part or whole of which is represented by said graphical element.

According to a further aspect, the invention provides a method of visualising linear molecules or ensembles thereof, especially biological macromolecules, by means of a computer comprising the steps of

providing data representing one or more molecules as consisting of basic units,

providing a multidimensional graphical representation of the molecule or molecules on a graphical user interface,

providing a one-dimensional representation of said linear molecule or molecules on the same graphical user interface, said one-dimensional representation comprising subsequent graphical sites representing the site of subsequent basic units, wherein each basic unit is represented by a symbol indicating the respective basic unit,

providing at least one further one-dimensional representation comprising a sequence of graphical sites which are at least partly aligned with the one-dimensional representation of said linear molecule or molecules on the same graphical user interface,

interacting with one of said further one-dimensional representations to select one or more sites corresponding to sites of basic elements of said linear molecule or molecules,

selecting the basic units in the multidimensional representation of said molecule or molecules corresponding to the selected sites in said further one-dimensional representation.

The invention may provide a method characterized by the step of performing an operation on the multidimensional representation of the selected sites of said molecule or molecules.

The invention may provide that a further one-dimensional representation corresponds to a further linear molecule different from said first molecule and matching the first linear molecule at least over part of said sequence of sites according to predetermined criteria, said one-dimensional representation of said further linear molecule being arranged such that matching sites in said one-dimensional representations are aligned.

The invention may provide that a further one-dimensional representation comprises sites aligned with said first or second one-dimensional representation and comprising symbols indicating information related to a basic unit of said first or second molecule.

The invention may provide that selecting one of said symbols effects a different representation of the portion of the multidimensional representation of said molecule corresponding to the site of said selected symbol.

The invention may provide that said information is displayed in said multidimensional representation.

The invention may provide a method of visualising an ensemble of linear polymer molecules comprising the steps of

providing data representing the molecules of said ensemble,

providing a multi-dimensional graphical representation of said molecules on a graphical user interface on the basis of these data,

providing a one-dimensional representation of said linear polymer molecules on the same graphical user interface, wherein all sequences of the molecules of said ensemble are represented in one line.

According to this embodiment, it may be provided that selecting one of said molecules in said multi-dimensional representation or said one-dimensional representation results in a zoom to the sequence of said molecule in said one-dimensional representation and/or said multidimensional representation. This zoom may especially be a continuous auto-zoom.

The invention also provides a method of visualising biological entities, especially linear macromolecules or ensembles of linear macromolecules, by means of a computer comprising the steps of

providing a multidimensional graphical representation of one or more biological entities on a graphical user interface,

selecting one or more points or features of a portion of said graphical user interface containing said representation,

performing a calculation having as input parameters parameters related to one or more selected points or features of the graphical user interface or one or more portions of a biological entity previously selected and having as output data related to a multidimensional graphical representation of a biological entity,

altering said multidimensional graphical representation according to the result of said calculation.

The invention may provide that portions of a biological entity within a certain distance around a point or feature selected in said graphical user interface are determined by said calculation.

The invention may provide that a part of said biological entity is selected as a result of said calculation and the selected part of said biological entity is displayed differently from the previous representation of said biological entity, especially in a different representation style.

The invention may provide that a part of said biological entity is determined by said calculation and said part is displayed differently from other parts of the representation of said biological entity.

The invention may provide that a representation of a part of said biological entity is determined by said calculation and said part is displayed and/or marked subsequent to said calculation.

The invention may comprise the step of providing data representing one or more biological entities, at least one of these entities being represented as consisting of basic biological units, especially residues of a sequence.

The invention may provide that said data related to said biological entity comprise data assigning one or more basic biological units to one or more structural units of said biological entity, said structural units and said basic biological units forming a hierarchy in that each of said structural units comprises at least one basic biological unit and/or another structural unit.

The invention may provide that one or more basic biological units and/or structural units are determined as the result of said calculation.

The invention may provide that those basic biological units and/or structural units closest to a point or feature selected in a portion of a said graphical user interface containing a multidimensional representation of said one or more biological entities are determined.

The invention may provide that a zoom factor is determined such that the area spanned by selected points and/or features covers a given percentage of the area provided for said multidimensional representation in said graphical user interface and wherein a corresponding zoom is performed.

The invention may provide that one or more structural units or basic biological units are determined according to a previously determined relation to the selected points or features and a zoom factor is determined such that the area covered by said basic biological units and/or structural units covers a given percentage of the area provided for said multidimensional representation in said graphical user interface and wherein a corresponding zoom is performed to a said basic biological units and/or structural units.

The invention may provide that one or more graphical elements of a multidimensional graphical representation of a biological entity are selected and one or more structural units at a given hierarchy level are determined which comprise basic biological units represented by one or more selected graphical elements of said representation and a zoom factor is determined such that the area covered by said structural units covers a given percentage of the area provided for said multidimensional representation in said graphical user interface.

The invention may provide that at least one selected graphical element corresponds to a structural unit at a certain level of hierarchy and the zoom is to said structural unit.

The invention may provide that a level of hierarchy is selected and the zoom is to the structural unit or structural units at the selected hierarchy level comprising selected graphical elements or graphical elements in the vicinity of one or more selected points in said graphical user interface.

The invention may provide that said step of selecting is effected by one or more mouse clicks and/or keystrokes and said steps of calculating and altering the representation are performed in response to these mouse clicks and/or keystrokes.

The invention may provide that said steps of selecting, calculating and altering the representation are performed in response to one single mouse click.

The invention may provide that said zoom is effected in response to one single mouse click, given the case with or without a simultaneous keystroke, such as ALT, CTRL, etc.

The invention may provide an apparatus for visualising biological entities, especially linear macromolecules or ensembles of linear macromolecules, comprising

means providing a multidimensional graphical representation of one or more biological entities on a graphical user interface,

interaction means for interacting with said graphical user interface to select a point or feature of a portion of said graphical user interface containing said representation,

means for determining a part of a biological entity to be selected that was not represented by a feature selected in said previous interaction step and selecting said part of said entity,

means for performing an operation on the representation of the selected part of said entities.

The invention may provide an apparatus characterized in that it comprises means for performing the steps of a method as described previously.

The invention may provide that the apparatus is adapted to perform the steps of determining a part of a biological entity to be selected that was not represented by a feature selected in said previous interaction step and/or selecting said part of said biological entity and/or performing an operation on the representation of the selected part of said entities automatically in response to a user interacting with said graphical user interface to select a point or feature of a portion of said graphical user interface containing said representation.

The invention may provide that upon selecting a graphical element of said representation by a user the apparatus selects the portion of said entity represented by said graphical element.

The invention may provide that upon selecting a graphical element of said representation by a user the apparatus selects only part of the portion of said entity represented by said graphical element.

The invention may provide that a biological entity represented is a linear molecule, wherein upon interacting with said multidimensional graphic representation to select a further graphical element of the multidimensional graphical representation of said molecule, the apparatus selects the entire range of said molecule represented by the portion of said graphical representation from said first graphical element to said second, further graphical element and wherein said apparatus is adapted to perform an operation on the representation of the selected range of said molecule only.

The invention may further comprise means for determining a level of hierarchy and wherein said apparatus automatically selects a structural unit at the determined level of hierarchy which comprises a basic biological unit or group of basic biological units of said biological entity previously selected.

The invention may provide that upon selecting a plurality of graphical elements of said representation is selected the apparatus selects in a further step all structural units that comprise basic biological units corresponding to any of said graphical elements of said representation selected in said first step.

The invention may provide that upon selecting one graphical element of said representation by interacting with said graphical representation of said biological entity the apparatus selects the structural unit at said level of hierarchy which comprises all basic biological units of said biological entity corresponding to the selected element of said representation.

The invention may provide that said apparatus selects the next higher level to that of the greatest structural unit comprised in the group of selected basic biological units.

The invention may provide that said apparatus automatically selects the next higher level to that of the greatest structural unit comprised in the group of basic biological units selected previously.

The invention may provide that said apparatus determines a further part of the biological entity to be selected by a calculation having as input parameters parameters related to one or more previously selected points or features of the graphical user interface or one or more basic biological units and/or structural units previously selected.

The invention may provide that said apparatus displays the part of said biological entity comprising the basic biological units and/or structural units determined by said calculation differently from the previous representation of said biological entity and/or from other parts of the representation of said biological entity.

The invention may provide that said apparatus displays and/or marks a representation of said basic biological units and/or structural units determined by said calculation subsequent to said calculation.

The invention may provide that said apparatus displays a selected part of a biological entity differently from the rest of the biological entity.

The invention may provide that at least one of said biological entities comprises a molecule and said apparatus calculates a binding surface of said molecule with regard to the selected point or feature.

The invention also provides an apparatus for visualising biological entities, especially linear macromolecules or ensembles of linear macromolecules, comprising

means for storing data representing at least one biological entity as consisting of basic biological units wherein said data related to said biological entity comprise data assigning one or more biological units to one or more structural units of said biological entity, said structural units and said biological units forming a hierarchy in that each of said structural units comprises at least one basic biological unit and/or another structural unit,

means for providing a multidimensional graphical representation of one or more biological entities on a graphical user interface,

means for selecting a level of hierarchy,

wherein said apparatus performs operations on the graphical user interface on the basis of a previously selected hierarchy level.

The invention may provide that the apparatus is adapted to perform a method as previously described.

The invention may provide that subsequent to a selection of a part of the representation of said biological entity said apparatus performs an operation on said selected part on the basis of a selected hierarchy.

The invention also provides an apparatus for visualising linear molecules or ensembles thereof, especially biological macromolecules or ensembles thereof, comprising:

means for receiving data representing a molecule or molecules as consisting of basic units,

means providing a multidimensional graphical representation of the molecule or molecules on a graphical user interface,

means providing a one-dimensional representation of said linear molecule or molecules on the same graphical user interface, said one-dimensional representation comprising subsequent graphical sites representing the site of subsequent basic units wherein each basic unit is represented by a symbol indicating the respective basic unit,

means providing at least one further one-dimensional representation comprising a sequence of graphical sites which are at least partly aligned with the one-dimensional representation of said linear molecule or molecules on the same graphical user interface,

means for interacting with one of said further one-dimensional representations to select one or more sites corresponding to sites of basic elements of said linear molecule or molecules,

wherein said apparatus selects the basic units in the multidimensional representation of said molecule or molecules corresponding to the selected sites in said further one-dimensional representation.

This apparatus may comprise means for performing a method as previously described.

The invention may provide that upon selection of one or more symbols in one of said one-dimensional representations said apparatus effects a different representation of the portion of the multidimensional representation of said molecule or molecules corresponding to the site of said selected symbol.

The invention also provides an apparatus for visualising biological entities, especially linear macromolecules or ensembles thereof, comprising

means providing a multidimensional graphical representation of one or more biological entities on a graphical user interface,

means for selecting one or more points or features of a portion of said graphical user interface containing said representation,

means performing a calculation having as input parameters parameters related to one or more selected points or features of the graphical user interface or one or more portions of said biological entity previously selected and having as result data related to a multidimensional graphical representation of a biological entity,

means for altering said multidimensional graphical representation according to the result of said calculation.

This apparatus may comprise means for performing a method as previously described.

The invention may provide that said apparatus selecting a part of said biological entity as a result of said calculation and displaying the selected part of said biological entity differently from the previous representation of said biological entity and/or from other parts of the representation of said biological entity.

The invention may provide that said apparatus determines a representation of a part of said biological entity by said calculation and displays and/or marks said part subsequent to said calculation.

The invention may provide that said apparatus determines a zoom factor such that the area spanned by selected points and/or features covers a given percentage of the area provided for said multidimensional representation in said graphical user interface and wherein said apparatus performs a corresponding zoom.

The invention may provide that said apparatus determines one or more structural units or basic biological units according to a previously determined relation to selected points and/or features and determines a zoom factor such that the area covered by said basic biological units and/or structural units covers a given percentage of the area provided for said multidimensional representation in said graphical user interface and wherein said apparatus performs a corresponding zoom to said basic biological units and/or structural units.

The invention may provide that said apparatus performs a zoom to the structural unit or structural units at a previously selected hierarchy level comprising selected graphical elements or graphical elements in the vicinity of one or more selected points in said graphical user interface.

The invention also provides a computer readable medium for embodying or storing therein data readable by a computer, said medium having embodied thereon one or more of the following:

a data structure generated by executing a process according to any of the method;

program code adapted to cause a computer to execute a method according to any of the method case, given the case, with a appropriate user input, as requested or enabled by said program code.

According to a further aspect, the invention provides a method of retrieving information regarding the structure of one-dimensional biological molecules by means of a data processing system, said molecules being determined by a sequence of elements, comprising the steps of:

retrieving the sequence of a first molecule,

retrieving information on the three-dimensional structure of one or linear molecules or complexes of linear molecules, said linear molecules matching said first molecule according to predetermined criteria,

providing a data structure comprising data records having as keys the sequence of a molecule, said records furthermore comprising data related to the structure of matching molecules, such that data related to a record can be accessed by said sequence.

The invention may provide that one of the molecules the structure of which is retrieved is the first molecule itself. This corresponds to the case that the structure of the molecule is known. In this case the record may comprise only the structure of the desired molecule as additional information to the sequence, although it may, of course, be provided to provide structural information on similar molecules, if desired or required by the case.

The three-dimensional structure may not only be the structure of one single molecule, but also the structure of a complex of molecules.

The step of matching molecules may especially comprise a match of the sequence of two molecules or parts of two molecules. Criteria for matching, aligning and establishing the degree of similarity of biological molecules are well known in the art.

The invention may provide that in each record the data about structures of molecules are sorted according to the degree of similarity of the sequence of the molecule related to said structure to the sequence forming the key of the record.

The invention may provide that in a record said data relating to the structure point to another data structure, especially a separate database.

The invention may provide that a record comprises data relating to the alignment, e.g. the range, location and/or degree of a match, of the sequence of a molecule related to a structure with the sequence forming the key of the record.

The invention may provide that alignment data are stored in a separate data structure, especially a database.

The invention may provide that said data structure is linked to at least one protein sequence database (e.g. SwissProt), at least one structure database (e.g. PDB) and/or at least one database of sequence annotations (e.g. InterPro).

### DETAILED DESCRIPTION OF PREFERRED EMBODIMENTS

Various embodiments of the invention are subsequently explained in more detail with reference to the attached drawings.

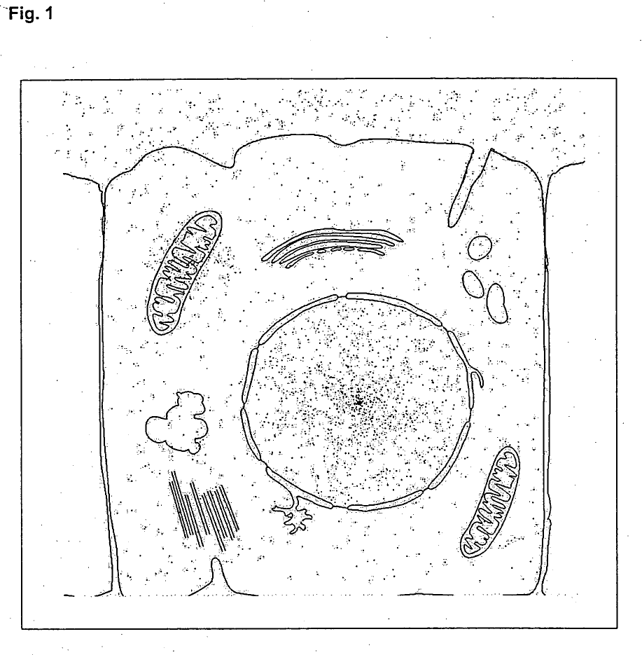

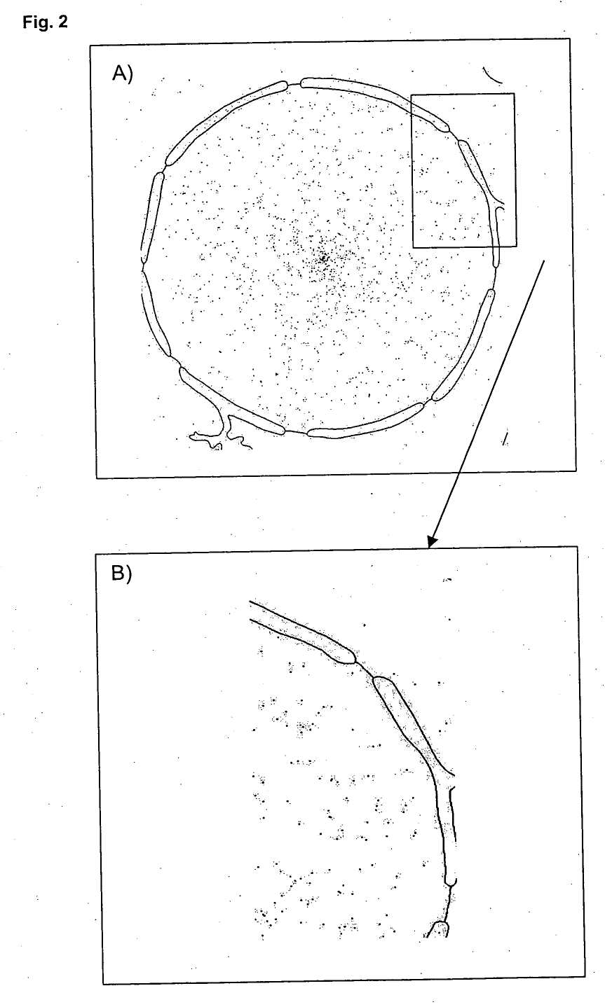

FIG. 1 shows a graphical representation of a biological environment according to preferred embodiment of the invention.

FIG. 2 illustrates a zoom function according to an embodiment of the invention.

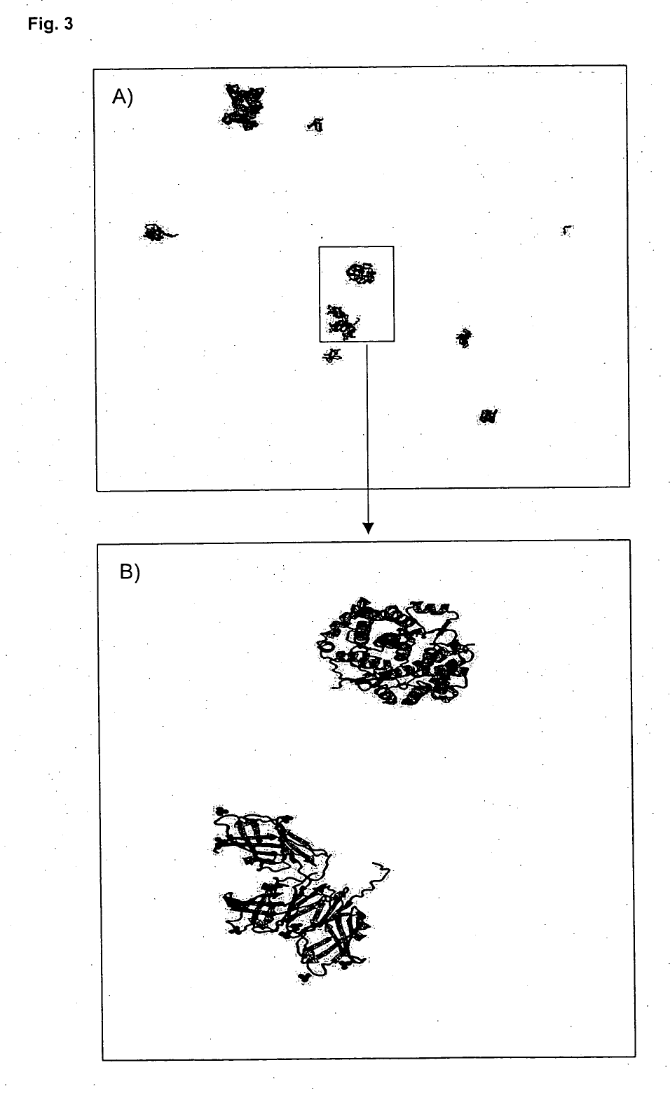

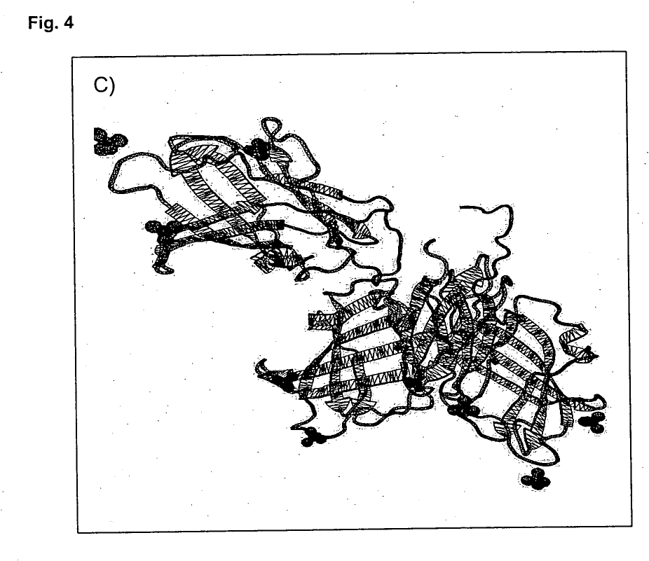

FIGS. 3 and 4 further illustrate a zoom process according to an embodiment of the invention.

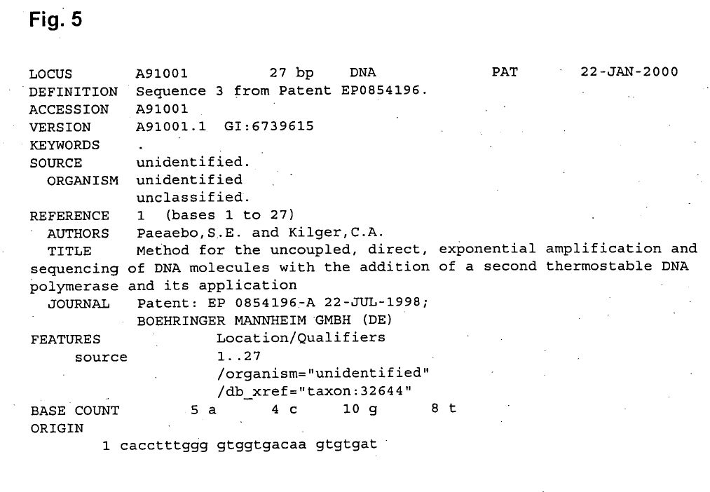

FIG. 5 shows a representative database entry.

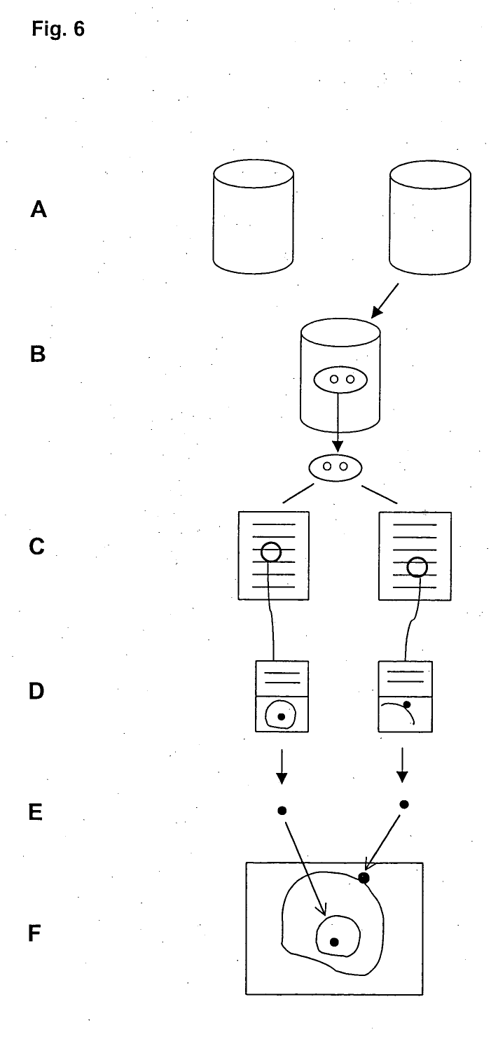

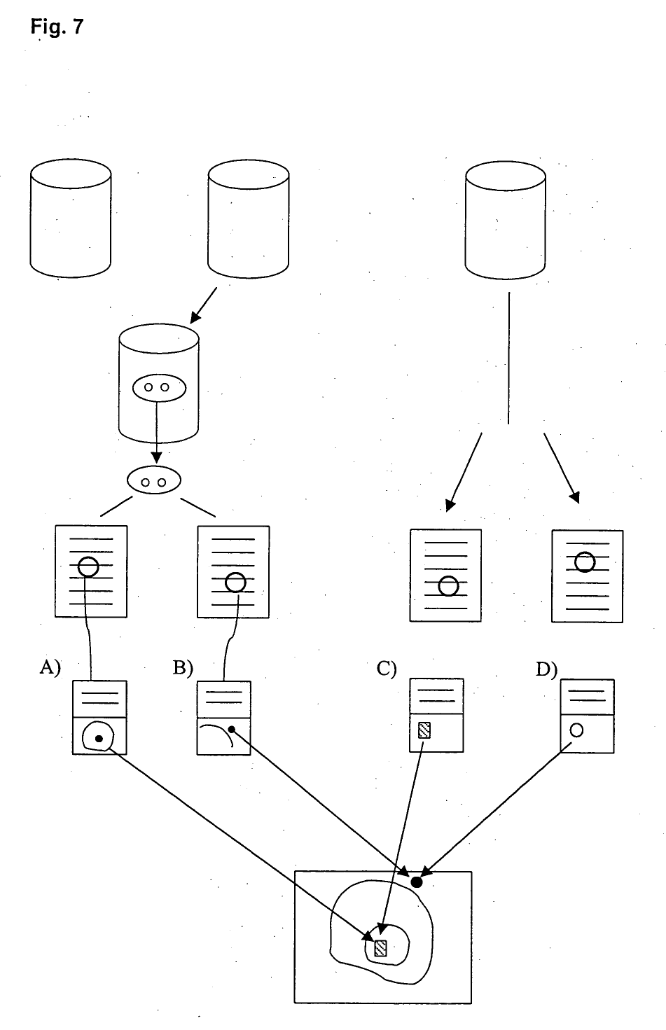

FIGS. 6 and 7 schematically illustrate a method for organizing and depicting biological elements according to the invention.

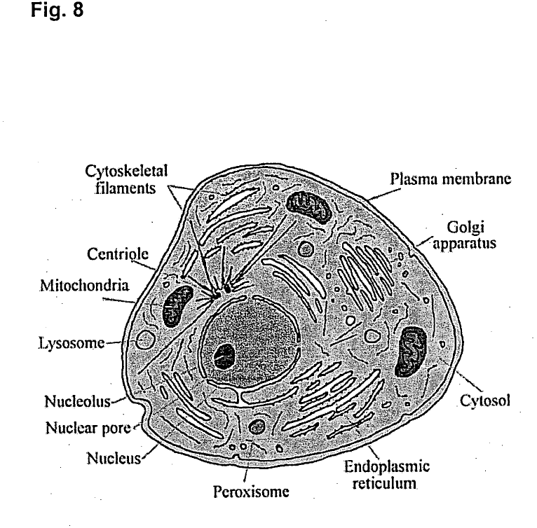

FIG. 8 schematically shows the picture of an eukariotic cell.

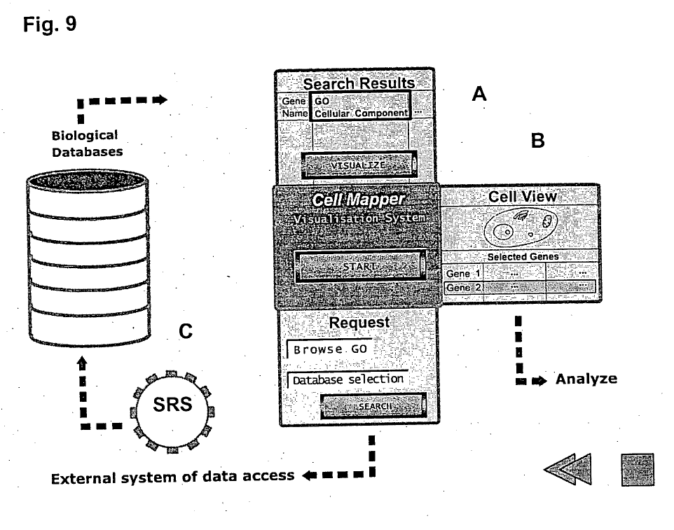

FIG. 9 schematically illustrates an overall system according to an embodiment of the invention.

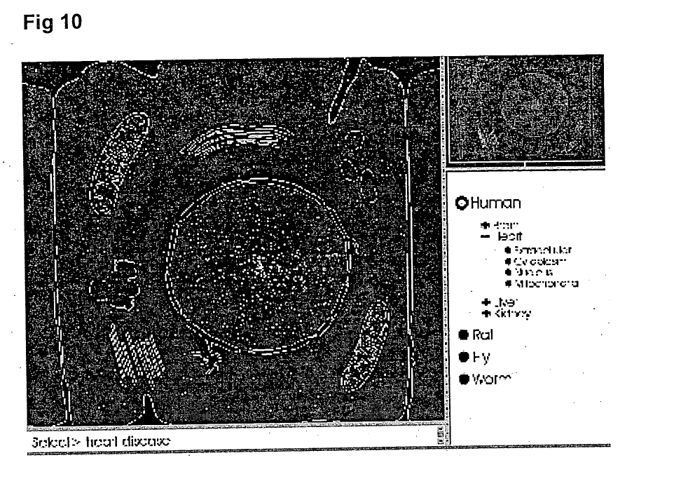

FIG. 10 shows an exemplary screenshot according to one embodiment of the invention.

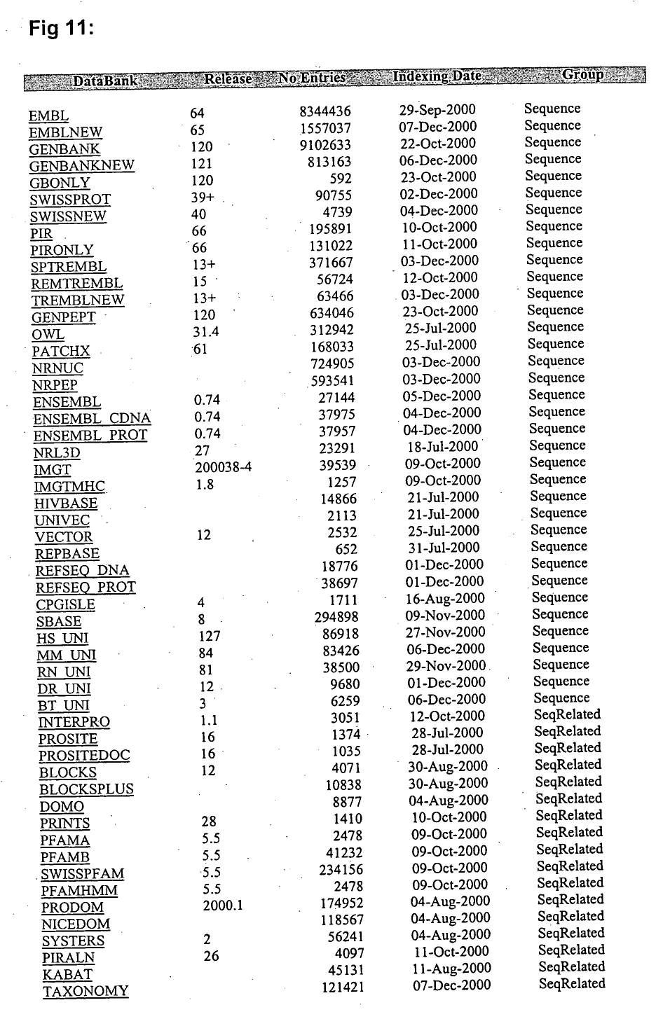

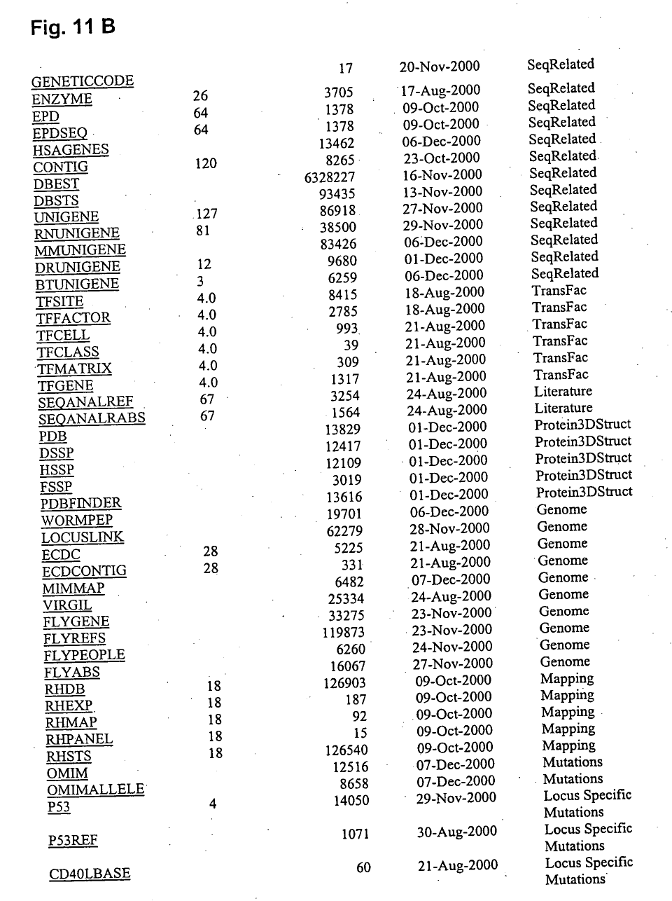

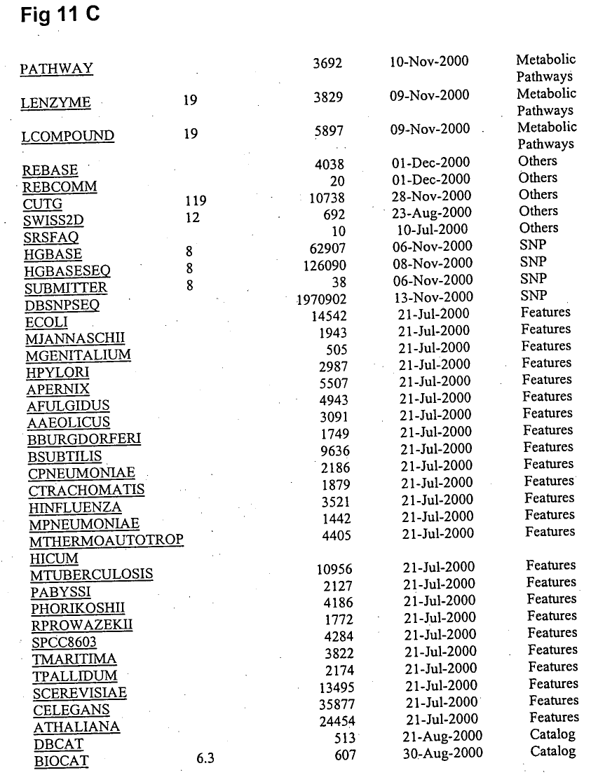

FIG. 11a to c show a selection of databases that could be used according to one embodiment of the invention.

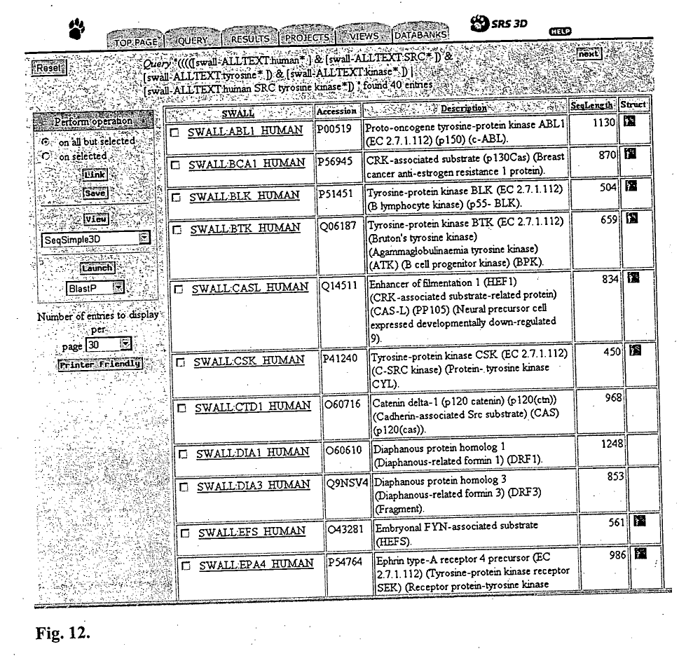

FIG. 12 to 15 are screenshots illustrating the way of mapping of sequences and annotations to structures according to the present invention.

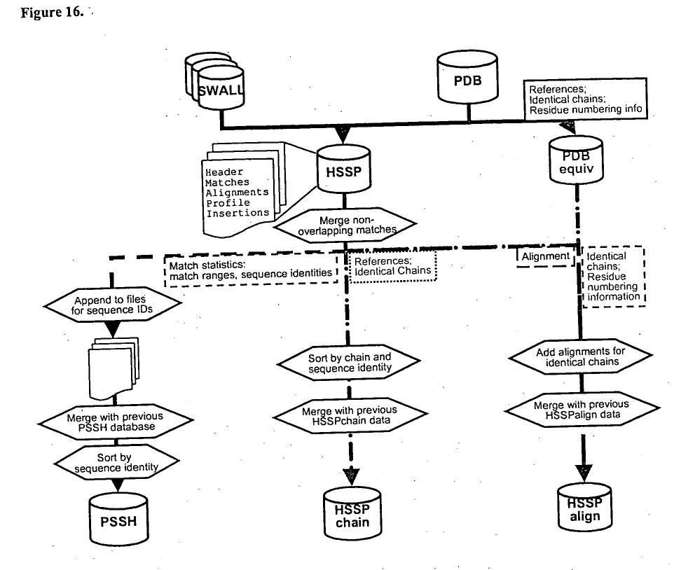

FIG. 16 is a schematic representation of the processes involved in the creation of the databases PSSH, HSSPalign, and HSSPchain.

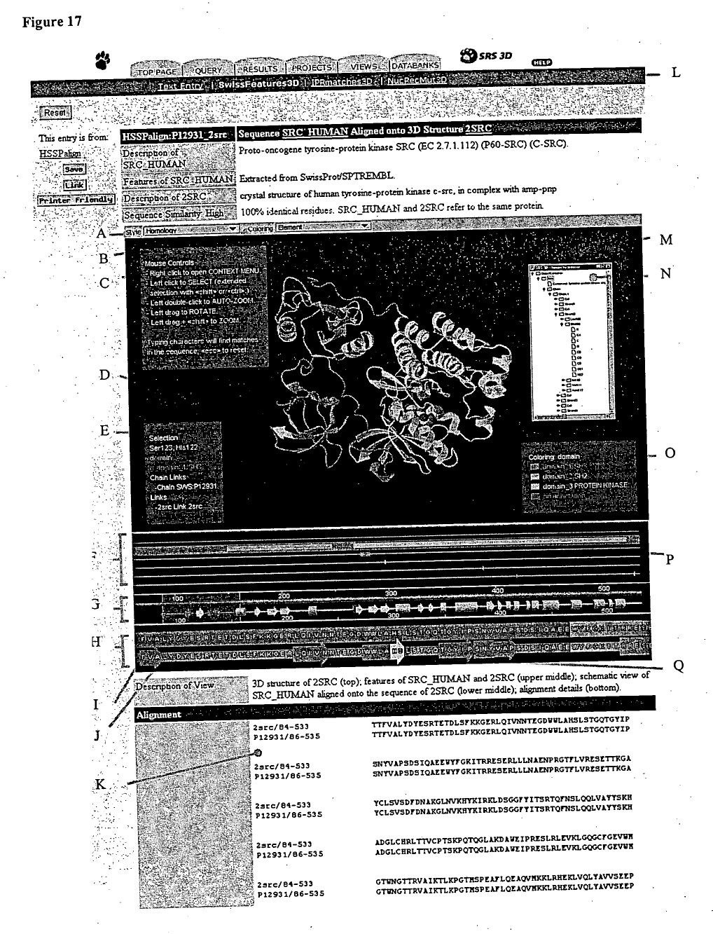

FIG. 17 to 20 are screenshots of an exemplary embodiment of a three-dimensional protein viewer according to the present invention.

FIG. 21 to 23 illustrate leaf level selection according to the present invention.

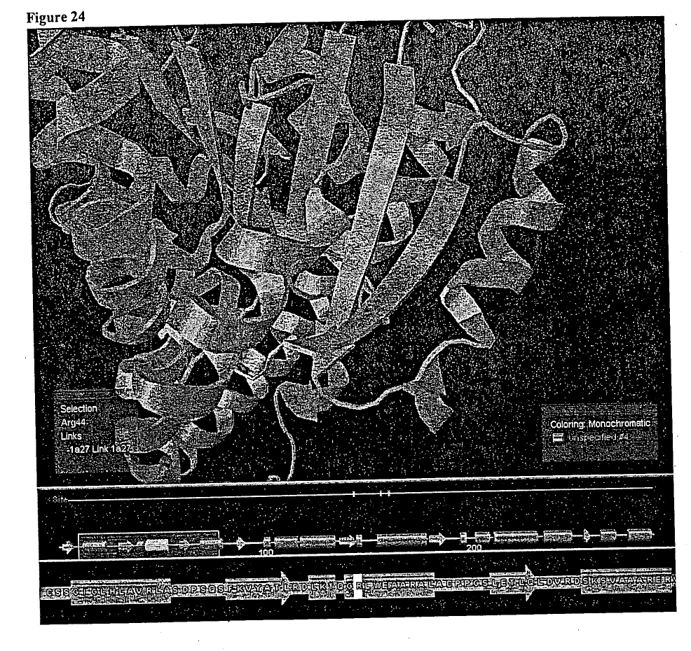

FIG. 24 to 26 illustrate range selection according to the invention.

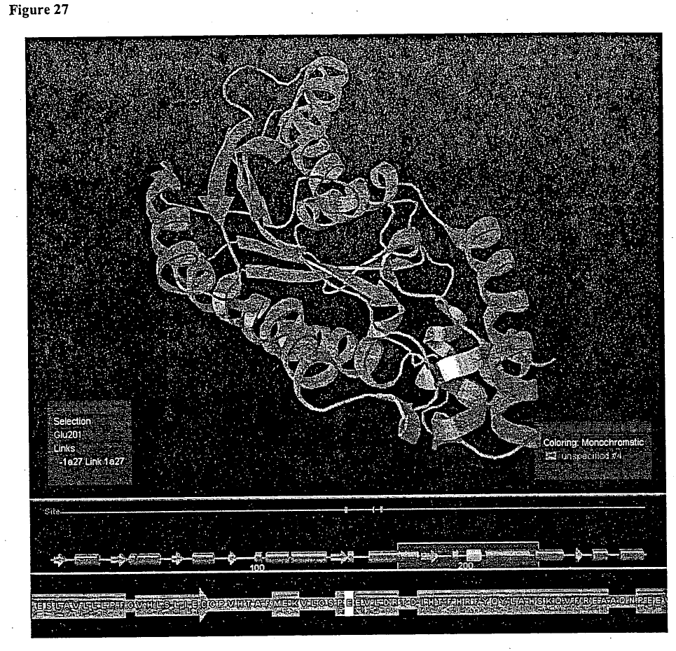

FIG. 27 to 29 illustrate hierarchical selection according to the invention.

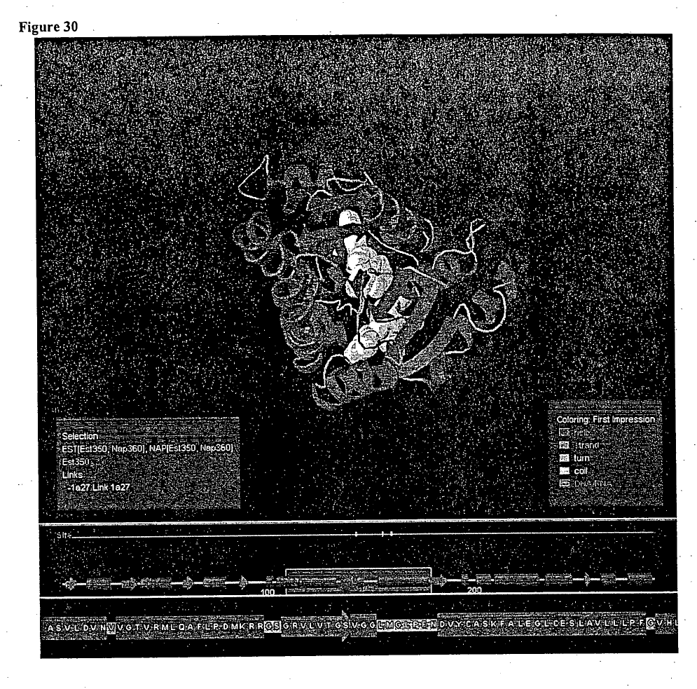

FIG. 30 to 34 illustrate the zoom function.

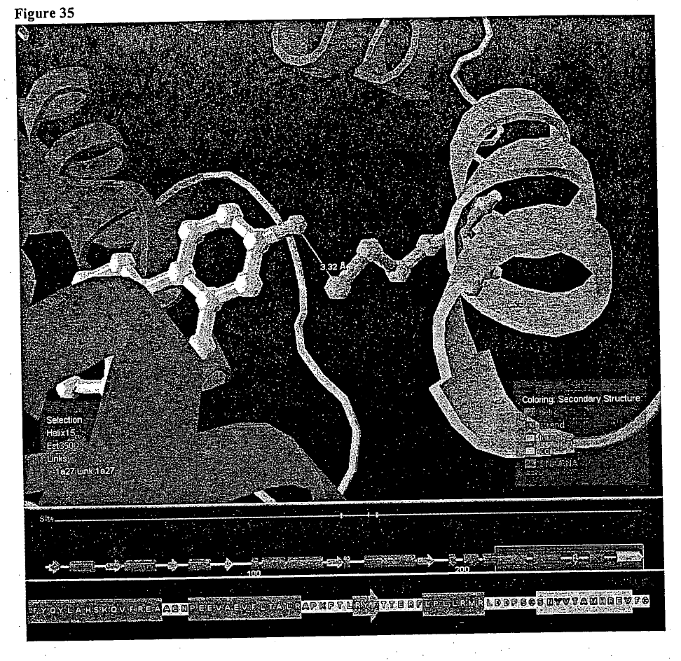

FIG. 35 illustrates the minimal distance function.

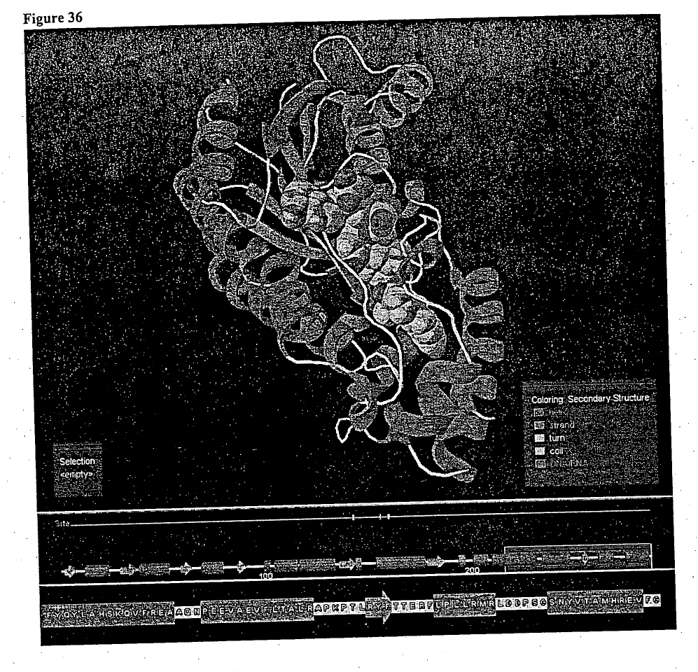

FIG. 36 to 38 illustrate various representation styles according to this invention.

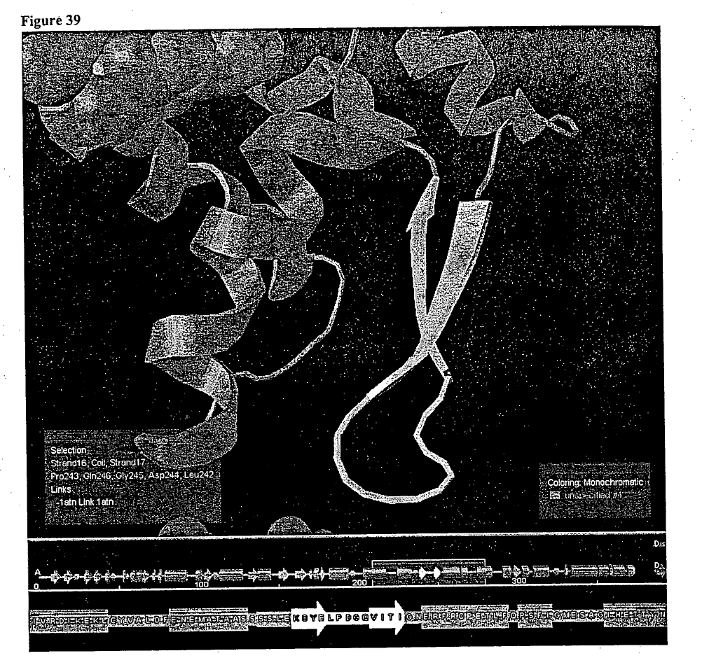

FIG. 39 to 41 illustrate multiple range selection according to this invention.

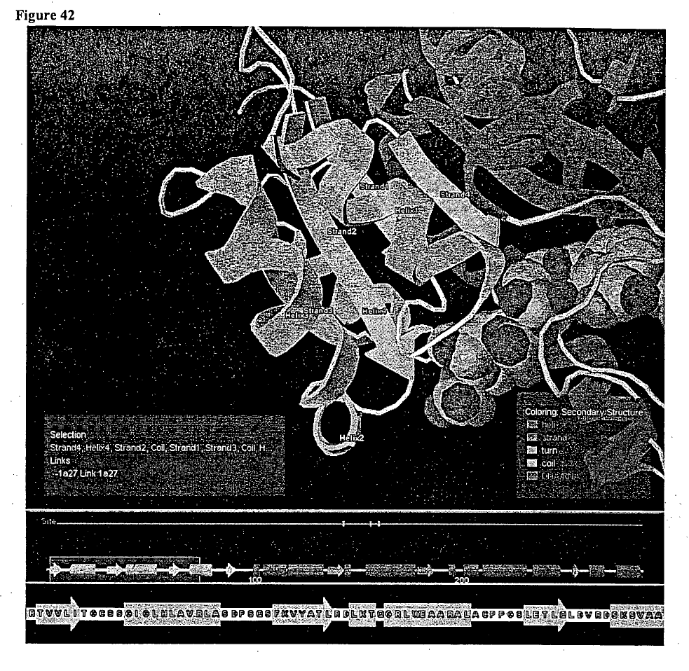

FIG. 42 illustrates labelling in a three-dimensional representation according to the invention.

In preferred embodiments the foregoing invention is also able to solve the following problems for the first time.

The sub-cellular location of a protein is one of the most fundamental functional properties. There are increasing more data that accurately define where in the cell proteins occur; however, no available method is able to visualize such data, either for a single protein, a selection of many proteins, or for one or more entire genomes. The invention enables the user to rapidly see the subcellular distribution of a selected group of proteins.

By combining together information from several different databases and presenting the result in a single view, the invention organizes and depicts these data into a simpler, more intuitive form.

A major initial hurdle in learning to understand complex data sets in particular biochemical data sets is to develop an overview of the processes involved. This is difficult primarily because of the large number of different data types or e.g. proteins and reactions involved. The invention is a highly interactive thus, an intuitive tool that encourages the user to explore, and also provides an immediately comprehensible context of where each data set fits into a broader picture.

The invention can be used to view periodic database queries relevant to a particular topic. However, this unique visual arrangement of results provides a different kind of ‘filtering’ that may sometime lead to significant new insight. For example, a researcher may use the invention to check for new experimental finding about his favorite data set of genes or proteins by periodically starting the invention and zooming straight to that data set or protein. When a significant new result has become available (e.g. a new SNP site in a neighboring protein), the user will immediately see the difference. By contrast, with database approaches, the user will generally only find data that she/he specifically requests through a query.

With the explosion in data in particular in the field of biology and chemistry e.g. protein sequences and structures, it becomes increasingly difficult to keep track of particular information pertaining to data sets as e.g. proteins of interest.

Currently, one needs to remember the name or accession number of a protein. In contrast, a user of the invention in a preferred embodiment can e.g. find proteins he is interested in, based on their location in the 2D view.

The details of the cell view (membranes, large complexes of proteins and lipids) provide a memory ‘anchor’ or a context—once one has seen the cellular context in which a protein occurs, it is very easy to remember where the protein lies in the view. Thus, at a later stage, one can simply and quickly return to the part of the cell to find the protein again. This is a completely novel way of finding information about and/or within data in particular proteins, and has great advantages over the traditional database approach known in the prior art.

Most people are much better at remembering spatial locations than at remembering the strings of numbers and characters that are used for database accession numbers. An example of a database entry is shown in FIG. 5.

The mnemonic feature of the invention results from the context created for each protein i.e., the location in the cell, the proximity to other cellular structures and other proteins, and also the shape of the proteins structures and the appearance of the annotations mapped on the structures. All of these provide the mnemonic ‘anchors’ that will help the user recall not just the location of a given protein, but also the location of abstract annotations.

For example, a protein with unusually highly conserved sequence may be colored completely one color, such as blue. The user may then remember having seen fully blue protein at a particular location, for example close to a large complex of proteins and close to the mitochondrial outer membrane; thus, he would be able to find the protein again without having to remember its name.

Visualization of 3D structures of membrane proteins are a special case as they are among the most important medically, but unfortunately very few 3D structures of membrane proteins are known. There is currently no method for automatically modeling the membrane topology, placing this within a membrane, and mapping onto the model important functional properties. Such a view by itself can give a useful insight into the protein function. The invention may provide for a view of the protein itself, be it instead of the previous representation of a biological environment, be it in a separate window.

In a preferred embodiment in which the invention is applied to a biological question the invention defines a single view that combines information from several different databases, especially data on where proteins occur in the cell, data on which proteins form complexes, and data on the 3D structure of proteins. The view may consist of a 2D (or 3D) model of the cell; the proteins of interest are then placed into the subcellular compartments where they are known to occur.

Within each compartment, proteins that are known to bind together are placed together. The user may initially see an image of the whole cell with small proteins represented as single pixels on the computer monitor; very large macromolecular complexes such as chromosomes and ribosomes are represented as simplified 3D representations that hide the atomic detail, or as 2D images.

The user can then select a region and zoom into it. The user can zoom continuously from the cellular scale (micrometers) down to the molecular scale (nanometers); as the user zooms in on a protein it changes continuously from a single point at the micrometer scale (for small proteins) to a detailed 3D structure at the molecular scale. Where several proteins are known to interact, and where the interaction interfaces are known or can be predicted, these protein structures are positioned and aligned to show the exact interaction. In addition to representing the physical structure of each protein, the structure is annotated by coloring and by choice of representation to display other important aspects of protein function, such as protein family assignment, short sequence signature patterns, SNPs (single nucleotide polymorphisms) sites, sequence conservation, bound ligands, and active sites. Zooming further, the protein may be represented by its 3D structure, together with the corresponding annotations.

In a preferred embodiment of the invention the method enables the user to look in detail at regions of interest (either individual protein structure or a large aggregate or cluster of proteins), while maintaining an overview of where each region fits into the context of the whole cell.

The view is not necessarily trying to depict the actual physical arrangement of every single molecule in the cell; similarly, a geographical atlas does not try to model every tree or rock.

Rather, the aim is visualize representative subsets of proteins that cover all interaction possibilities.

The invention provides a novel way to overview an entire genome of data, gaining at a quick glance an idea of how proteins are distributed in the cell.

The invention also provides a novel way of viewing selected subsets of an genome. For example, the invention could be used to view all human proteins for which the associated database entries have been added or update in the last month. Or the invention could be used to show only those proteins associated with a particular disease.

The invention provides a novel view of a large number of atomic resolution 3D structures of proteins.

The invention enables the visualization of another kind of information, namely the detail of the interacting surfaces, in addition to the cellular context of the interaction.

The invention can also be used as a simple molecular graphics tool for single proteins: when used in this way, it has several advantages compared with standard molecular graphics tools. Firstly, the subcellular location is made clear by the overview frame (top right, FIG. 10), and by the ability to zoom quickly out to the cell view. The second major advantage is the immediate realization of which proteins are in vicinity or interacting with the particular protein of interest. Finally, given that neighboring proteins are present, the invention view can also display insightful representation of the inter-protein interactions through visualizing interaction surfaces or electrostatic potentials.

The invention can be extended to display tissues, organs, organisms or different cell types, such as neurons, plant cells, bacteria cells, and viruses.

The data placing in particular protein placing method can be extended or replaced by similar methods; other types of protein-protein interaction data may be used, such as metabolic or signaling pathway data.

The main view can be 3D; this can be visualized either using a standard PC monitor plus stereo glasses, or with ‘immersion’-graphics systems.

The invention can be extended to include dynamics, this will facilitate the visualization of reaction data as well, for example letting the proteins move or ‘diffuse’ to different locations. Then, the invention would incorporate yet another type of databases (reactions or metabolic pathways) into its single view.

Data obtained from expression profiles analysis (DNA-chips or protein chip experiments) can also be included using static or dynamic methods.

Process such as protein expression and translocation, or signal transduction, can also be visualized in the invention.

A clear extension is to connect the viewer to a viewer of tissue and organism, i.e. to see the cells in their relationship to each other, each tissue type, and then the distribution of tissues. within the body. Visualization of tissues within the body is a prior art, however, once again the inventive aspect here is to combine this view with a subcellular location view, and also a molecular graphics view. This also extends the field of application to medicine and health.

The view can be also extended to see even greater subatomic detail of parts of the protein or other molecules.

The method can be extended to view other macromolecules such as lipid aggregates and RNA; small molecules, such as ATP, can also be incorporated.

The invention can be extended to display different stages of the cell cycle, and also the show a simulation of the cell cycle.

Embodiments of the present invention may be implemented using a computer system as schematically illustrated in FIG. 4. A computer system 600 may comprise a computer 605 connected to a display 610, a mouse 620, and comprising some storage medium 630 such as a floppy disk drive, a CD-ROM drive or the like, and some hardware components 640 comprising at least one CPU and a memory such as to enable the computer to carry out by means of the CPU program instructions stored in said memory. The program itself may be stored on any computer readable medium, or it may by carried out on a remote computer (host) to be accessed by a client computer through a communications link such as the internet. Hybrid implementations are also possible, such as a Java implementation being downloaded in part or as a whole through a network and carried out on a client.

### EXAMPLES

### Example 1

An initial selection of proteins is made by the user with a search engine such as SRS (Sequence Retrieval System). The example used here for illustrative purposes is all publicly available human sequences.

The proteins are then placed in their respective sub-cellular locations. For many proteins, the sub-cellular location are found in the corresponding entry in the SWISS-PROT database (www.expasy.ch/sprot) by querying the database through SRS. For those proteins with no annotated location, the location can be predicted either by homology to proteins with known location, or other predictive methods, such as those based on the presence of transmembrane helices (e.g., PHD, Rost 1996), of signal peptides (e.g. SignalP, Nielsen, Engelbrecht et al. 1997), or of characteristic amino acid composition (e.g., PreLoc, Andrade, O'Donoghue et al. 1998).

Membrane proteins are placed along the respective membranes, initially randomly. The position of the membrane proteins is then optimized such that proteins within the same membrane that are known to bind to each other are moved together: a repulsive term is also added to ensure than proteins known not to interact do not occur together in the final optimized positions. During the optimization, the proteins are constrained to lie always on the membrane.

Next, proteins are placed initially randomly into the spaces (nucleoplasm, cytoplasm, mitochondrial matrix, extracellular space, etc.), with a check to ensure that they are in the correct space. The positions of the non-membrane bound proteins are then optimized such that the proteins that are known to interact are moved together, those that do not are forced apart, and during the optimization, a constraint is added to ensure the proteins remain in the correct compartment.

Information about which proteins form complexes is extracted either from SWISS-PROT or other databases, such as BIND, that specifically annotate protein-protein complex formation. Further information about protein-protein binding can be predicted either by homology to proteins known to form complexes, or other predictive methods, such as protein-protein docking.

Information about protein 3D structure is then extracted from for example the PDB database; for proteins with no experimentally determined 3D structure, the 3D structure can often be inferred via homology modeling or threading methods.

One may also predict aspects of protein structure, such as solvent accessibility and secondary structure, using methods such as PHD.

Transmembrane helices can be reliably predicted; hence a two-dimensional representation can be built and placed in the respective membrane.

Proteins for which no 3D structural data is available are represented as 2D objects, or very flat 3D objects, to distinguish them from 3D structures.

The speed at which placing proteins into the view can be made very fast by precalculating placements; predictions of subcellular location, binding partners, and 3D structures can also be precalculated and stored on a centralized computer.

Access to these data are managed by server running on this machine.

### Example 2

Displaying the View

The invention view is generated by e.g. a client program running on the users' machine. In a preferred embodiment one window with four separate frames is created the main frame (FIG. 10) shows the current region of interest—initially, this would usually be the whole cell. In this frame, the user can select a region with the mouse to zoom into, or can zoom out back to the whole cell view. The user can also select individual proteins, or groups of proteins, by selecting a region.

A second frame (top right, FIG. 10) always shows the whole cell view, and has lines (in green) indicating the region that is currently seen in the main frame.

A third frame (bottom right, FIG. 10) displays textual information about the currently selected group of proteins, such as the number of molecules selected, their names, amino acid sequence, etc.

A fourth frame (bottom left, FIG. 10) gives a command line interpreter where the user can enter queries to narrow the selection to a group of proteins matching the query.

### Example 3

The Basic Environment Element is a Cell or a Sub-Compartment Thereof:

In this preferred embodiment of the basic environment element the method and/or the system according to the invention makes use of a cell image bank which is broken up into elementary images corresponding to components of the main cell image.

These elements also form part of the image bank and can be used to carry out various images of cells. For example the nucleus is a basic element which will be useful for several type of cells.

For example, a cell is represented with the membrane, the nucleus, the cytoplasm and the principal cellular organelles (mitochondrion, golgi apparatus, chloroplast for the plant cells). The cell image may contain the standard sub-cellular compartments. For example, a generalized eukaryotic cell will contain a cytoplasm, mitochondrion, golgi apparatus, peroxysome, and endoplasimic reticulum. For specialized cells, such as nerve cells, can also be represented, in which case appropriate specialized structures, such as the axon can be represented.

### Example 4

Zooming into the View of the Basic Environment Element:

In one embodiment of the invention as outlined above, the forgoing invention makes use of either an organism, one or more tissue types, a cell, an organelle, a sub-cellular compartment, a molecule, an atom and/or a sub atomic particle as a basic environment element. An organism may be up to meters in size (“m”), a particular tissue type is routinely in the millimeter size range (“mm”), an average cell is usually about a micrometer in size (“μm”), an organelle routinely a fraction thereof in size, a molecule is within the general dimension of nanometers. Atoms are in the range of 100 s of picometers. Subatomic particles are much smaller.

In this preferred embodiment of the invention the basic environment element is a either an organism or a tissue, or a cell. Thus, the first view of the basic environment element displayed in accordance with the method according to the invention is, when zoomed out an area representing meters to millimeters. In this embodiment of the invention, the area displayed by the. basic environment element may be changed in a continues fashion in order to enable the “zooming in” starting from an area in the range of millimeters down to an area of picometers or even smaller.

Thus, a user of the method according to the invention would be able to select biological elements that are to be displayed on the basic environment element and follow their location, distribution and/or interaction within a tissue or cell down to the location, distribution, and/or interaction and more importantly physical characteristics within a picometer range. While changing the “view” the databases according to the invention are queried in order to determine desired feature elements which are needed to provide for the different displays within the basic environment element.

Thus, while no feature element is necessary for depicting the physical property of a protein at the mm level, the method must determined one or more at the picometer level, if the user desires to investigate the physical properties of the proteins at this level.

In this embodiment of the invention it is now possible to zoom in and out of an organism, down to the picometer range, while at the same time the necessary feature elements are determined both for the environment element as well as for the biological elements in order to make it possible to create “a continuous travel” through the dimensions, starting from meters travelling down to picometers. The invention makes it possible at the same time to, both chose and update the kind of biological elements that are displayed. In particular the data sets can be chosen from internal (part of the apparatus) and external (e.g. found within the internet) data bases which thus potentially provide for instant and up-to-date data sets.

Thus, in this embodiment of the invention a user may chose to analyze the relationship between a new set of proteins discovered and published at a given day and another particular set of proteins the user knows from the past by choosing the respective databases and/or data sets.

At the whole cell view, almost all proteins (the biological elements in this embodiment) are too small to be seen, and hence are represented as single pixels.

As the user zooms into a region at intermediate scale, such as the region in the nucleus, most proteins would still be too small to see and hence the representation for these proteins remains as single pixels.

Once the user has zoomed in far enough such that the size of the protein becomes larger than a single point, the representation of the protein may be changed to provide more detail about the protein or biological element. This more detailed representation may be the full atomic-detail 3D structure, or a reduced 3D representation that hides atomic detail, or a 2D image of the protein structure (see FIGS. 2 & 3). Reduced representations would be important for allowing large macromolecular complexes, such as entire chromosomes or ribosomes, to be represented in a simple way. Thus, the local computer that manages the display will only need to deal with the reduced level of detail. In the preferred embodiment, when the user of the invention would like to examine one area of the complex or biological element in detail, the user zooms into that region and only at that particular time are the full details of that region transferred to the local computer from a server computer.

In the preferred embodiment of the invention, several different reduced representations are used between the single-point per protein and the full atomic detail 3D structure. For 3D reduced representations, progressively more detail is added to the 3D structure. For 2D reduced representations (images) several 2D images may be used with several different levels of resolution. Initially, the lowest resolution representation is displayed to save computer memory. As the user zooms closer to the protein, the representation changes to higher resolution.

When images are used, at a certain point, the 2D image is replaced by a 3D representation of the protein, either the final atomic detail representation, or a reduced 3D representation (see figures); this transition from a simple image to a 3D structure can be arranged so that it is not noticed by the user.

The final 3D representation of the biological element can be rotated in three dimesnions, to provide the user with an insight into the protein three dimensional structure and function; The structure may additionally be annotated with important functional aspects.

The different levels of resolution are included so that the viewer program only needs to download the detailed representation for the proteins that the user is interested in, thus reducing the RAM requirements of the viewer used in the invention.

By carefully choosing the transitions from low resolution to high resolution images, or from 2D image to 3D representation, the user does not notice the transitions, and the zooming appears to be seamless and continuous.

In one session, the user may visit only a relatively small number of protein structure at atomic detail (such as shown in the figures); these structures are cached in RAM and on a local hard disk so they can be quickly revisited.

Unlike other database visualization tools that place proteins into abstract 2D spaces, the view created by the invention is physically and biologically meaningful. Thus each protein is placed into a meaningful context, defined by its subcellular location, and also by the neighboring proteins, DNA, or membranes. This context aids the user in gaining insight into the protein function.

### Example 5

Selection of Data Subsets

The method also allows for the possibility to select subsets of the initially displayed data. In the preferred embodiment of the invention, a hierarchical viewer is provided that allows the user to select groups of biological elements by their sub-cellular location (see bottom right panel, FIG. 10). Thus clicking on the term ‘nucleus’ would immediately select all biological elements located in the nucleus. The selected proteins can be indicated by changing their coloring or some other visual means. Selecting a sub-cellular location can also be facilitated by, for example, double clicking anywhere within a given location.

In the preferred embodiment of the method, an alternative mechanism for enabling the user to define selections is defined. This alternative is a command line (see bottom left panel, FIG. 10) where the user can type a query term, for example ‘cancer’. This would them select the subset of biological elements currently displayed that are associated with the keyword ‘cancer’. The result of query can be found by sending the query term to a meta-database engine, such as SRS,.

### Example 6

Communication with other Applications

In one embodiment of the method, the subsets that are defined by the above methods can be communicated to other computer applications. Also, the method and apparatus according to the invention can receive a list that specifies a subset of proteins (biological elements) to display from another application. As one example, the invention may communicate with an application such as arraySCOUT that analyses data coming from the expression level of many different proteins. With this communication, the user can first select in the in the apparatus according to the einvention only nuclear proteins. This selection can then be sent to the arraySCOUT program, so that only nuclear proteins are selected for the analysis in arraySCOUT. The analysis may then suggest that a given subset of those proteins are of significant interest. The user can then send this subset back to the apparatus according to the invention to see which of these proteins are, for example, complexed with a given chromosome, or which of these proteins occur freely in the nucleus or are complexed with one another.

### Example 7

The method according to the invention can be extended to display different cell types, such as neurons, plant cells, bacteria cells, and viruses or, e.g. different stages of the cell cycle. Additionally, the distribution of biological elements throughout the cell cycle may be shown.

Hereby a “depository” or database is created containing information which may be extracted for creating different types of basic environment elements. One may for example envision also the display of two or more “comparative” basic environment elements (“BEE”), wherein one BEE shows the distribution of biological elements in a (i) normal cell and the other shows the distribution and/or presence within a (ii) diseased cell. One may also envision the subtraction of (i) from (ii) or vice versa and thus merely the display of the remainder. All of the above has enormous advantage of putting the scientist in the position to “grasp” a large amount of information within a single view.

The selection methods can then also be extended to allow the user to choose between the different cell types. In the preferred embodiment, the hierarchy viewer (bottom right panel, FIG. 10) shows different organisms; under each organism can be listed each organ; under each organ can be listed each cell type; under each cell type is listed the different sub-cellular locations. The user can select an organism, organ, and cell type, causing the display to switch to the appropriate cell view, and the select of biological elements to switch to those belonging to that cell type.

The inter-application communication can also take advantage of this feature of the invention. For example, the selection of subsets of biological elements from the meta-database engine (e.g. SRS) can be made to depend automatically on the cell type, organ, and organism chosen. Similarly, the selection of organ, organism, and cell type can be communicated to and from applications such as arraySCOUT.

### Further Examples

The process of locating at least one of said graphical representations of said biological elements on said display of said basic environment element, can be extended by making use of other types of data sets or databases, such as metabolic or signaling pathway data or protein-protein interaction.

The basic environment element may also be a 3D display., Tthis can be visualized either using a standard PC monitor plus stereo glasses, or with ‘immersion’-graphics systems.

The invention can be extended to include dynamics: this will facilitate the visualization of reaction data as well, for example letting the proteins move or ‘diffuse’ to different locations.

Then, the invention could incorporate yet another type of databases (reactions or metabolic pathways) as source for feature elements.

Data obtained from expression profiles analysis (DNA-chips or protein chip experiments) can also be included using static or dynamic methods.

Processes such as protein expression and/or translocation, or signal transduction, can also be visualized in the invention.

A clear extension is to connect the display of the basic environment element to a viewer of a tissue and/or organism, i.e. to see the cells in their relationship to each other, each tissue type, and then the distribution of tissues within the body.

The method according to the invention can be extended to view other macromolecules such as lipid aggregates and RNA; small molecules, such as ATP, can also be incorporated.

FIG. 1 to 11, relating to the aspects of the invention previously described in this section, will now be explained in more detail.

FIG. 1:

FIG. 1 shows a preferred embodiment of the invention in which a method for organizing and depicting one or more biological elements is performed in such a way that the basic environment element is a generalized eukaryotic cell. The area displayed is about 20×20 μm. One can see that several thousand biological elements have been placed within the “cell” based on information from the various data-sets. One can see that some are also located outside the cell. The representation is a simplification of the preferred embodiment whereby the cell image is generated based on micrograph pictures

FIG. 2:

FIG. 2A shows a preferred embodiment of the invention whereby the user has chosen the area that is depicted in said display of said basic environment element by choosing an area in a second display of said basic environment element. The user has zoomed into a location within the cell by choosing an area in a first display (2A) which is then enhanced in a second display of said basic environment element (2B). The user can see e.g. which proteins are located on or in the nuclear membrane. The area shown in 2A is about 10×10 μm in size. The area shown in 2B is 2×2 μm in size. In a preferred embodiment the user may zoom from the area shown in 2A to the area in 2B. In another embodiment two separate displays are chosen.

FIG. 3 to 4:

The figures show how the user may change displays. What should be noted is that the various areas displayed may require different kinds of feature elements to be extracted from the various data-sets. In these embodiments for example (3B) protein structures are shown. Thus, when zooming from the area shown in FIG. 1 to the area shown in FIG. 4 a) the number of biological elements that are displayed is reduced drastically however different additional and/or different feature elements are determined in order to, e.g. show the protein structure of a biological element.

FIG. 5:

FIG. 5 shows a typical database entry stemming from the National Institute of Health (USA), pertaining to a nucleic acid molecule.

FIG. 6:

FIG. 6 shows a method for organizing and depicting one or more biological elements comprising the steps of, receiving an input to select one or more databases (A), receiving further input to select one or more desired data sets from the one or more databases based on one or more selection criteria (B), determining at least one first feature element from each of said one or more data sets (C-D), determining a graphical representation for displaying at least one of the biological elements corresponding to said one or more data sets and (E), enhancing a display of a basic environment element by locating at least one of said graphical representations of said biological elements on said display of said basic environment element, depending on the information contained in said first feature element (F). Here, a database was identified which contains data pertaining to two proteins. The data sets were extracted and the entries analyzed, in order to identify information pertaining to their localization in a cell. For each of the proteins a graphical representation was created. The graphical representations of the proteins were placed into the virtual cell based on the information stemming from the data sets. One can see that one protein is located in the nucleus, whereas the other protein is located in the outer cell membrane.

FIG. 7:

FIG. 7 shows a method for organizing and depicting one or more biological elements comprising the steps of, receiving an input to select one or more databases, receiving further input to select one or more desired data sets from the one or more databases based on one or more selection criteria (A,B), determining at least one first feature element from each of said one or more data sets, determining a graphical representation for displaying at least one of the biological elements corresponding to said one or more data sets and, enhancing a display of a basic environment element by locating at least one of said graphical representations of said biological elements on said display of said basic environment element, depending on the information contained in said first feature element. In this embodiment of the invention a further database is chosen, further feature elements are extracted from data sets therefrom and the feature elements are used to further enhance the display of said at least one graphical representation of said biological element by using the information from said further feature element.

Here, a database was identified which contains data pertaining to two proteins (A, B). The data sets were extracted and the entries analyzed, in order to identify information pertaining to their localization in a cell. For each of the proteins a graphical representation was created based on data from another database (C, D).

The graphical representations of the proteins were placed into the virtual cell based on the information stemming from the data sets (A, B). One can see that one protein is located in the nucleus, whereas the other protein is located in the outer cell membrane. Their respective visualization is based on data stemming from data sets C and D.

FIG. 8:

FIG. 8 shows a schematic picture of a eukaryotic cell as it be used to form the basic environment display.

FIG. 9:

FIG. 9 shows a screenshot from a schematic picture of how one of the embodiments of the method according to the invention is organized. Wherein (B) would be the display, displaying the genes (biological elements) chosen, (A) would be a window allowing the definition of the selection criteria, (C) would be one possible tool that would enable the querying of the databases. In this case SRS (Sequence Retrieval System, see also WO0041094) is used for accessing the databases.

FIG. 10:

FIG. 10 shows one embodiment of the invention wherein a user may select the biological elements to be displayed by choosing these from a list seen in a second “window”.

FIG. 11:

The FIGS. 11 to 11C show a selection of databases which may be accessed when extracting data sets both for the biological elements as well as for the display of the basic environment element. The figures also show, e.g. what kind of data is contained, how many releases exist, as well as how many entries are contained.

Specific, non-limiting examples of embodiments of further aspects of the invention will be explained in more detail subsequently.

Data Structures for Mapping Sequences to Structures

According to the invention, a new system is also provided for mapping sequences and sequence annotations onto 3D structures.

The preferred embodiment has three database that relate sequence and structure, namely PSSH, HSSPalign and HSSPchain.

In the database PSSH matches are sorted by the matched protein sequence instead of the PDB structures. Thus, this database facilitates navigation from a protein sequence (e.g. from Swissprot) to the structure of a related sequence.

HSSPalign is a database containing the alignments between single chains of PDB structures and their respective similar protein sequences. This database establishes the equivalencies between residues in PDB structures and residues in related protein sequences. Thus, sequence features stored in sequence databases can be mapped onto related structures with the help of this database.

HSSPchain is a database containing the matches sorted by the chain of the structure they belong to. Identical chains in the same structure are indicated. Thus, this database facilitates linking between the chains of PDB structures and the sequence information of the respective proteins (e.g. in Swissprot).

In the preferred embodiment, these database are integrated into an SRS environment that contains at least one protein sequence database (e.g. SwissProt), at least on structure database (PDB), and one or more databases of sequence annotations (e.g. InterPro).

The user can then navigate from a sequence to all related structures (by linking to the PSSH entry); from here, the user can select a structure (or several structures), and view the alignment of his sequence of interest and the related structure (i.e. a view of a HSSPalign entry). This view can also pick up the structure from the PDB, and features from InterPro or other databases. The features can then be mapped onto the structure using the sequence-to-structure alignment.

This workflow (from sequence to structure to annotations) is indicated by the screenshots of FIGS. 12 to 15.

The screenshot of FIG. 12 shows the result of a query of a sequence database (SwissProt). Each sequence entry that has related 3D structures is indicated by an icon in the column marked ‘Struct’ (far right).

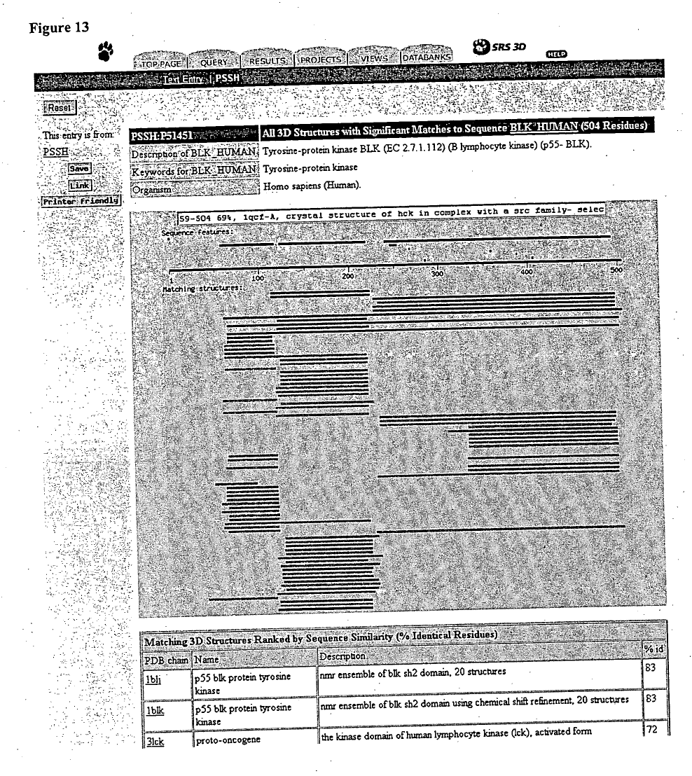

The screenshot of FIG. 13 shows a PSSH entry related to a given protein sequence. The view shows all 3D structures related to the given sequence; the structures are ranked in order of their similarity to the query sequence.

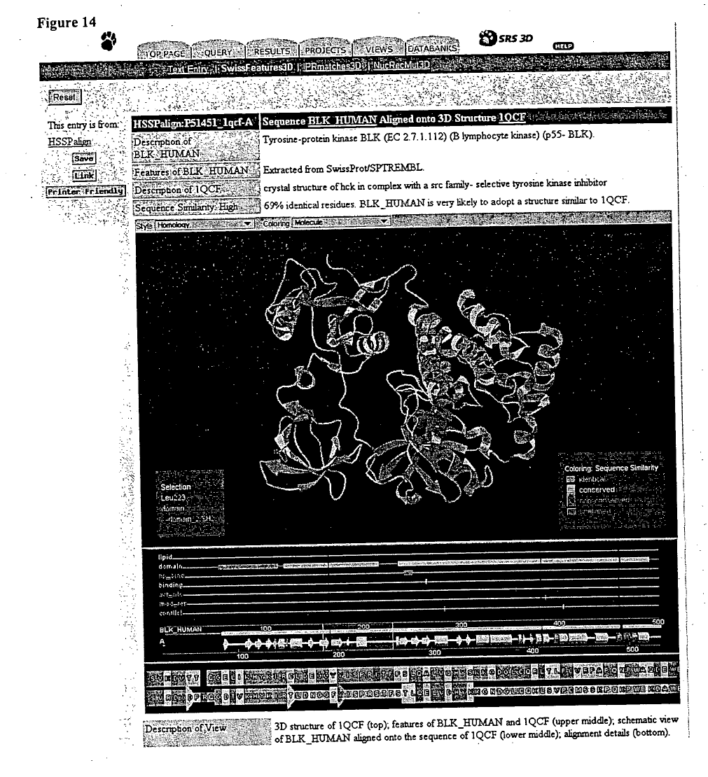

The screenshot of FIG. 14 shows a view of an HSSPalign entry, i.e. the alignment between a query protein sequence a given 3D structure. The associated 3D structure is also shown, initially colored so that the user can see which regions are similar to the query sequence. Annotations of the query sequence are also shown, in this case the annotations are extracted from SwissProt features.

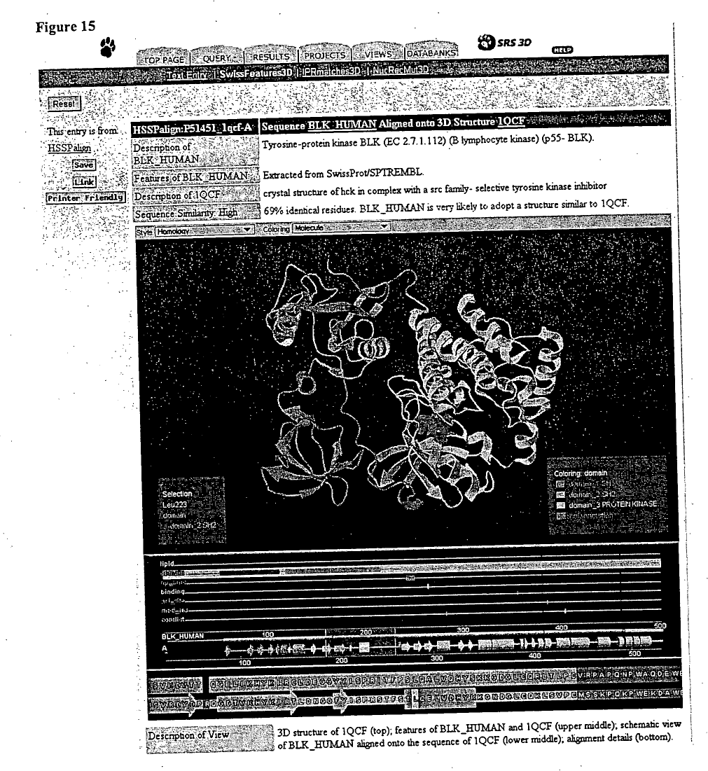

The screenshot of FIG. 15 shows another view of an HSSPalign entry. In this case, a SWISSPROT annotation (the domain annotation) has been activated by clicking on the correspoding annotation lane. This automatically maps the annotation onto the 3D structure, and colors the structure according to the annotation colors.

FIG. 16 provides a schematic representation of the processes invoved in the creation of the databases PSSH, HSSPalign and HSSPchain.

As a prerequisite to creating these databases, the following information is extracted from PDB and stored in the PDBequiv database:

For each chain contained in the PDB file,

the database reference(s) to SwissProt entry is extracted;

the similarity to other chains listed in the same PDB file before the current chain is calculated (based on the SEQRES records of the chains) and a pointer to the first (more than 99%) identical chain found is stored as a reference sequence;

an alignment between the sequence extracted from the coordinate section and the sequence given in the SEQRES record is calculated. For every residue of the SEQRES record the corresponding residue number and insertion code used in the coordinate section is stored. An alignment to an (almost) identical reference chain contained in the same PDB file is added where applicable.

The files composing the HSSP database are processed sequentially in order to create or update the databases HSSPchain, HSSPalign and PSSH. Each HSSP file contains matching sequences for the protein chains contained in one PDB file. A HSSP file is divided into several sections that are parsed sequentially. The content of these sections and the information extracted from them is described in the following:

(a) Header.

The header lists information about the protein sequences contained in the PDB file which were used for searching similar sequences in sequence databases and which serve as references in the resulting multiple alignment. (Alignments of chains not explicitly handled in the HSSP file because they are identical to the chains used in the search are generated while parsing the HSSP file using information stored in the PDBequiv database.)

(b) Matches.

The “PROTEINS” section contains a table of all matches found, properties of the matching sequences and statistics about the respective alignment (e.g. alignment length and sequence identity). The statistics are extracted to be stored in the HSSPchain and PSSH databases.

(c) Alignments and Insertions.

The alignment section contains the alignments of the matching sequences against the PDB structure. If more than 70 matching sequences have been found, the alignment section is split into several parts, each containing 70 alignments. Insertions in the matching sequences are omitted in the alignment section and instead listed in a separate section at the end of the file. For every insertion, that section contains the match number the insertion belongs to, the residue number (in HSSP numbering scheme) of the last residue of the query structure in front of the insertion and the inserted sequence of the match.

The alignments stored in HSSPalign are constructed using the information from the alignment and insertion sections. An alignment is stored in ClustalW format (Thompson, J. D., D. G. Higgins, et al. (1994). “CLUSTAL W: improving the sensitivity of progressive multiple sequence alignment through sequence weighting, positions-specific gap penalties and weight matrix choice.” Nucleic Acids Research 22: 4673-4680) and in a concise machine-readable format listing pairs of first and last residue numbers of all ungapped parts of the sequence alignment. In order to be able to use the PDB residue numbering (including insertion codes) in this concise form of the alignment, reference is made to the PDBequiv database.

Using information about identical chains, the alignment database is completed to contain the alignment between a protein sequence and all matching chains in a PDB structure.

(d) Profile.

The profile section contains the relative frequency of each of the 20 amino acid residues in a given sequence position.

Non-overlapping matches between the same chain and protein sequence are combined into a single match by merging the corresponding alignments and calculating the sequence identity of the combined match.

For the production of PSSH, the matches of the individual protein sequences to PDB structures are assembled in separate files for each protein during the processing of HSSP. In a subsequent step, the information contained in these separate files is sorted by sequence identity and assembled in the PSSH database.

In order to ensure that the assembled database files can be handled by the file system as well as SRS, during database creation the resulting file size is checked regularly and database files are split into several parts if necessary.

The database creation can be executed either from scratch or in update mode. In update mode, only HSSP files that have been changed since the last execution of the database creation are processed. Subsequently, information about unchanged matches is extracted from the old databases and added to the new ones. Changes in HSSP file are detected either by comparison of the modification date of a HSSP file and the database files, or changed files can be specified explicitly in a file list.

Visualization of 3D Structures, Sequences and Annotations

Subsequently an exemplary embodiment of the present invention, wherein a three-dimensional view of proteins is provided, will be described with reference to FIG. 17 to 20.

FIG. 17 shows a single protein viewed using one preferred embodiment of the invention. The legend below refers to regions of this figure. In FIG. 17, the various letters stand for the following:

A. Style combo box

B. Coloring combo box.

C. Basic information about mouse controls

D. Clicking on molecule selects residues or atoms; selection is indicated by highlighted color.

E. Field or window providing a text description of the current selection.

F. Annotation lane

G. Sequence Overview.

H. Sequence Detail View.

I. Focus box.

J. Selection indicator

K. Complete HSSPalign entry.

L. Selection bar

M. 3D View.

N. Hierarchy Window

O. Legend window

P. Highlighted annotation lane

Q. Highlighted residues.

Using the style combo (A), a molecule can be set to a predefined representation and coloring. According to the invention various styles are available which have been explained previously.

By use of the coloring combo (B) the molecule coloring can be set or changed individually.

Denoted by C is a field or window which provides a user with basic information about mouse controls.

Clicking on an annotation lane (F) colors the molecule at the site or sites of an annotation by the colour of the annotation (default) or another distinguishing colour to be selected.

Sequence overview (G) comprises a lane with symbols indicating secondary structure elements. It shows the entire sequence. Clicking an element of the sequence overview selects a secondary structure element.

Sequence detail view comprises a lane of characters corresponding to the one-letter amino-acid or nucleic-acid code for a protein or a DNA. Clicking sequence detail view (H) selects a residue.

Focus box (I) indicates which part of the sequence is shown in the sequence detail view. Dragging the focus box changes the focus.

Selection indicator (J) indicates where selection occurs in the sequence.

The HSSPalign entry (K) shows sequence-to-structure alignment details.

Selection bar (L) enables selection of a database from which sequence features are extracted.

By means of hierarchy window (N) an element of hierarchy can be selected and/or expanded.

Legend window (O) provides a legend for the current coloring scheme.

Highlighting of an annotation lane (P) indicates that the colouring used for elements of this lane is used to color the corresponding regions of the molecule. For example, the three areas of lane F may be coloured, from left to right, blue, red and green. The left area corresponds to the lower left part of the 3 D structure shown at M and will be coloured blue. The middle area corresponds to the upper left part of the 3 D structure shown at M and will be coloured red. The right area corresponds to the right part of the 3 D structure shown at M and will be coloured green.

Highlighted residues (Q) indicate that these residues are selected.

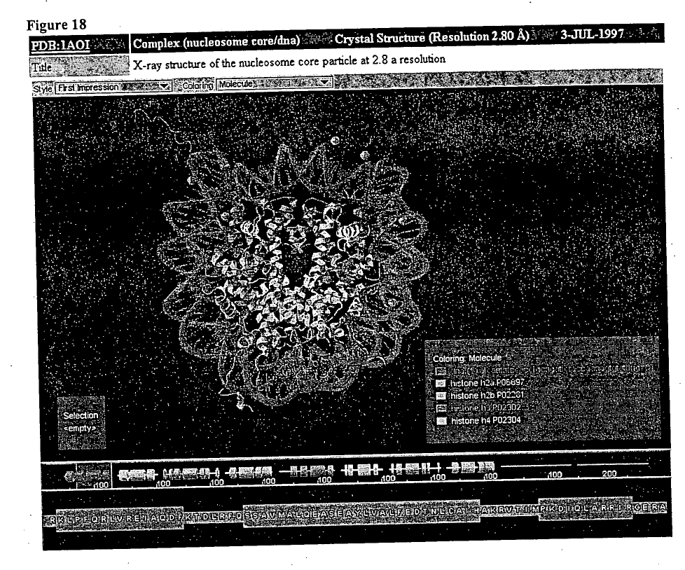

FIG. 18 shows, as a further example, a screenshot representing a complex consisting of eight protein chains and a strand of DNA, using a preferred embodiment of the invention.

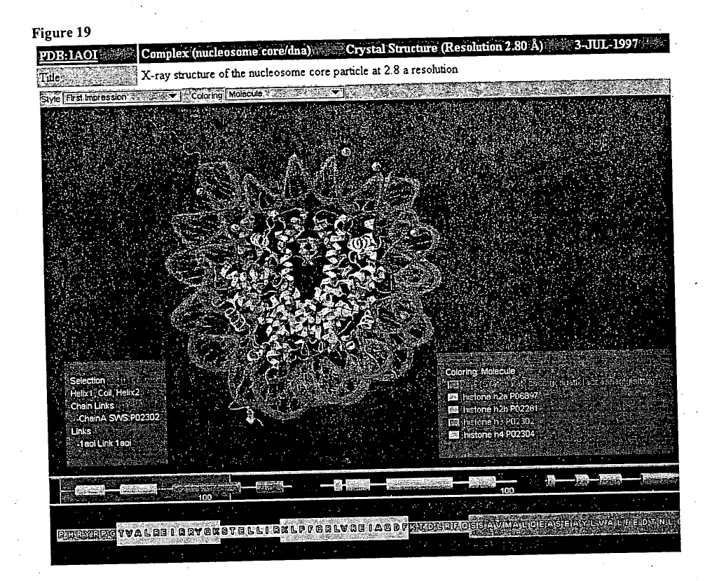

FIG. 19 shows a screenshot as in FIG. 18 with part of one protein selected. The selection is highlighted in all views, and the Sequence Overview automatically adjusts by zooming into that the selected chain.

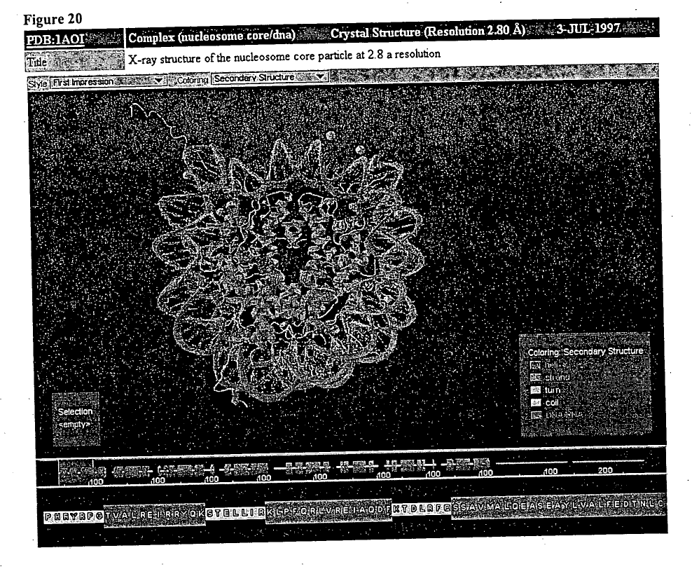

FIG. 20 shows a screenshot as in FIG. 18 or 19 with a different coloring scheme selected. The change of coloring is propagated to all views.

Selection Schemes

According to the invention a general selection scheme is provided that allows flexible selections and deselections. It should be noted that the selection scheme is most powerful in conjunction with a hierarchical object organization. In case of a macromolecule or even a single molecule a hierarchical data structure is inherent and hierarchy—dependent selection scheme are a powerful tool for making the view more intelligible.

Certain preferred special selection behaviors of the model are described below as non-limiting, non-exhaustive examples:

(a) Single-Level Selection.

With the Single-Level Selection the user is enabled to select an object in one determined level of the object hierarchy with a single mouse click action (without first choosing a menu item).

(b) Leaf-Level Selection.

If Leaf-Level Selection is chosen, the system selects only leaf items in the hierarchy in response to a single selection operation, such as a mouse click. Leaf items are items that terminate the hierarchical structure. Leaf items do not have any further descendants. According to one embodiment for visualizing macromolecules, leaf items are either whole molecules (at the cell level), residues or atoms.

(c) Adding to the Selection.

To add an object to a selection the selection is extended by that particular object by a further mouse click or another selection command.

(d) Removing from the Selection.

To remove an object from a selection the object is taken out of the selection, e.g. by selecting an object from a selected range or portion of a representation and inputting a command, e.g. by means of a keystroke and/or a mouseclick, that this object is to be removed from the selection.

(e) Range Selection.

Range Selection can be applied to objects with a certain order. The input parameters for the range selection are a range anchor object and a second object. Together with the ordering they define the range that is added to the selection. Once a range is selected the range anchor will stay rigid for all further range selection, which means that one is able to reset the range by defining just a new range object. Especially, the ordering of residues is intrinsic (sequence data) and it can be used for residue range selection.

(f) Range Deselection.

Range De-selection functions as normal Range Selection, but rather than extending the selection by adding a range the range is taken out of the existing selection.

(g) Multiple Range Selection/Deselection.

The invention provides the facility of defining multiple range selections/range deselection, i.e. multiple, non-coherent items can be selected or deselected in response to an appropriate command.

(h) Hierarchical Selection.

The input parameters for a hierarchical selection are, according to the one embodiment of the invention, the existing selection (if there is no existing selection hierarchical selection acts as adding to the selection) and a second object that is used as anchor for the hierarchical extension. In case of an existing selection the given upward hierarchy of the anchor object is examined. A concrete level (e.g. the lowest) in the anchor hierarchy that is not part of the existing selection is determined. The structural unit or units at this level comprising the selected range and all their descendant objects are added to the selection. In other words the hierarchical selection simply steps up one hierarchy level from the existing selection in respect to the anchor object. The invention may also provide a hierarchical selection that inverts the described mechanism starting on a top level object and refining the object down to the detail of interest.

(i) Hierarchical Deselection.

Hierarchical Deselection that removes objects from the selection in a hierarchical manner, analogous to hierarchical selection. The input parameters are, as above, the existing selection and an anchor object. Rather than adding an upper hierarchy level to the selection, a lower level of the hierarchy (that includes the anchor) is removed from the selection.

(j) Selection by Text Searching.

Searching for a matching string in a sequence, the user can simply type in either a search command, such as Ctrl-F, or just start typing alphabetic characters (since they have no other assignment, this can start a search). Useful qualifiers are: which sequence to search (if there are several) and whether to find all matches or just the next match. The use of wildcards (e.g. *=any character) is provided according to one embodiment to allow the user to find non-exact patterns in the sequence. Residue ranges that match the query term are selected in all views on a graphical user interface, and can then be operated upon with any of the above functions.

(k) Selecting Annotations and Features.

Whole annotations or individual features can be selected. This may result e.g. in coloring the molecule by the annotation colors or displaying information related to the annotation, but it may also result in simply selecting the corresponding range of residues. The above graphical selection/deselection methods can also be applied to annotation objects.

According to an exemplary embodiment, the selected parts of the molecule are indicated by a lighter shading of the same color. This representation has the advantage that the user still sees the original coloring and representation information.

According to certain embodiments, the invention may also provide for navigating through a biological environment, e.g. a cell or a three-dimensional structure of a protein or an ensemble of proteins. Navigation of a focus (group of objects that are in focus or the selection itself) can very useful in understanding the dependencies between related data, such as the relationship between sequences and macromolecules. The following navigation functions were found to be particularly useful in this respect.

(a) Stepping through the Hierarchy Level.

The hierarchical structure enables to step through elements with some common properties. Especially, the invention provides for stepping through the elements of one hierarchy level (that is defined by the current focus or selection) one by one (or with any other step size). For example, the user may have selected a chain. By iterative tabbing he could cycle though all chains available in one view, without changing its content.

(b) Moving Up or Down the Hierarchy.

The hierarchical structure enables the user to change the current focus level in the hierarchy. One user operation is provided for stepping up one level, a second for going down the hierarchy towards a specific anchor.

(c) Proximity Selection.

According to the present invention it is basically possible to apply arbitrary operations on the selected items and especially to analyze molecules based on the selection made. One analysis tool with great importance, especially in drug discovery, is the determination of the proximal area around specified objects (selection) using a certain metric and threshold. The invention provides for a tool, wherein all chemical or biological items which are within a certain range around selected items are determined by analysing the environment of the selected items. For example, nearest neighbours, next nearest neighbours can be determined, especially in an ordered structure. Alternatively, all elements within a certain radius around a given object or point may be determined.

Other extensions to these ideas are possible, for example moving to the beginning or end of a chain or secondary structure element.

The invention also provides for selection-based functionality, i.e. special functions or operations applied to the selected part. Some of these functions will be described in more detail subsequently.

(a) Minimal Distance Computation.

The described selection scheme can be utilized with a Minimal Distance Computation function. The hierarchical organization of the objects is used to detect groups (sub hierarchies) of objects in the selection. For two groups in this selection the minimal distance using a defined metric can be determined and displayed. This is especially interesting in the analysis of molecules.

(b) Surface Calculation.

According to one embodiment of the invention a binding surface around selected items is calculated and displayed.

(c) Labeling.

Selected items are provided with a label displayed on the graphical user interface. According to a preferred embodiment, the display of labels can be switched on and off for selected items and new labels, links or other information can be added to selected items only.

(d) Changing Properties.

According to an embodiment of the invention, the representation of selected items, such as coloring, changing representation and visibility can be changed in conjunction with a selection.

(e) Applying a Style.

A style, e.g. a style as described previously, can be applied to a selected part of the molecule, irrespective of the style of other parts of the molecule.

(f) Copying a Selection.

According to the invention it may be provided that when the user issues a copy command, the program copies the current selection to a paste buffer. The user can then paste the contents of the buffer into another application, for example a text editor. This can be a useful way of saving a range of residues. The paste buffer can also hold not just the residues selected, but all in the current chain, or all chains. The selected residues can then be selectively highlighted in such a way as to indicate that they are selected.

(g) Linking from 3D Structures—3D Mark-Up.

The invention may provide that the user can open URLs related to protein features by clicking on the features or on the 3D structure itself, when direct linking is enabled. This enables a user to find out directly from the 3D structure which features may be important based on their 3D location, and then directly follow hyperlinks to get more information about these features.

The invention may provide a Selection Description Overlay (visible in the 3D Viewer) that describes the content of the current selection. Additionally, further information collected from appropriate databases, such as annotations from InterPro or SwissProt, is provided in a suitable manner in the graphical user interface for the selected items.

Summarizing, according to one aspect the invention provides a combination of a selection scheme, as described previously, followed by the application of a function (on the selection).

The above selection and navigation behavior can e.g. be implemented with the following key and mouse assignments.

The following tables gives a simplified explanation of a set of mouse controls that implement the above selection scheme.

| | |
|---|---|
| click: | |
| on atom | selects atom |
| on residue | selects residue |
| on annotation lane | colors molecule by annotation |
| on annotation feature | selects residue range of feature |
| on element in sequence | selects secondary structure element |
| overview | clears selection |
| on background | |
| Shift + click | selects a range of residues |
| Ctrl + click: | |
| on a selected object | extends selection to next level of hierarchy |
| on an unselected object | keeps previous selection; starts new selection |
| Shift + Ctrl + click: | |
| on a selected object | removes object from selection |
| on an unselected object | removes next level of hierarchy from selection |
| Alt + click | selects whole chain |

A specific embodiment of the invention may further provide the following mouse operations, alone and in combination with function keys, such as shift, control, alt, etc. The following table lists in a first column the mouse operation and in further columns the respective key operation that effects a certain function.

| Mouse/ | | | | | | alt |
|---|---|---|---|---|---|---|
| Key | none | shift | control | shift/control | alt | graph |
| left | select bottom | if selection already | add to selection; | if nothing in | select | X |
| click | of hierarchy | exists, | successive | the chain is | whole | |
| | (lose previous | (re)set residue | clicks | selected, Select | chain | |
| | selection); | range selection; | select elements | whole | | |
| | no toggle | if object is atom | hierarchically, | chain; if part | | |
| | | (or bond), select | including whole | of the chain | | |
| | | whole residue; | layer, then all | is already | | |
| | | if previous click | layers; no | selected, deselect | | |
| | | was | toggle | elements hierarchically | | |
| | | shift/control | | | | |
| | | (i.e. deselect), | | | | |
| | | deselects a | | | | |
| | | range or residues; | | | | |
| | | no toggle | | | | |
| left | (above then) | (above then) | (above then) | (above then) | X | X |
| double | auto-zoom to | auto-zoom to | auto-zoom to | auto-zoom to | | |
| click | selection | selection | selection | selection | | |
| left | rotate view | zoom to center | rotate view | combine | X | X |
| drag | around X & | of screen | around z-axis | shift/control | | |
| | Y axes | | | | | |

The invention may also provide, according to an exemplary embodiment, for the following key functions.

| | |
|---|---|
| Esc | clears selection; closes context menu; cancels an operation |
| | in progress |
| Enter or | auto-zooms to selection; zoom to whole molecule if |
| Return | nothing is selected |
| Shift Enter | auto-zooms to whole structure without changing selection. |
| Right Arrow | selects next residue in the sequence |
| Left Arrow | selects previous residue in the sequence |
| Shift + Right | adds next residue to selection range |
| Arrow | |
| Shift + Left | adds previous residue to selection range |
| Arrow | |
| Up Arrow | selects next higher level in hierarchy |
| Down Arrow | selects next lower level in hierarchy |
| Tab | selects next sequence object (residue, secondary structure |
| | element, or chain) depending on the currently selected |
| | object |
| Shift + Tab | selects previous sequence object (as above) |
| 2 | rotates around x axis (counterclockwise) |
| 4 | rotates around y axis (clockwise) |
| 6 | rotates around y axis (counterclockwise) |
| 8 | rotates around x axis (clockwise) |
| + | zooms in stepwise |
| − | zooms out stepwise |
| control-A | selects all objects. |
| control-C | copies selection to paste buffer |
| control-L | Selects all ligands |
| control-I | toggles visible/invisible |
| control-R | toggles ribbon representation |
| control-T | toggles C-alpha trace |

The selection and functionality schemes described above can easily be applied to molecular biological environments, such as ensembles of proteins, protein structures or DNA/RNA structures, and to linear polymers in general.

The inherent hierarchical organization of the data (e.g. as molecular ensembles, molecules, residues, atoms) can be advantageously employed for appropriate selection schemes. The same applies to sequences, which can also be structured in an hierarchical manner.

Certain selection and style features are explained in more detail with reference to the attached drawings. The range of selection can be seen both in the three-dimensional representation and in the one-dimensional sequence view.

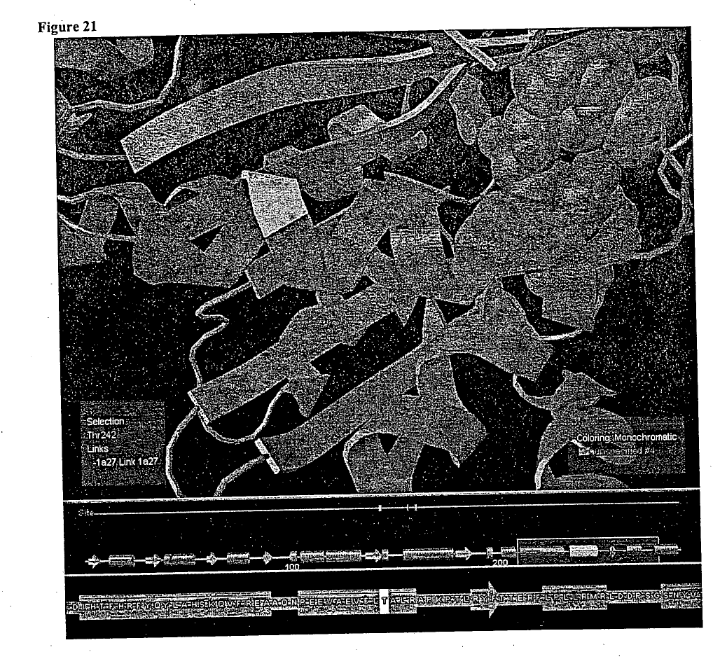

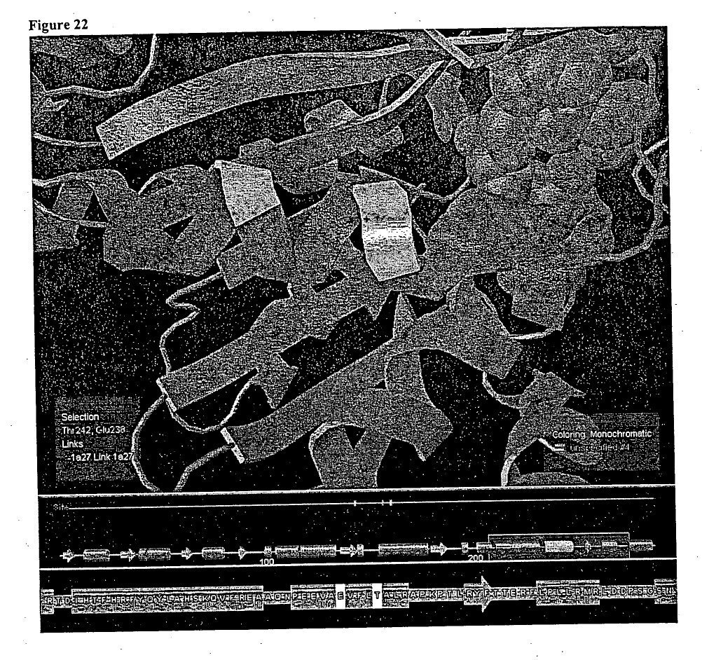

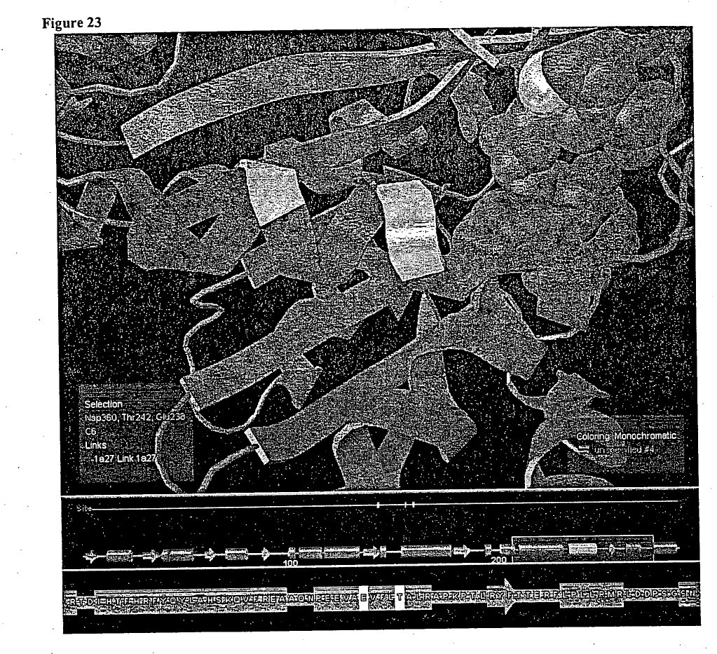

FIG. 21 to 23 illustrate leaf level selection. First a residue is selected (FIG. 21), then another residue is added (FIG. 22) and at last an atom is added (FIG. 23).

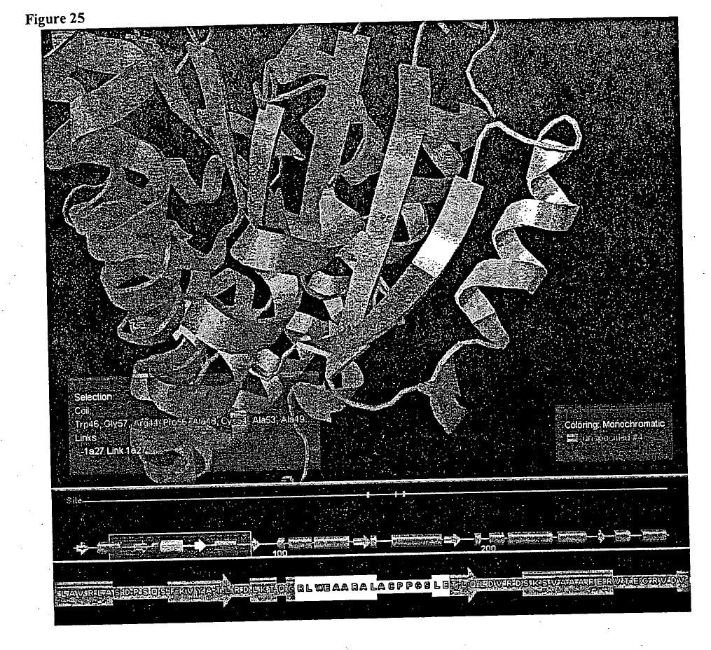

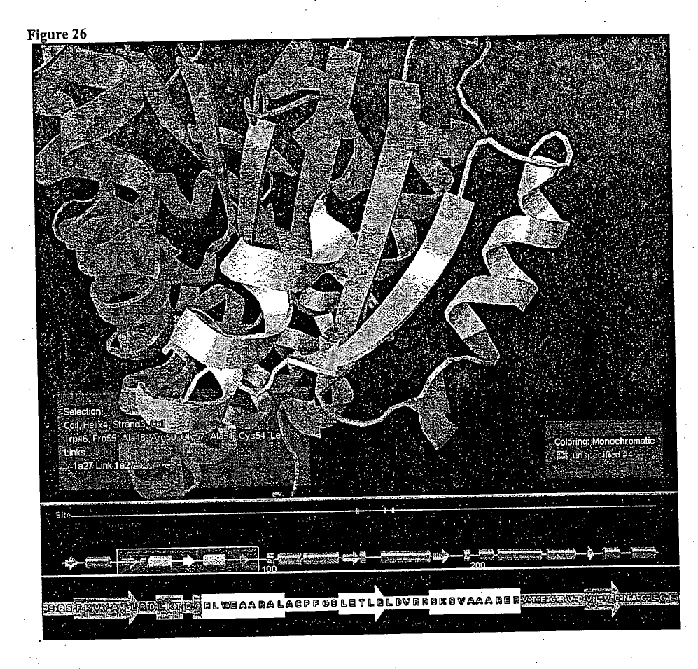

The example of range selection according to FIG. 24 to 26 starts with leaf selection of a residue (FIG. 24) and is then expanded to span a range (FIG. 25) to finally cover a full strand (FIG. 26).

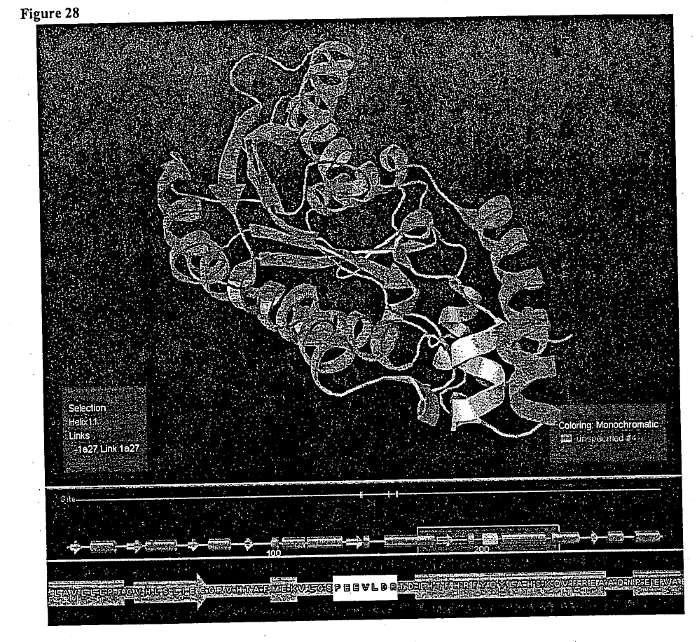

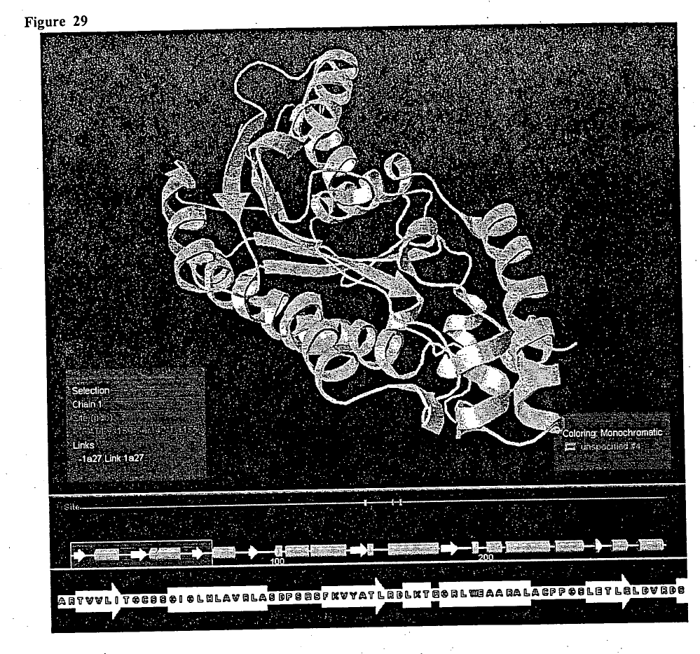

In the example of hierarchical selection exemplified in FIG. 27 to 29, starting from a single selected residue (FIG. 27), the user clicks with the CTRL key pressed, which causes the selection to be extended to the whole secondary structure element, in this case a helix (FIG. 28). Clicking again on the selected helix causes the entire chain to be selected (FIG. 29).

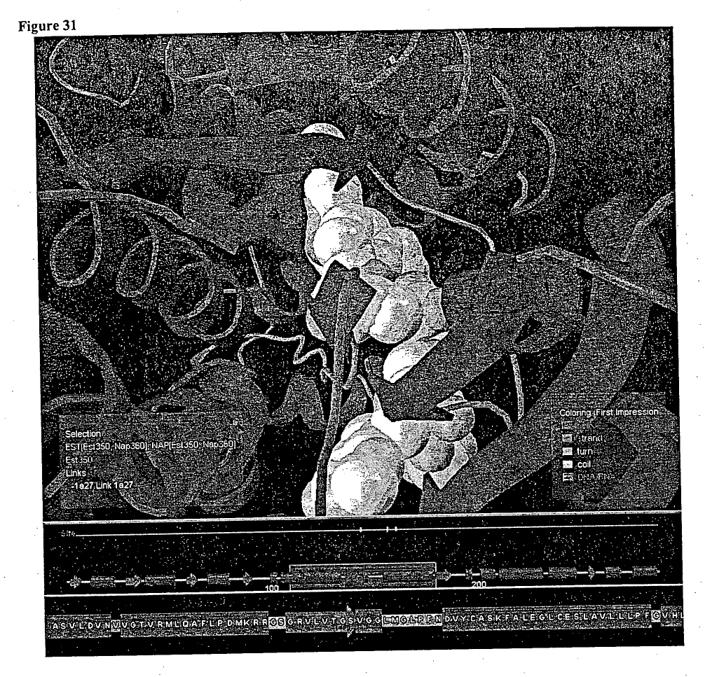

FIGS. 30 and 31 illustrate a zoom operation, followed by a change of style of parts of the representation which are interest. First, a ligand is selected (FIG. 30), then the auto-zoom is activated and the view zooms down continuously until the ligand nearly fills the screen (FIG. 31). When the zoom is complete, the center of rotation is set to the center of the ligand. Further rotations will turn the structure around the new center of rotation

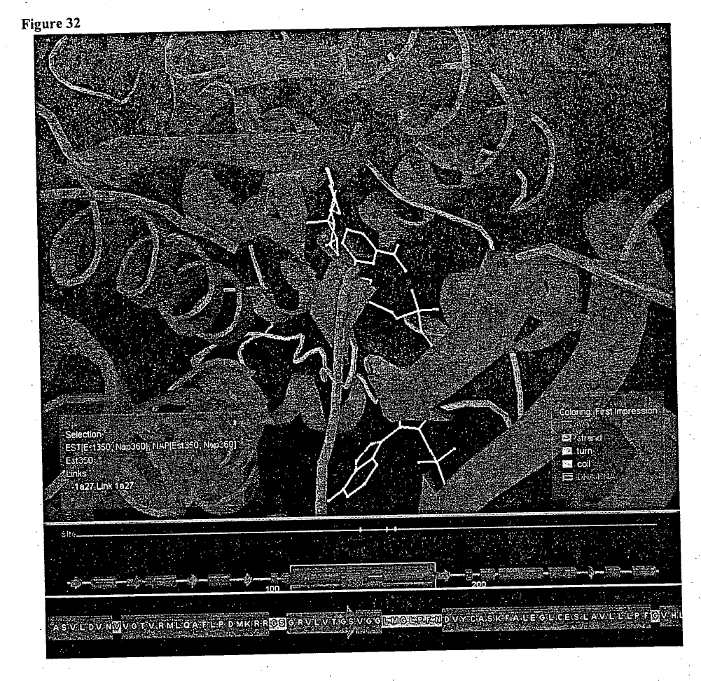

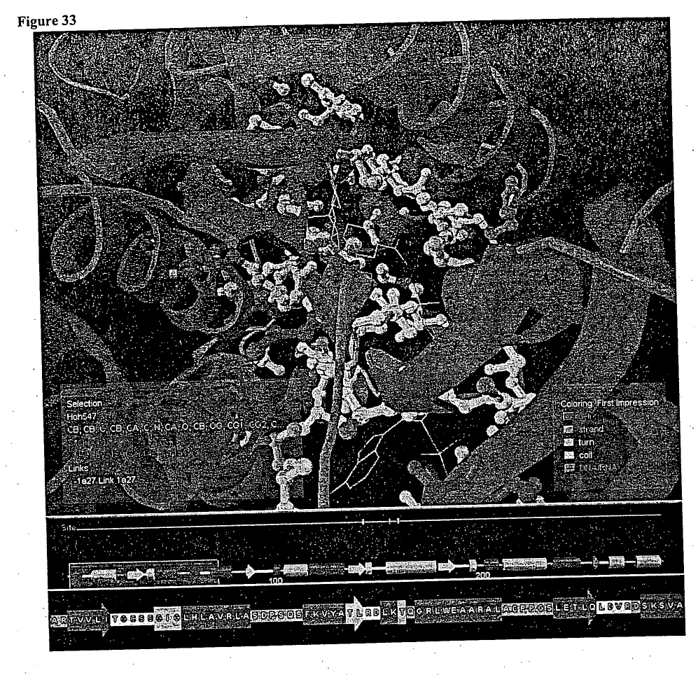

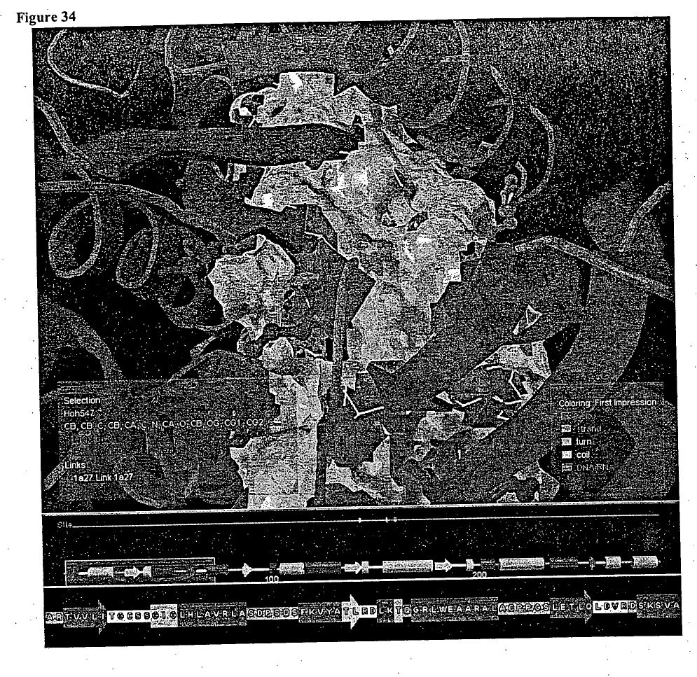

The representation of the current selection is then changed to wireframe (FIG. 32), after which proximity selection is applied to the ligand to select all atoms of the protein that are within 6A distance from the ligand (FIG. 33). From this selection of atoms close to a ligand, an accessible excluded surface is calculated and displayed (FIG. 34).

FIG. 35 illustrates the minimal distance function: in the exemplified example, the minimal distance from a helix to a ligand is calculated.

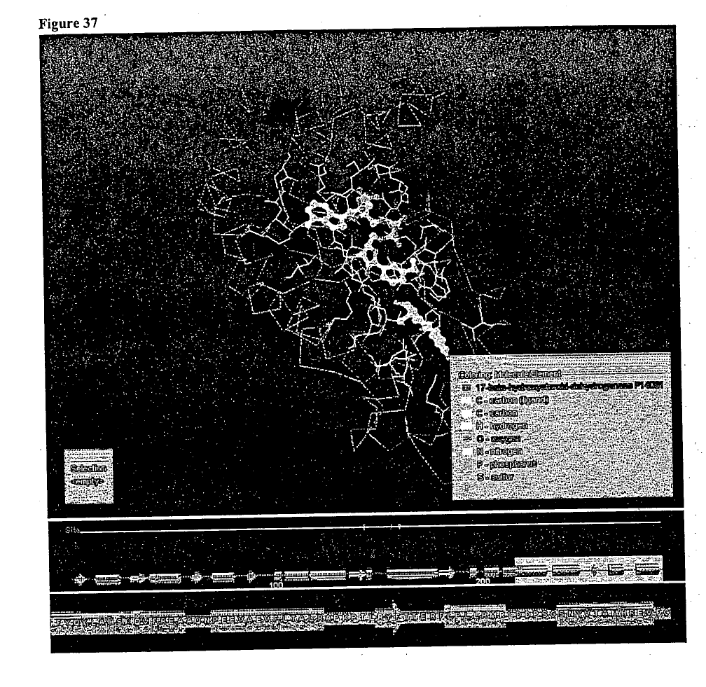

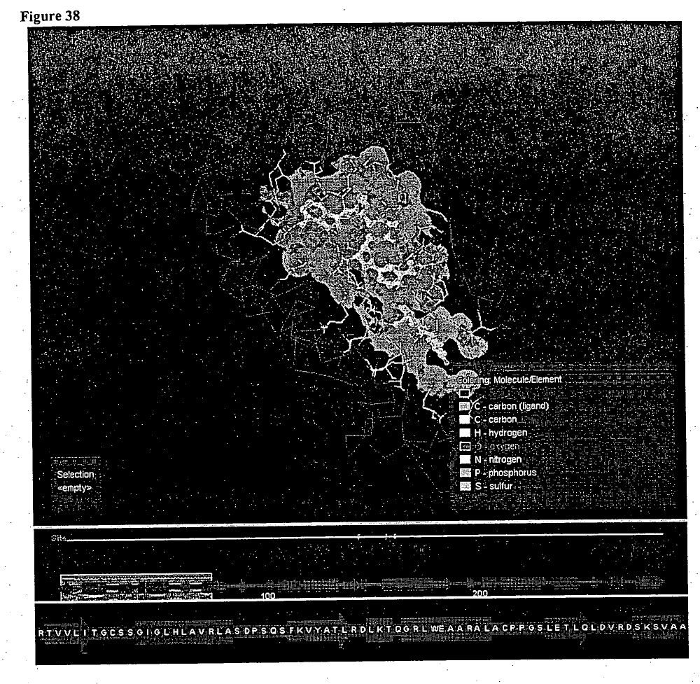

FIG. 36 to 38 illustrate various representation styles according to this invention. FIG. 36 shows the representation of a protein with a bound ligand in first impression style. In FIG. 37 the same protein/ligand complex is shown in the binding site style. After calculating a binding surface the protein/ligand complex looks like FIG. 38.

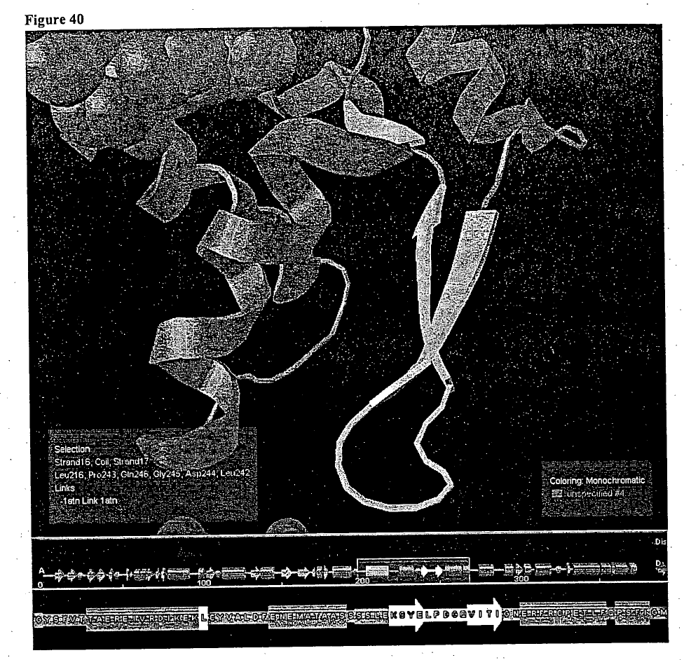

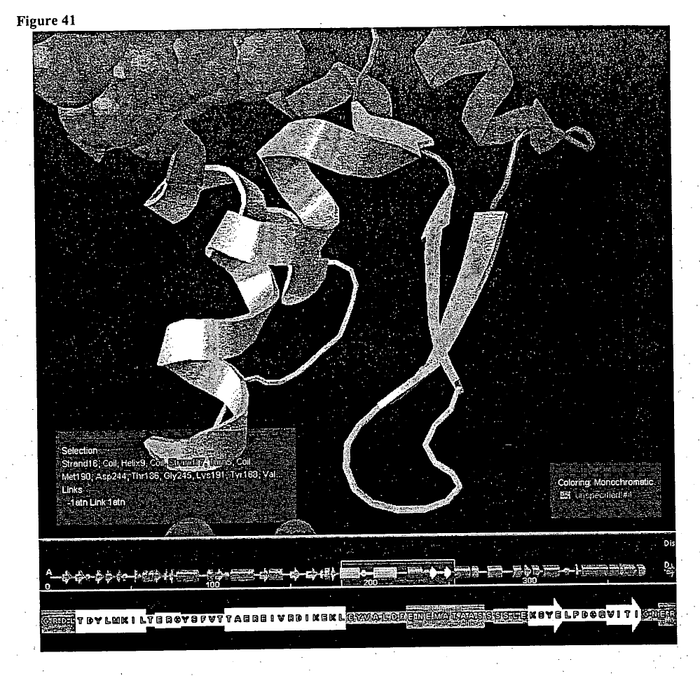

FIG. 39 to 41 illustrate multiple range selection according to this invention. FIG. 39 shows the result of a normal range selection. In FIG. 40 a residue has been added to the selection and FIG. 41 shows the result when the second range is selected.

FIG. 42 illustrates labelling in a three-dimensional representation according to the invention.

1. Method for depicting one or more biological elements in a basic environment by means of a data processing system comprising the steps of:
a) obtaining one or more data sets relating to a biological element,
b) determining at least one first feature element from said data sets, said feature element providing information on a relation between said biological element and said basic environment,
c) obtaining data determining a graphical representation for depicting at least one of the biological elements corresponding to said one or more data sets
d) determining a relation between the graphical representation of said basic environment and said graphical representation on the basis of said first feature element,
e) providing means for effecting that in a graphical representation of said environment generated from said data said graphical representation of said biological element is depicted as located on said display of said basic environment element according to said relation determined on the basis of said first feature element.

2. Method according to claim 1, comprising the further steps of
receiving an input to select one or more databases,
receiving further input to select one or more desired data sets from the one or more databases based on one or more selection criteria.

3. Method according to claim 1 or 2, wherein the biological elements are selected from the group comprising molecules, complexes of molecules, atoms, sub-atomic particles, SNPs/SAPs, exon/intron borders, annotations of active site residues and/or post-translational modification sites.

4. Method according to one of claims 1 to 3, wherein the display of said basic environment element is enhanced by locating at least 50 of said graphical representations of said biological elements on said display of said basic environment element.

5. Method according to claim 4, wherein the display of said basic environment element is enhanced by locating at least 500 of said graphical representations of said biological elements on said display of said basic environment element.

6. Method according to claim 5, wherein the display of said basic environment element is enhanced by locating at least 5000 of said graphical representations of said biological elements on said display of said basic environment element.

7. Method according to one of claims 2 to 6, wherein one or more further feature elements are determined for said one or more data sets and the one or more further feature elements are extracted from the same database as the database from which the first feature element was determined.

8. Method according to claims 2 to 7, wherein one or more further feature elements are determined for said one or more data sets and the one or more further feature elements are extracted from one or more different databases as the database from which the first feature element was determined.

9. Method according to claim 7 or 8 comprising the steps of:
determining at least one second feature element for said at least one data set and,
further modifying the data representing the display of said basic environment element by using the information from said second feature element such that the graphical representation of said basic environment element is enhanced so as to place the at least one biological element into said basic graphical representation of said basic environment element.

10. Method according to claim 7 or 8 comprising the steps of:
determining at least one further feature element for said at least one data set and,
further modifying the data for displaying said at least one graphical representation of said biological element by using the information from said further feature element.

11. Method according to claim 10 wherein a further feature element for said at least one data set pertaining to said at least one biological element contains information pertaining to one of the activities of said biological elements and the feature element is used to modify the graphical representation of said biological element by displaying the activity thereof.

12. Method according to one of claims 2 to 11, wherein said one or more databases, are chosen from the group comprising databases that comprise data sets with information regarding biomolecules, organic molecules and/or inorganic molecules found in living organisms.

13. Method according to claim 12, wherein the databases comprise data sets with information regarding genes and/or proteins and/or chemical compounds.

14. Method according to any of the above claims wherein said basic environment element is a representation chosen from the group comprising an organism, one or more tissue types, an organ, a cell, an organelle, a sub-cellular compartment, a complex of molecules, a molecule, an atom and/or a sub atomic particle.

15. Method according to one of claims 1 to 14, wherein said basic environment element is a linear polymer molecule or an ensemble of linear polymer molecules.

16. Method according to claim 15, wherein said basic environment element comprises a three-dimensional protein structure and one or more biological elements are protein features, such as SNPs, SAPs, domain boundaries, exon/intron borders, annotations of active site residues and/or post-translational modifications.

17. Method according to claim one of claims 1 to 16, wherein the representation is a two- or three-dimensional representation.

18. Method according to claims 15 to 17, wherein a three dimensional representation of a linear molecule is displayed together with a one-dimensional representation of said linear molecule.

19. Method according to claim 18, characterized in that said one dimensional representation is a character representation.

20. Method according to one of claims 18 or 19, wherein the graphical representation of said basic environment element is a three dimensional representation of a linear molecule, wherein one or more one dimensional representations of the sites of said linear molecule are provided on a graphical user interface, wherein one or more biological elements are represented in one or more of said one dimensional representations and wherein selecting a representation of a biological element in one of these one-dimensional representations results in said three-dimensional representation of said linear molecule to be enhanced by the selected biological element.

21. Method according to one of claims 1 to 20, wherein the graphical representation of said biological element is different from the graphical representation of said environment element.

22. Method according to one of claims 16 to 20, wherein said linear molecule comprises a sequence of elements and differs from the sequence of a second molecule aligned thereto such that there is an optimum match of the elements at the aligned sites of said first and second molecules, wherein said biological element consists of one or more elements of said first molecule differing from the aligned sequence of said second molecule and said first feature element comprises information on the site or sites of said differing elements, wherein said biological element is represented at the sites indicated by said first feature in a manner different from the representation of said linear molecule.

23. Method according to one of claims 1 to 22, characterised in that a part of said basic environment element is selected on which whole or part of said biological element is to be located in said graphical representation.

24. Method according to claims 18 to 23, wherein a one-dimensional representation of a linear molecule is displayed, a range of elements of said molecule is selected in said one-dimensional display, wherein said biological element is a part of said molecule and is depicted at the location of the three-dimensional representation of said molecule corresponding to the selected range in that one dimensional representation.

25. Method according to any of the above claims comprising the step of determining the area that is depicted in said display of said basic environment element by selecting an area in a second display of said basic environment element.

26. Method according to one of claims 15 to 22, characterised in that a range of said macromolecule displayed and/or selected and/or the element on which the cursor is currently positioned are displayed in said one-dimensional representation.

27. Method according to one of claims 1 to 26, characterised by the steps of a method according to one of claims 28 to 93, 129 to 134 or 136 to 139.

28. Method of visualising biological entities, especially linear macromolecules, by means of a data processing system, comprising the steps of
providing a multidimensional graphical representation of one or more biological entities on a graphical user interface,
interacting with said graphical user interface to select a point or feature of a portion of said graphical user interface containing said representation,
determining a part of a biological entity to be selected that was not represented by a feature selected in said previous interaction step and selecting said part of said biological entity,
performing an operation on the representation of the selected part of said entity.

29. Method according to claim 28 wherein the representation of at least one biological entity comprises a plurality of individual graphical elements, said feature selected in said step of interacting with the graphical user interface is a graphical element of the representation of said biological entity and wherein a further part of said biological entity is determined to be selected that was not represented by said selected graphical element.

30. Method according to claim 29, wherein said step of selecting a graphical element of said representation implies the selection of the portion of said entity represented by said graphical element.

31. Method according to claim 29, wherein said step of selecting a graphical element of said representation implies the selection of only part of the portion of said entity represented by said graphical element.

32. Method according to one of claims 28 to 31, wherein said biological entity is a linear molecule and said method comprises the steps of:
interacting with said multidimensional graphic representation to select a further graphical element of the multidimensional graphical representation of said molecule, thereby selecting the entire range of said molecule represented by the portion of said graphical representation from said first graphical element to said second, further graphical element,
performing an operation on the representation of the selected range of said molecule.

33. Method according to one of claims 28 to 32, wherein said biological entity is a linear molecule and said step of determining a further part of said biological entity comprises the steps of:
interacting with said multidimensional graphical representation to select a further graphical element of the graphical representation of said biological entity, thereby adding the portion of said biological entity represented by said graphical element to the selected part of said biological entity.

34. Method according to one of claims 28 to 33, comprising the step of providing data representing one or more biological entities, at least one of these entities being represented as consisting of basic biological units, especially residues of a sequence.

35. Method according to claim 34, wherein said data related to said biological entity comprise data assigning one or more basic biological units to one or more structural units of said biological entity, said structural units and said basic biological units forming a hierarchy in that each of said structural units comprises at least one basic biological unit and/or another structural unit, said step of determining a part of a biological entity to be selected comprises the steps of:
determining a level of hierarchy and
selecting a structural unit at the determined level of hierarchy which comprises a previously selected basic biological unit or group of basic biological units of said biological entity.

36. Method according to claim 35, wherein in a first step one or more graphical elements of said representation are selected and in a further step all basic biological units and/or structural units are selected that comprise or correspond to basic biological units corresponding to any of said graphical elements of said representation selected in said first step.

37. Method according to claim 36, wherein one graphical element of said representation is selected by interacting with said graphical representation of said biological entity and that the structural unit at said level of hierarchy is selected which comprises all basic biological units of said biological entity corresponding to the selected element of said representation.

38. Method according to one of claims 35 to 37, wherein said level of hierarchy is the next higher level to that of the greatest structural unit comprised in the group of selected basic biological units.

39. Method according to one of claims 35 to 37 wherein said level of hierarchy is greater or equal to that of the greatest structural unit represented by a previously selected graphical element.

40. Method according to one of claims 35 to 37, wherein said level of hierarchy is in a predetermined relation to the level of hierarchy represented by a selected graphical element.

41. Method according to claim 40, wherein in a first step one or more basic biological units are selected, a graphical element is further selected as an anchor object and that said level of hierarchy is in a predetermined relation to the level of hierarchy represented by said anchor object.

42. Method according to one of claims 35 to 41, wherein said selection of the level of hierarchy is effected by a keystroke and/or a mouse click.

43. Method according to one of claims 28 to 32, wherein a further part of the biological entity to be selected is determined by a calculation having as input parameters parameters related to one or more selected points or features of the graphical user interface or one or more basic biological units and/or structural units previously selected.

44. Method according to claim 43, wherein those basic biological units and/or structural units within a certain distance around a point or feature selected in said graphical user interface are determined and the basic biological units and/or structural units determined are selected.

45. Method according to claim 43 or 44, wherein the part of said biological entity comprising the basic biological units and/or structural units determined by said calculation are displayed differently from the previous representation of said biological entity.

46. Method according to one of claims 43 to 45, wherein the part of said biological entity comprising the basic biological units and/or structural units determined by said calculation are displayed differently from other parts of the representation of said biological entity.

47. Method according to claim 43 to 46, wherein a representation of said basic biological units and/or structural units determined by said calculation is displayed and/or marked subsequent to said calculation.

48. Method according to one of claims 28 to 47, wherein those basic biological units and/or structural units closest to a point or feature selected in a portion of a said graphical user interface containing said representation of said one or more biological entities are determined by said calculation.

49. Method according to one of claims 28 to 48, wherein said interaction with said graphical user interface comprises a mouse click and/or a keystroke.

50. Method according to one of claims 28 to 49, wherein said selected part of the biological entity is represented differently from the rest of the biological entity.

51. Method according to claim 50, wherein said selected part is represented in a different representation style.

52. Method according to one of claims 28 to 51 wherein said representation is zoomed to the selected part of said biological entity.

53. Method according to claim 52, wherein said zoom is such that the selected part of said biological entity is fully displayed on the screen.

54. Method according to one of claims 52 or 53, wherein said zoom is continuous.

55. Method according to one of claims 28 to 54, wherein said operation comprises executing a link assigned to a selected part of said biological entity or a selected part of the representation thereof and displaying information provided by said link.

56. Method according to one of claims 28 to 55, wherein at least one of said biological entities comprises a molecule and a binding surface of said molecule is calculated with regard to the selected point or feature.

57. Method according to claim 56, wherein said selected feature is the representation of a further molecule or part thereof.

58. Method of visualising biological entities, especially linear polymer molecules or ensembles of polymer molecules, by means of a data processing system, comprising the steps of
providing data representing at least one biological entity as consisting of basic biological units wherein said data related to said biological entity comprise data assigning one or more biological units to one or more structural units of said biological entity, said structural units and said biological units forming a hierarchy in that each of said structural units comprises at least one basic biological unit and/or another structural unit,
providing a multidimensional graphical representation of one or more biological entities on a graphical user interface,
selecting a level of hierarchy and
operating on the graphical user interface on the basis of the selected hierarchy.

59. Method according to claim 58, wherein said biological entity is a linear molecule and a cursor movement is provided along said molecule in steps of one or more structural units at the chosen hierarchy level.

60. Method according to claim 58 or 59, wherein a certain representation style is assigned to each hierarchy level and a biological entity is depicted according to the style determined for said hierarchy.

61. Method according to one of claims 58 to 60, wherein the representation of said biological entity is shown as consisting of graphical elements, at least part of which correspond to structural units at the chosen level of hierarchy.

62. Method according to one of claims 58 to 51, wherein a part of the representation of said biological entity is selected and an operation on said selected part is performed on the basis of the selected hierarchy.

63. Method according to one of claims 58 to 62, wherein different levels of hierarchy are chosen for different parts of said representation of said biological entity.

64. Method according to claim 63, wherein one or more of said different parts are determined by selecting a portion of said biological entity and a level of hierarchy is chosen for operations on the graphical representation of the selected portion.

65. Method according to one of claims 58 to 64, wherein said level of hierarchy is chosen by a keystroke and/or a mouse click.

66. Method according to claim 65, wherein by means of a keystroke and/or a mouse click the next higher or lower level of hierarchy is selected.

67. Method according to one of claims 58 to 66, wherein said level of hierarchy is in a predetermined relation to the level of hierarchy represented by a selected graphical element.

68. Method according to claim 67, wherein in a first step one or more basic biological units are selected, a graphical element is further selected as an anchor object and that said level of hierarchy is in a predetermined relation to the level of hierarchy represented by said anchor object.

69. Method according to claim 58, characterized that in response to a cursor operation in the vicinity of or on a graphical element of said graphical representation a zoom is effected to the structural unit at the chosen hierarchy level part or whole of which is represented by said graphical element.

70. Method of visualising linear polymer molecules or ensembles of linear polymer molecules, especially biological macromolecules, by means of a data processing system comprising the steps of
providing data representing one or more molecules as consisting of basic units,
providing a multidimensional graphical representation of the molecule or molecules on a graphical user interface,
providing a one-dimensional representation of said linear molecule or molecules on the same graphical user interface, said one-dimensional representation comprising subsequent graphical sites representing the site of subsequent basic units, wherein each basic unit is represented by a symbol indicating the respective basic unit,
providing at least one further one-dimensional representation comprising a sequence of graphical sites which are at least partly aligned with the one-dimensional representation of said linear molecule or molecules on the same graphical user interface,
interacting with one of said further one-dimensional representations to select one or more sites corresponding to sites of basic elements of said linear molecule or molecules,
selecting the basic units in the multidimensional representation of said molecule or molecules corresponding to the selected sites in said further one-dimensional representation.

71. Method according to claim 70, characterized by the step of performing an operation on the multidimensional representation of the selected sites of said molecule or molecules.

72. Method according to claim 70 or 71, wherein a further one-dimensional representation corresponds to a further linear molecule different from said first molecule or molecules and matching one of said first linear molecules at least over part of said sequence of sites according to predetermined criteria, said one-dimensional representation of said further linear molecule being arranged such that matching sites in said one-dimensional representations are aligned.

73. Method according to one of claims 70 to 72, wherein a further one-dimensional representation comprises sites aligned with said first or second one-dimensional representation and comprising symbols indicating information related to a basic unit of said first or second molecule.

74. Method according to one of claims 70 to 73, wherein selecting one of said symbols effects a different representation of the portion of the multidimensional representation of said molecule or molecules corresponding to the site of said selected symbol.

75. Method according to claim 74, wherein said information is displayed in said multidimensional representation.

76. Method of visualising biological entities, especially linear polymer molecules, by means of a data processing system comprising the steps of
providing a multidimensional graphical representation of one or more biological entities on a graphical user interface,
selecting one or more points or features of a portion of said graphical user interface containing said representation,
performing a calculation having as input parameters parameters related to one or more selected points or features of the graphical user interface or one or more portions of a biological entity previously selected and having as output data related to a multidimensional graphical representation of a biological entity,
altering said multidimensional graphical representation according to the result of said calculation.

77. Method according to claim 76, wherein portions of a biological entity within a certain distance around a point or feature selected in said graphical user interface are determined by said calculation.

78. Method according to claim 76 or 77, wherein a part of said biological entity is selected as a result of said calculation and the selected part of said biological entity is displayed differently from the previous representation of said biological entity, especially in a different representation style.

79. Method according to one of claims 76 to 78, wherein a part of said biological entity is determined by said calculation and said part is displayed differently from other parts of the representation of said biological entity.

80. Method according to one of claims 76 to 79, wherein a representation of a part of said biological entity is determined by said calculation and said part is displayed and/or marked subsequent to said calculation.

81. Method according to one of claims 76 to 80, comprising the step of providing data representing one or more biological entities, at least one of these entities being represented as consisting of basic biological units, especially residues of a sequence.

82. Method according to claim 81, wherein said data related to said biological entity comprise data assigning one or more basic biological units to one or more structural units of said biological entity, said structural units and said basic biological units forming a hierarchy in that each of said structural units comprises at least one basic biological unit and/or another structural unit.

83. Method according to claim 82, wherein one or more basic biological units and/or structural units are determined as the result of said calculation.

84. Method according to claim 83, wherein those basic biological units and/or structural units closest to a point or feature selected in a portion of a said graphical user interface containing a multidimensional representation of said one or more biological entities are determined.

85. Method according to one of claims 76 to 82, wherein a zoom factor is determined such that the area spanned by selected points and/or features covers a given percentage of the area provided for said multidimensional representation in said graphical user interface and wherein a corresponding zoom is performed.

86. Method according to one of claims 76 to 82, wherein one or more structural units or basic biological units are determined according to a previously determined relation to the selected points or features and a zoom factor is determined such that the area covered by said basic biological units and/or structural units covers a given percentage of the area provided for said multidimensional representation in said graphical user interface and wherein a corresponding zoom is performed to a said basic biological units and/or structural units.

87. Method according to claim 86, wherein one or more graphical elements of a multidimensional graphical representation of a biological entity are selected and one or more structural units at a given hierarchy level are determined which comprise basic biological units represented by one or more selected graphical elements of said representation and a zoom factor is determined such that the area covered by said structural units covers a given percentage of the area provided for said multidimensional representation in said graphical user interface.

88. Method according to claim 87, wherein at least one selected graphical element corresponds to a structural unit at a certain level of hierarchy and the zoom is to said structural unit.

89. Method according to one of claims 85 to 88, wherein said zoom is continuous.

90. Method according to claim 88 or 89, wherein a level of hierarchy is selected and the zoom is to the structural unit or structural units at the selected hierarchy level comprising selected graphical elements or graphical elements in the vicinity of one or more selected points in said graphical user interface.

91. Method according to one of claims 76 to 90, wherein said step of selecting is effected by one or more mouse clicks and/or keystrokes and said steps of calculating and altering the representation are performed in response to these mouse clicks and/or keystrokes.

92. Method according to one of claims 76 to 90, wherein said steps of selecting, calculating and altering the representation are performed in response to one single mouse click.

93. Method according to one of claims 85 to 91, wherein said zoom is effected in response to one single mouse click.

94. Apparatus for organizing and depicting one or more biological elements, said apparatus comprising:
a receiving module for receiving an input to select one or more databases,
a receiving module for receiving further input to select one or more desired data sets from the one or more databases based on one or more selection criteria,
a determination module for determining at least one first feature element from each of said one or more data sets,
a determination module for determining a graphical representation for displaying at least one of the biological elements corresponding to said one or more data sets and,
an enhancing module for enhancing a display of a basic environment element by locating at least one of said graphical representations of said biological elements on said display of said basic environment element, depending on the information contained in said first feature element.

95. Apparatus for visualising biological entities, especially linear polymer molecules or ensembles of linear polymer molecules, comprising:
means providing a multidimensional graphical representation of one or more biological entities on a graphical user interface,
interaction means for interacting with said graphical user interface to select a point or feature of a portion of said graphical user interface containing said representation,
means for determining a part of a biological entity to be selected that was not represented by a feature selected in said previous interaction step and selecting said part of said entity,
means for performing an operation on the representation of the selected part of said entities.

96. Apparatus according to claim 95, characterized in that it comprises means for performing the steps of a method according to one of claims 28 to 57.

97. Apparatus according to claim 95 or 96, wherein said apparatus is adapted to perform the steps of determining a part of a biological entity to be selected that was not represented by a feature selected in said previous interaction step and/or selecting said part of said biological entity and/or performing an operation on the representation of the selected part of said entities are performed automatically in response to a user interacting with said graphical user interface to select a point or feature of a portion of said graphical user interface containing said representation.

98. Apparatus according to one of claims 95 to 97, wherein upon selecting a graphical element of said representation by a user the apparatus selects the portion of said entity represented by said graphical element.

99. Apparatus according to one of claims 95 to 97, wherein upon selecting a graphical element of said representation by a user the apparatus selects only part of the portion of said entity represented by said graphical element.

100. Apparatus according to one of claims 95 to 99, wherein a biological entity represented is a linear molecule and wherein upon interacting with said multidimensional graphic representation to select a further graphical element of the multidimensional graphical representation of said molecule, the apparatus selects the entire range of said molecule represented by the portion of said graphical representation from said first graphical element to said second, further graphical element and wherein said apparatus is adapted to perform an operation on the representation of the selected range of said molecule only.

101. Apparatus according to one of claims 95 to 100, further comprising means for determining a level of hierarchy and wherein said apparatus automatically selects a structural unit at the determined level of hierarchy which comprises a basic biological unit or group of basic biological units of said biological entity previously selected.

102. Apparatus according to one of claims 95 to 101, wherein upon selecting a plurality of graphical elements of said representation is selected the apparatus selects in a further step all structural units that comprise basic biological units corresponding to any of said graphical elements of said representation selected in said first step.

103. Apparatus according to claim 102, wherein upon selecting one graphical element of said representation by interacting with said graphical representation of said biological entity the apparatus selects the structural unit at said level of hierarchy which comprises all basic biological units of said biological entity corresponding to the selected element of said representation.

104. Apparatus according to one of claims 101 to 103, wherein said apparatus selects the next higher level to that of the greatest structural unit comprised in the group of selected basic biological units.

105. Apparatus according to one of claims 101 to 103, wherein said apparatus automatically selects the next higher level to that of the greatest structural unit comprised in the group of basic biological units selected previously.

106. Apparatus according one of claims 95 to 105, wherein said apparatus determines a further part of the biological entity to be selected by a calculation having as input parameters parameters related to one or more previously selected points or features of the graphical user interface or one or more basic biological units and/or structural units previously selected.

107. Apparatus according to claim 106, wherein said apparatus displays the part of said biological entity comprising the basic biological units and/or structural units determined by said calculation differently from the previous representation of said biological entity and/or from other parts of the representation of said biological entity.

108. Apparatus according to one of claims 106 or 107, wherein said apparatus displays and/or marks a representation of said basic biological units and/or structural units determined by said calculation subsequent to said calculation.

109. Apparatus according to one of claims 95 to 108, wherein said apparatus displays a selected part of a biological entity differently from the rest of the biological entity.

110. Apparatus according to one of claims 95 to 109, wherein at least one of said biological entities comprises a molecule and said apparatus calculates a binding surface of said molecule with regard to the selected point or feature.

111. Apparatus for visualising biological entities, especially linear polymer molecules or ensembles of linear polymer molecules, comprising:
means for storing data representing at least one biological entity as consisting of basic biological units wherein said data related to said biological entity comprise data assigning one or more biological units to one or more structural units of said biological entity, said structural units and said biological units forming a hierarchy in that each of said structural units comprises at least one basic biological unit and/or another structural unit,
means for providing a multidimensional graphical representation of one or more biological entities on a graphical user interface,
means for selecting a level of hierarchy,
wherein said apparatus performs operations on the graphical user interface on the basis of a previously selected hierarchy level.

112. Apparatus according to claim 111, characterized in that it is adapted to perform a method according to one of claims 53 to 62.

113. Apparatus according to one of claims 111 or 112, wherein subsequent to a selection of a part of the representation of said biological entity said apparatus performs an operation on said selected part on the basis of a selected hierarchy.

114. Apparatus for visualising linear polymer molecules or ensembles of linear polymer molecules, especially biological macromolecules or ensembles thereof, comprising:
means for receiving data representing a molecule or molecules as consisting of basic units,
means providing a multidimensional graphical representation of the molecule or molecules on a graphical user interface,
means providing a one-dimensional representation of said linear molecule or molecules on the same graphical user interface, said one-dimensional representation comprising subsequent graphical sites representing the site of subsequent basic units, wherein each basic unit is represented by a symbol indicating the respective basic unit,
means providing at least one further one-dimensional representation comprising a sequence of graphical sites which are at least partly aligned with the one-dimensional representation of said linear molecule or molecules on the same graphical user interface,
means for interacting with one of said further one-dimensional representations to select one or more sites corresponding to sites of basic elements of said linear molecule or molecules,
wherein said apparatus selects the basic units in the multidimensional representation of said molecule or molecules corresponding to the selected sites in said further one-dimensional representation.

115. Apparatus according to claim 114, comprising means for performing a method according to one of claims 70 to 75.

116. Apparatus according to one of claims 114 or 115, wherein upon selection of one or more symbols in one of said one-dimensional representations said apparatus effects a different representation of the portion of the multidimensional representation of said molecule or molecules corresponding to the site of said selected symbol.

117. Apparatus for visualising biological entities, especially linear polymer molecules or ensembles thereof, comprising:
means providing a multidimensional graphical representation of one or more biological entities on a graphical user interface,
means for selecting one or more points or features of a portion of said graphical user interface containing said representation,
means performing a calculation having as input parameters parameters related to one or more selected points or features of the graphical user interface or one or more portions of said biological entity previously selected and having as output parameters parameters related to a multidimensional graphical representation of a biological entity,
means for altering said multidimensional graphical representation according to the result of said calculation.

118. Apparatus according to claim 117 and comprising means for performing a method according to one of claims 79 to 93.

119. Apparatus according to claim 117 or 118, said apparatus selecting a part of said biological entity as a result of said calculation and displaying the selected part of said biological entity differently from the previous representation of said biological entity and/or from other parts of the representation of said biological entity.

120. Apparatus according to one of claims 117 to 119, wherein said apparatus determines a representation of a part of said biological entity by said calculation and displays and/or marks said part subsequent to said calculation.

121. Apparatus according to one of claims 117 to 120, wherein said apparatus determines a zoom factor such that the area spanned by selected points and/or features covers a given percentage of the area provided for said multidimensional representation in said graphical user interface and wherein said apparatus performs a corresponding zoom.

122. Apparatus according to one of claims 117 to 121, wherein said apparatus determines one or more structural units or basic biological units according to a previously determined relation to selected points and/or features and determines a zoom factor such that the area covered by said basic biological units and/or structural units covers a given percentage of the area provided for said multidimensional representation in said graphical user interface and wherein said apparatus performs a corresponding zoom to said basic biological units and/or structural units.

123. Apparatus according to claim one of claims 117 to 121, wherein said apparatus performs a zoom to the structural unit or structural units at a previously selected hierarchy level comprising selected graphical elements or graphical elements in the vicinity of one or more selected points in said graphical user interface.

124. Data structure representing a graphic display, said data structure being obtainable by a method according to one of claims 1 to 27.

125. Data structure according to claim 124, wherein at least 50 of said graphical representations of said biological elements are present.

126. Data structure according to claim 124, wherein at least 500 of said graphical representations of said biological elements are present.

127. Data structure according to claim 124, wherein at least 5000 of said graphical representations of said biological elements are present.

128. A computer readable medium for embodying or storing therein data readable by a computer, said medium having embodied thereon one or more of the following:
a data structure generated by executing a process according to any of claims 1 to 27;
program code adapted to cause a computer to execute a method according to any one of claims 1 to 93.

129. Method of retrieving information regarding the structure of one-dimensional biological molecules by means of a data processing system, said molecules being determined by a sequence of elements, comprising the steps of:
retrieving the sequence of a first molecule,
retrieving information on the three-dimensional structure of one or linear molecules or complexes of linear molecules, said linear molecules matching said first molecule according to predetermined criteria,
providing a data structure comprising data records having as keys the sequence of a molecule, said records furthermore comprising data related to the structure of matching molecules or complexes, such that data related to a record can be accessed by said sequence.

130. Method according to claim 129, wherein in each record the data about structures of molecules are sorted according to the degree of similarity of the sequence of the molecule related to said structure to the sequence forming the key of the record.

131. Method according to claim 129 or 130, wherein in a record said data relating to the structure point to another data structure.

132. Method according to one of claims 129 to 131, wherein a record comprises data relating to the alignment of the sequence of a molecule related to a structure with the sequence forming the key of the record.

133. Method according to claim 132, wherein alignment data are stored in a separate data structure, especially a database.

134. Method according to one of claims 129 to 133, wherein said data structure is linked to at least one protein sequence database, at least one structure database and/or at least one database of sequence annotations.

135. Data structure embodied on a data carrier medium, obtainable by a method according to one of claims 129 to 134.

136. Method of visualising an ensemble of linear polymer molecules comprising the steps of
providing data representing the molecules of said ensemble,
providing a one-dimensional representation of said linear polymer molecules on a graphical user interface, wherein all sequences of the molecules of said ensemble are represented in one line.

137. Method according to claim 136, comprising the step of providing a multi-dimensional graphical representation of said molecules on said graphical user interface on the basis of said data.

138. Method according to one of claims 136 or 137, wherein selecting one of said molecules in said multi-dimensional representation or said one-dimensional representation results in a zoom to the sequence of said molecule in said one-dimensional representation and/or said multi-dimensional representation.

139. Method according to claim 138, wherein said zoom is a continuous auto-zoom.
